(19) United States
(12) Patent Application Publication
(10) Pub. No.: US 2024/0370129 A1
(43) Pub. Date: Nov. 7, 2024

(54) USER INTERFACES FOR REMOTE CONTENT DISPLAY

(71) Applicant: Apple Inc., Cupertino, CA (US)

(72) Inventors: Jae Woo CHANG, Cupertino, CA (US); Raymond S. SEPULVEDA, Portland, OR (US); Marcel VAN OS, Santa Cruz, CA (US); Chun Kin Minor WONG, Portland, OR (US)

(21) Appl. No.: 18/506,893

(22) Filed: Nov. 10, 2023

Related U.S. Application Data
(60) Provisional application No. 63/464,463, filed on May 5, 2023.

(51) Int. Cl. G06F 3/04812; G06F 3/14

(52) U.S. Cl. CPC G06F 3/04812; G06F 3/1454

(57) ABSTRACT

The present disclosure generally relates to user interfaces for displaying remote content. In some embodiments, the display of remote content can be split across two or more local display screens. In some embodiments, virtual displays can be generated to view remote content. In some embodiments, visual effects can be displayed associated with a cursor to provide indication of an input at a remote computer system.

### CROSS-REFERENCE TO RELATED APPLICATIONS

This application claims priority to U.S. Provisional Patent Application No. 63/464,463, entitled “USER INTERFACES FOR REMOTE CONTENT DISPLAY,” filed on May 5, 2023, the content of which is hereby incorporated by reference in its entirety.

### FIELD

The present disclosure relates generally to computer user interfaces, and more specifically to techniques for displaying remote content.

### BACKGROUND

Content can be shared between computer systems such that a local computer system can display content that is provided by a remote computer system. User interfaces can be provided so that the remote content can be displayed at the local computer system.

### BRIEF SUMMARY

Some techniques for displaying remote content using electronic devices, however, are generally cumbersome and inefficient. For example, some existing techniques use a complex and time-consuming user interface, which may include multiple key presses or keystrokes. Existing techniques require more time than necessary, wasting user time and device energy. This latter consideration is particularly important in battery-operated devices.

Accordingly, the present technique provides electronic devices with faster, more efficient methods and interfaces for displaying remote content. Such methods and interfaces optionally complement or replace other methods for displaying remote content. Such methods and interfaces reduce the cognitive burden on a user and produce a more efficient human-machine interface. For battery-operated computing devices, such methods and interfaces conserve power, increase the time between battery charges, provide improved control schemes for displaying remote content, and reduce the computational workload of the computing devices.

Example methods are described herein. An example method includes, at a computer system that is in communication with a set of one or more display generation components and one or more input devices: displaying, via the set of one or more display generation components, a shared-content user interface having respective content shared from an external computer system, the shared-content user interface including: a representation of first content shared from a first desktop of the external computer system; and a representation of second content shared from a second desktop of the external computer system; while displaying the shared-content user interface having a first displayed state, receiving a request to modify the shared-content user interface from the first displayed state to a second displayed state; and in response to receiving the request to modify the shared-content user interface from the first displayed state to the second displayed state, displaying the shared-content user interface having the second displayed state, including: in accordance with a determination that the set of one or more display generation components includes a first display generation component and a second display generation component different from the first display generation component, displaying the representation of the first content shared from the first desktop of the external computer system at the first display generation component and displaying the representation of the second content shared from the second desktop of the external computer system at the second display generation component; and in accordance with a determination that the set of one or more display generation components includes the first display generation component and does not include another display generation component, displaying the representation of the first content shared from the first desktop of the external computer system and the representation of the second content shared from the second desktop of the external computer system at the first display generation component of the computer system.

An example method includes, at a computer system that is in communication with a set of one or more display generation components and one or more input devices: displaying, via the set of one or more display generation components, a setup user interface for enabling display of content shared from an external computer system, including displaying, in the setup user interface, a plurality of display type options for selecting a display type for displaying the content shared from the external computer system; detecting, via the one or more input devices, a first set of one or more inputs corresponding to a request to enable display of content shared from the external computer system; and in response to detecting the first set of one or more inputs corresponding to a request to enable display of content shared from the external computer system, displaying, via the one or more display generation components, content shared from the external computer system, including: in accordance with a determination that a first display type option is selected, displaying, via the set of one or more display generation components, a representation of first content that is shared from the external computer system and is displayed at a display device of the external computer system; and in accordance with a determination that a second display type option is selected, generating a virtual display interface that includes a representation of second content that is shared from the external computer system and is not displayed at a display device of the external computer system.

An example method includes, at a computer system that is in communication with a display generation component and one or more input devices: while displaying, via the display generation component, a first user interface that includes a representation of respective content shared between the computer system and an external computer system: in response to detection of an input while a cursor is displayed at the first user interface: in accordance with a determination that the cursor is displayed at a location in the first user interface that overlaps at least a portion of the representation of respective content shared between the computer system and the external computer system when the input is detected, performing a first action associated with the detected input and displaying a visual effect that is visually associated with the cursor when a set of criteria is met; and in accordance with a determination that the cursor is displayed at a location in the first user interface that does not overlap at least a portion of the representation of respective content shared between the computer system and the external computer system when the input is detected, performing a second action associated with the detected input without displaying the visual effect that is visually associated with the cursor regardless of whether the set of criteria is met.

Example non-transitory computer-readable storage media are described herein. An example non-transitory computer-readable storage medium stores one or more programs configured to be executed by one or more processors of a computer system that is in communication with a set of one or more display generation components and one or more input devices, the one or more programs including instructions for: displaying, via the set of one or more display generation components, a shared-content user interface having respective content shared from an external computer system, the shared-content user interface including: a representation of first content shared from a first desktop of the external computer system; and a representation of second content shared from a second desktop of the external computer system; while displaying the shared-content user interface having a first displayed state, receiving a request to modify the shared-content user interface from the first displayed state to a second displayed state; and in response to receiving the request to modify the shared-content user interface from the first displayed state to the second displayed state, displaying the shared-content user interface having the second displayed state, including: in accordance with a determination that the set of one or more display generation components includes a first display generation component and a second display generation component different from the first display generation component, displaying the representation of the first content shared from the first desktop of the external computer system at the first display generation component and displaying the representation of the second content shared from the second desktop of the external computer system at the second display generation component; and in accordance with a determination that the set of one or more display generation components includes the first display generation component and does not include another display generation component, displaying the representation of the first content shared from the first desktop of the external computer system and the representation of the second content shared from the second desktop of the external computer system at the first display generation component of the computer system.

An example non-transitory computer-readable storage medium stores one or more programs configured to be executed by one or more processors of a computer system that is in communication with a set of one or more display generation components and one or more input devices, the one or more programs including instructions for: displaying, via the set of one or more display generation components, a setup user interface for enabling display of content shared from an external computer system, including displaying, in the setup user interface, a plurality of display type options for selecting a display type for displaying the content shared from the external computer system; detecting, via the one or more input devices, a first set of one or more inputs corresponding to a request to enable display of content shared from the external computer system; and in response to detecting the first set of one or more inputs corresponding to a request to enable display of content shared from the external computer system, displaying, via the one or more display generation components, content shared from the external computer system, including: in accordance with a determination that a first display type option is selected, displaying, via the set of one or more display generation components, a representation of first content that is shared from the external computer system and is displayed at a display device of the external computer system; and in accordance with a determination that a second display type option is selected, generating a virtual display interface that includes a representation of second content that is shared from the external computer system and is not displayed at a display device of the external computer system.

An example non-transitory computer-readable storage medium stores one or more programs configured to be executed by one or more processors of a computer system that is in communication with a display generation component and one or more input devices, the one or more programs including instructions for: while displaying, via the display generation component, a first user interface that includes a representation of respective content shared between the computer system and an external computer system: in response to detection of an input while a cursor is displayed at the first user interface: in accordance with a determination that the cursor is displayed at a location in the first user interface that overlaps at least a portion of the representation of respective content shared between the computer system and the external computer system when the input is detected, performing a first action associated with the detected input and displaying a visual effect that is visually associated with the cursor when a set of criteria is met; and in accordance with a determination that the cursor is displayed at a location in the first user interface that does not overlap at least a portion of the representation of respective content shared between the computer system and the external computer system when the input is detected, performing a second action associated with the detected input without displaying the visual effect that is visually associated with the cursor regardless of whether the set of criteria is met.

Example transitory computer-readable storage media are described herein. An example transitory computer-readable storage medium stores one or more programs configured to be executed by one or more processors of a computer system that is in communication with a set of one or more display generation components and one or more input devices, the one or more programs including instructions for: displaying, via the set of one or more display generation components, a shared-content user interface having respective content shared from an external computer system, the shared-content user interface including: a representation of first content shared from a first desktop of the external computer system; and a representation of second content shared from a second desktop of the external computer system; while displaying the shared-content user interface having a first displayed state, receiving a request to modify the shared-content user interface from the first displayed state to a second displayed state; and in response to receiving the request to modify the shared-content user interface from the first displayed state to the second displayed state, displaying the shared-content user interface having the second displayed state, including: in accordance with a determination that the set of one or more display generation components includes a first display generation component and a second display generation component different from the first display generation component, displaying the representation of the first content shared from the first desktop of the external computer system at the first display generation component and displaying the representation of the second content shared from the second desktop of the external computer system at the second display generation component; and in accordance with a determination that the set of one or more display generation components includes the first display generation component and does not include another display generation component, displaying the representation of the first content shared from the first desktop of the external computer system and the representation of the second content shared from the second desktop of the external computer system at the first display generation component of the computer system.

An example transitory computer-readable storage medium stores one or more programs configured to be executed by one or more processors of a computer system that is in communication with a set of one or more display generation components and one or more input devices, the one or more programs including instructions for: displaying, via the set of one or more display generation components, a setup user interface for enabling display of content shared from an external computer system, including displaying, in the setup user interface, a plurality of display type options for selecting a display type for displaying the content shared from the external computer system; detecting, via the one or more input devices, a first set of one or more inputs corresponding to a request to enable display of content shared from the external computer system; and in response to detecting the first set of one or more inputs corresponding to a request to enable display of content shared from the external computer system, displaying, via the one or more display generation components, content shared from the external computer system, including: in accordance with a determination that a first display type option is selected, displaying, via the set of one or more display generation components, a representation of first content that is shared from the external computer system and is displayed at a display device of the external computer system; and in accordance with a determination that a second display type option is selected, generating a virtual display interface that includes a representation of second content that is shared from the external computer system and is not displayed at a display device of the external computer system.

An example transitory computer-readable storage medium stores one or more programs configured to be executed by one or more processors of a computer system that is in communication with a display generation component and one or more input devices, the one or more programs including instructions for: while displaying, via the display generation component, a first user interface that includes a representation of respective content shared between the computer system and an external computer system: in response to detection of an input while a cursor is displayed at the first user interface: in accordance with a determination that the cursor is displayed at a location in the first user interface that overlaps at least a portion of the representation of respective content shared between the computer system and the external computer system when the input is detected, performing a first action associated with the detected input and displaying a visual effect that is visually associated with the cursor when a set of criteria is met; and in accordance with a determination that the cursor is displayed at a location in the first user interface that does not overlap at least a portion of the representation of respective content shared between the computer system and the external computer system when the input is detected, performing a second action associated with the detected input without displaying the visual effect that is visually associated with the cursor regardless of whether the set of criteria is met.

Example computer systems are described herein. An example computer system is configured to communicate with a set of one or more display generation components and one or more input devices and includes: one or more processors; and memory storing one or more programs configured to be executed by the one or more processors, the one or more programs including instructions for: displaying, via the set of one or more display generation components, a shared-content user interface having respective content shared from an external computer system, the shared-content user interface including: a representation of first content shared from a first desktop of the external computer system; and a representation of second content shared from a second desktop of the external computer system; while displaying the shared-content user interface having a first displayed state, receiving a request to modify the shared-content user interface from the first displayed state to a second displayed state; and in response to receiving the request to modify the shared-content user interface from the first displayed state to the second displayed state, displaying the shared-content user interface having the second displayed state, including: in accordance with a determination that the set of one or more display generation components includes a first display generation component and a second display generation component different from the first display generation component, displaying the representation of the first content shared from the first desktop of the external computer system at the first display generation component and displaying the representation of the second content shared from the second desktop of the external computer system at the second display generation component; and in accordance with a determination that the set of one or more display generation components includes the first display generation component and does not include another display generation component, displaying the representation of the first content shared from the first desktop of the external computer system and the representation of the second content shared from the second desktop of the external computer system at the first display generation component of the computer system.

An example computer system is configured to communicate with a set of one or more display generation components and one or more input devices and includes: one or more processors; and memory storing one or more programs configured to be executed by the one or more processors, the one or more programs including instructions for: displaying, via the set of one or more display generation components, a setup user interface for enabling display of content shared from an external computer system, including displaying, in the setup user interface, a plurality of display type options for selecting a display type for displaying the content shared from the external computer system; detecting, via the one or more input devices, a first set of one or more inputs corresponding to a request to enable display of content shared from the external computer system; and in response to detecting the first set of one or more inputs corresponding to a request to enable display of content shared from the external computer system, displaying, via the one or more display generation components, content shared from the external computer system, including: in accordance with a determination that a first display type option is selected, displaying, via the set of one or more display generation components, a representation of first content that is shared from the external computer system and is displayed at a display device of the external computer system; and in accordance with a determination that a second display type option is selected, generating a virtual display interface that includes a representation of second content that is shared from the external computer system and is not displayed at a display device of the external computer system.

An example computer system is configured to communicate with a display generation component and one or more input devices and includes: one or more processors; and memory storing one or more programs configured to be executed by the one or more processors, the one or more programs including instructions for: while displaying, via the display generation component, a first user interface that includes a representation of respective content shared between the computer system and an external computer system: in response to detection of an input while a cursor is displayed at the first user interface: in accordance with a determination that the cursor is displayed at a location in the first user interface that overlaps at least a portion of the representation of respective content shared between the computer system and the external computer system when the input is detected, performing a first action associated with the detected input and displaying a visual effect that is visually associated with the cursor when a set of criteria is met; and in accordance with a determination that the cursor is displayed at a location in the first user interface that does not overlap at least a portion of the representation of respective content shared between the computer system and the external computer system when the input is detected, performing a second action associated with the detected input without displaying the visual effect that is visually associated with the cursor regardless of whether the set of criteria is met.

An example computer system is configured to communicate with a set of one or more display generation components and one or more input devices and includes means for displaying, via the set of one or more display generation components, a shared-content user interface having respective content shared from an external computer system, the shared-content user interface including: a representation of first content shared from a first desktop of the external computer system; and a representation of second content shared from a second desktop of the external computer system; means for, while displaying the shared-content user interface having a first displayed state, receiving a request to modify the shared-content user interface from the first displayed state to a second displayed state; and means for, in response to receiving the request to modify the shared-content user interface from the first displayed state to the second displayed state, displaying the shared-content user interface having the second displayed state, including: in accordance with a determination that the set of one or more display generation components includes a first display generation component and a second display generation component different from the first display generation component, displaying the representation of the first content shared from the first desktop of the external computer system at the first display generation component and displaying the representation of the second content shared from the second desktop of the external computer system at the second display generation component; and in accordance with a determination that the set of one or more display generation components includes the first display generation component and does not include another display generation component, displaying the representation of the first content shared from the first desktop of the external computer system and the representation of the second content shared from the second desktop of the external computer system at the first display generation component of the computer system.

An example computer system is configured to communicate with a set of one or more display generation components and one or more input devices and includes means for displaying, via the set of one or more display generation components, a setup user interface for enabling display of content shared from an external computer system, including displaying, in the setup user interface, a plurality of display type options for selecting a display type for displaying the content shared from the external computer system; means for detecting, via the one or more input devices, a first set of one or more inputs corresponding to a request to enable display of content shared from the external computer system; and means for, in response to detecting the first set of one or more inputs corresponding to a request to enable display of content shared from the external computer system, displaying, via the one or more display generation components, content shared from the external computer system, including: in accordance with a determination that a first display type option is selected, displaying, via the set of one or more display generation components, a representation of first content that is shared from the external computer system and is displayed at a display device of the external computer system; and in accordance with a determination that a second display type option is selected, generating a virtual display interface that includes a representation of second content that is shared from the external computer system and is not displayed at a display device of the external computer system.

An example computer system is configured to communicate with a display generation component and one or more input devices and includes means for while displaying, via the display generation component, a first user interface that includes a representation of respective content shared between the computer system and an external computer system: in response to detection of an input while a cursor is displayed at the first user interface: in accordance with a determination that the cursor is displayed at a location in the first user interface that overlaps at least a portion of the representation of respective content shared between the computer system and the external computer system when the input is detected, performing a first action associated with the detected input and displaying a visual effect that is visually associated with the cursor when a set of criteria is met; and in accordance with a determination that the cursor is displayed at a location in the first user interface that does not overlap at least a portion of the representation of respective content shared between the computer system and the external computer system when the input is detected, performing a second action associated with the detected input without displaying the visual effect that is visually associated with the cursor regardless of whether the set of criteria is met.

Example computer program products are described herein. An example computer program product includes one or more programs configured to be executed by one or more processors of a computer system that is in communication with a set of one or more display generation components and one or more input devices, the one or more programs including instructions for: displaying, via the set of one or more display generation components, a shared-content user interface having respective content shared from an external computer system, the shared-content user interface including: a representation of first content shared from a first desktop of the external computer system; and a representation of second content shared from a second desktop of the external computer system; while displaying the shared-content user interface having a first displayed state, receiving a request to modify the shared-content user interface from the first displayed state to a second displayed state; and in response to receiving the request to modify the shared-content user interface from the first displayed state to the second displayed state, displaying the shared-content user interface having the second displayed state, including: in accordance with a determination that the set of one or more display generation components includes a first display generation component and a second display generation component different from the first display generation component, displaying the representation of the first content shared from the first desktop of the external computer system at the first display generation component and displaying the representation of the second content shared from the second desktop of the external computer system at the second display generation component; and in accordance with a determination that the set of one or more display generation components includes the first display generation component and does not include another display generation component, displaying the representation of the first content shared from the first desktop of the external computer system and the representation of the second content shared from the second desktop of the external computer system at the first display generation component of the computer system.

An example computer program product includes one or more programs configured to be executed by one or more processors of a computer system that is in communication with a set of one or more display generation components and one or more input devices, the one or more programs including instructions for: displaying, via the set of one or more display generation components, a setup user interface for enabling display of content shared from an external computer system, including displaying, in the setup user interface, a plurality of display type options for selecting a display type for displaying the content shared from the external computer system; detecting, via the one or more input devices, a first set of one or more inputs corresponding to a request to enable display of content shared from the external computer system; and in response to detecting the first set of one or more inputs corresponding to a request to enable display of content shared from the external computer system, displaying, via the one or more display generation components, content shared from the external computer system, including: in accordance with a determination that a first display type option is selected, displaying, via the set of one or more display generation components, a representation of first content that is shared from the external computer system and is displayed at a display device of the external computer system; and in accordance with a determination that a second display type option is selected, generating a virtual display interface that includes a representation of second content that is shared from the external computer system and is not displayed at a display device of the external computer system.

An example computer program product includes one or more programs configured to be executed by one or more processors of a computer system that is in communication with a display generation component and one or more input devices, the one or more programs including instructions for: while displaying, via the display generation component, a first user interface that includes a representation of respective content shared between the computer system and an external computer system: in response to detection of an input while a cursor is displayed at the first user interface: in accordance with a determination that the cursor is displayed at a location in the first user interface that overlaps at least a portion of the representation of respective content shared between the computer system and the external computer system when the input is detected, performing a first action associated with the detected input and displaying a visual effect that is visually associated with the cursor when a set of criteria is met; and in accordance with a determination that the cursor is displayed at a location in the first user interface that does not overlap at least a portion of the representation of respective content shared between the computer system and the external computer system when the input is detected, performing a second action associated with the detected input without displaying the visual effect that is visually associated with the cursor regardless of whether the set of criteria is met.

Executable instructions for performing these functions are, optionally, included in a non-transitory computer-readable storage medium or other computer program product configured for execution by one or more processors. Executable instructions for performing these functions are, optionally, included in a transitory computer-readable storage medium or other computer program product configured for execution by one or more processors.

Thus, devices are provided with faster, more efficient methods and interfaces for displaying remote content, thereby increasing the effectiveness, efficiency, and user satisfaction with such devices. Such methods and interfaces may complement or replace other methods for displaying remote content.

### DESCRIPTION OF THE FIGURES

For a better understanding of the various described embodiments, reference should be made to the Description of Embodiments below, in conjunction with the following drawings in which like reference numerals refer to corresponding parts throughout the figures.

FIG. 1A is a block diagram illustrating a portable multifunction device with a touch-sensitive display in accordance with some embodiments.

FIG. 1B is a block diagram illustrating exemplary components for event handling in accordance with some embodiments.

FIG. 2 illustrates a portable multifunction device having a touch screen in accordance with some embodiments.

FIG. 3 is a block diagram of an exemplary multifunction device with a display and a touch-sensitive surface in accordance with some embodiments.

FIG. 4A illustrates an exemplary user interface for a menu of applications on a portable multifunction device in accordance with some embodiments.

FIG. 4B illustrates an exemplary user interface for a multifunction device with a touch-sensitive surface that is separate from the display in accordance with some embodiments.

FIG. 5A illustrates a personal electronic device in accordance with some embodiments.

FIG. 5B is a block diagram illustrating a personal electronic device in accordance with some embodiments.

FIGS. 6A-6O illustrate exemplary user interfaces for displaying remote content, in accordance with some embodiments.

FIG. 7 is a flow diagram illustrating a method for displaying remote content, in accordance with some embodiments.

FIGS. 8A-8P illustrate exemplary user interfaces for generating virtual displays for displaying remote content, in accordance with some embodiments.

FIG. 9 is a flow diagram illustrating a method for generating virtual displays for displaying remote content, in accordance with some embodiments.

FIGS. 10A-10K illustrate exemplary user interfaces for displaying shared content, in accordance with some embodiments.

FIG. 11 is a flow diagram illustrating a method for displaying shared content, in accordance with some embodiments.

### DESCRIPTION OF EMBODIMENTS

The following description sets forth exemplary methods, parameters, and the like. It should be recognized, however, that such description is not intended as a limitation on the scope of the present disclosure but is instead provided as a description of exemplary embodiments.

There is a need for electronic devices that provide efficient methods and interfaces for displaying remote content. Such techniques can reduce the cognitive burden on a user who views remote content, thereby enhancing productivity. Further, such techniques can reduce processor and battery power otherwise wasted on redundant user inputs.

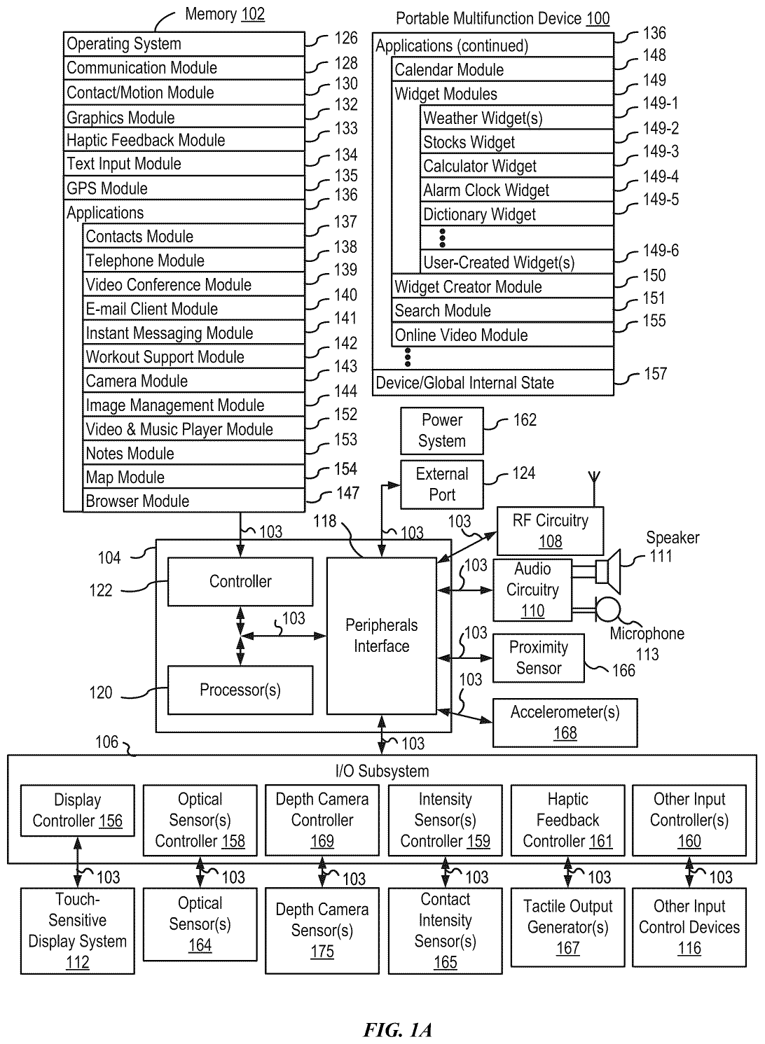

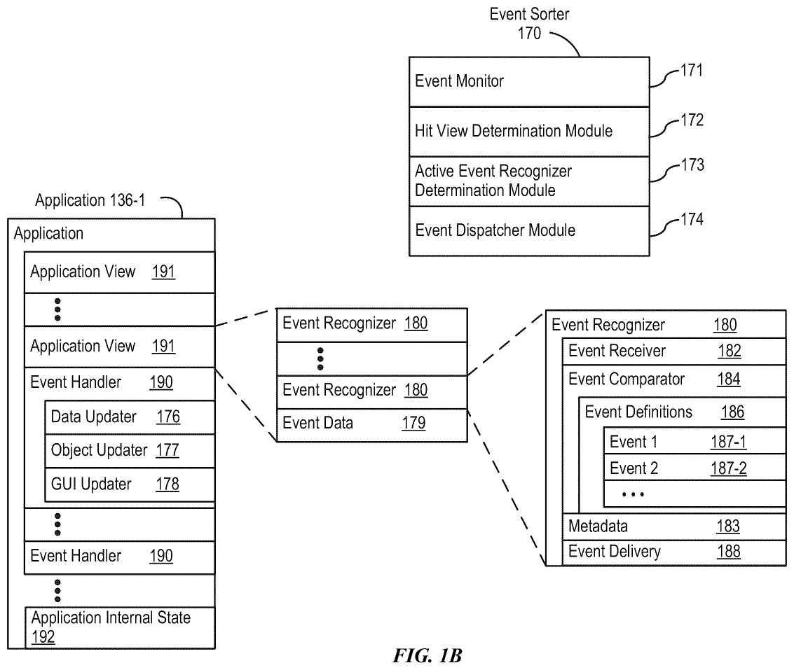

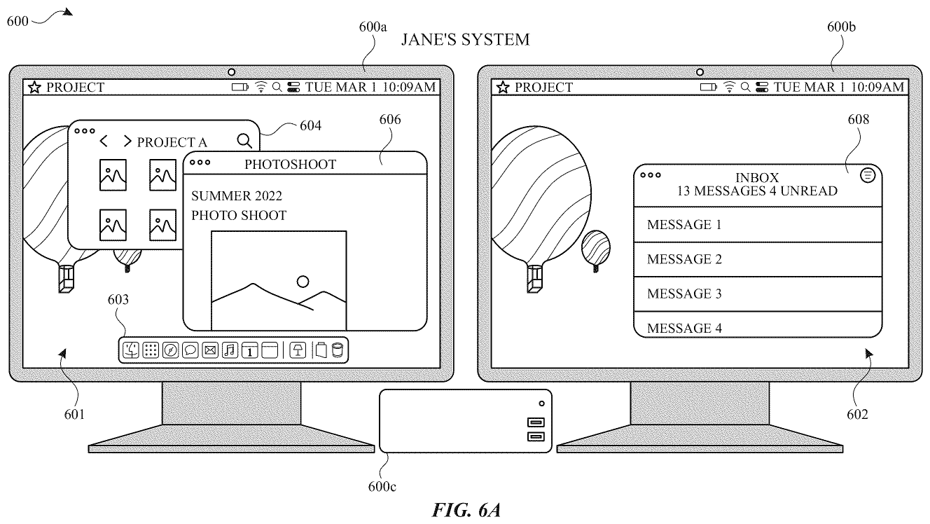

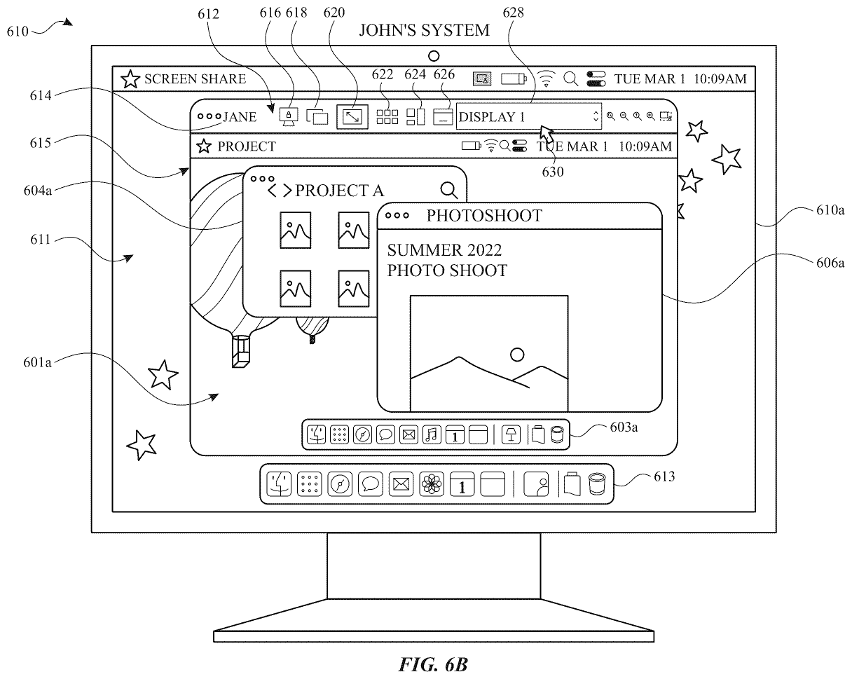

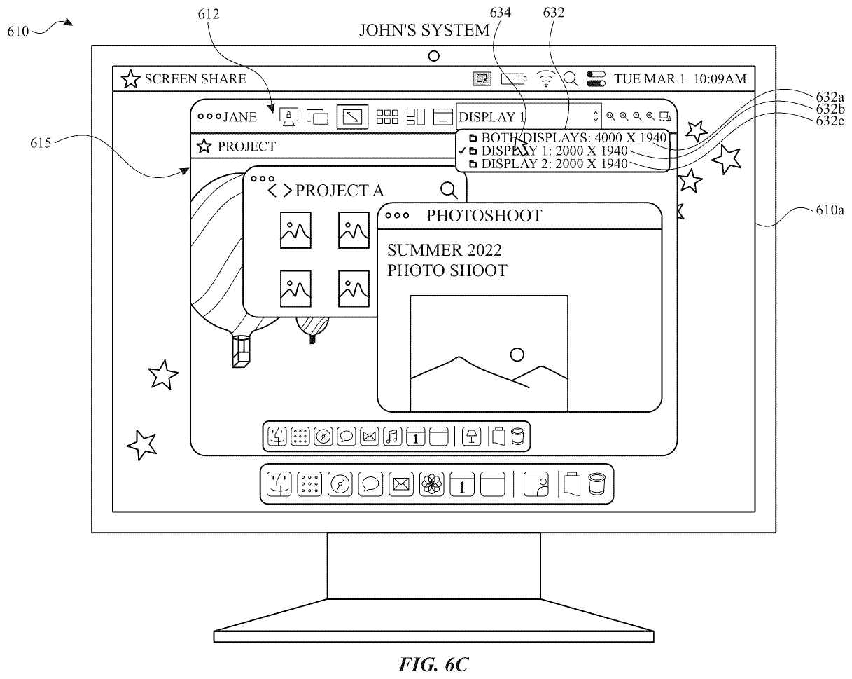

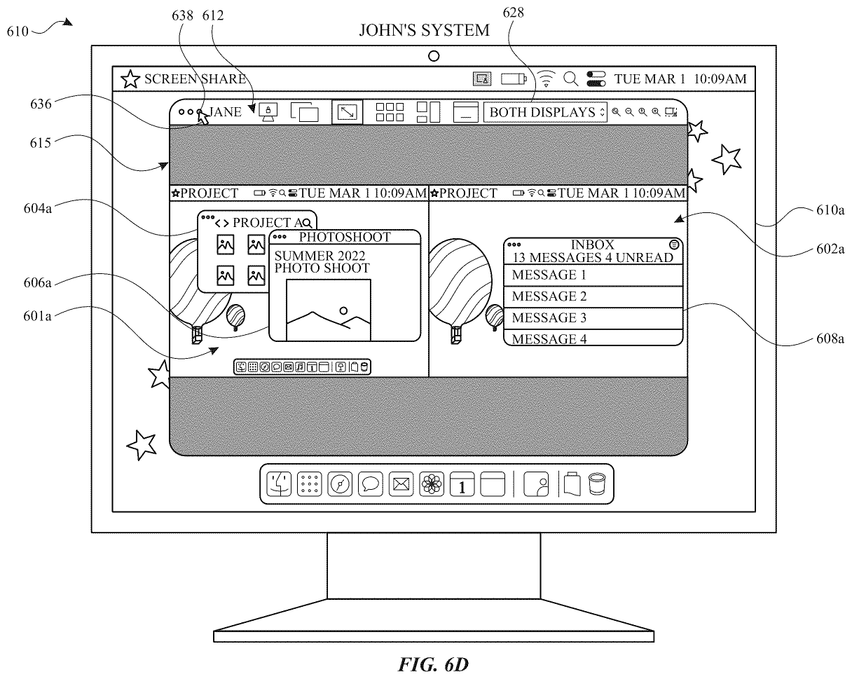

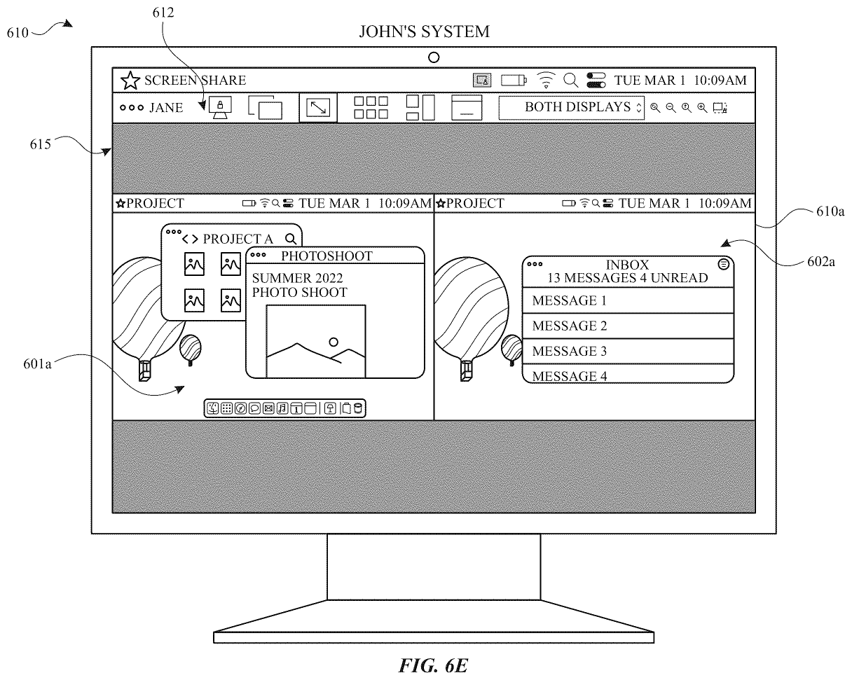

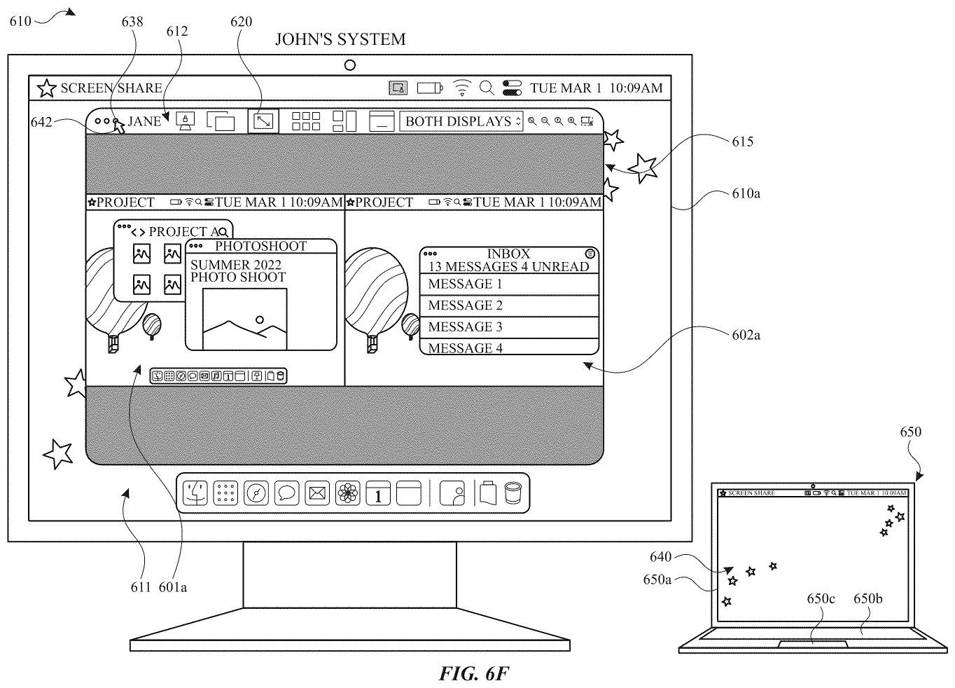

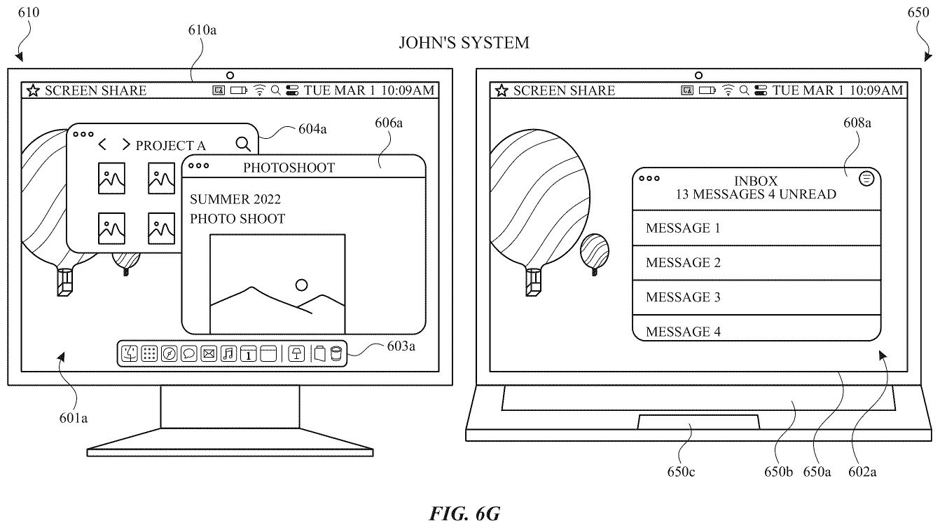

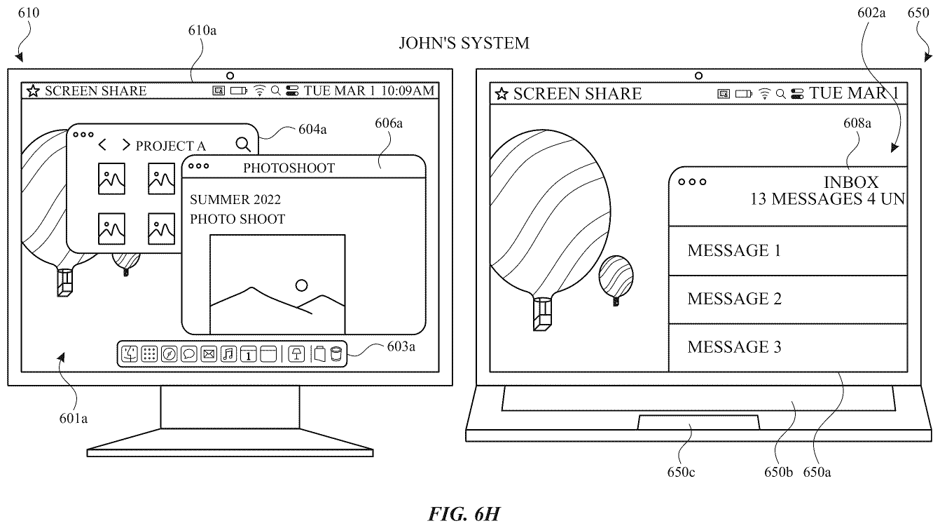

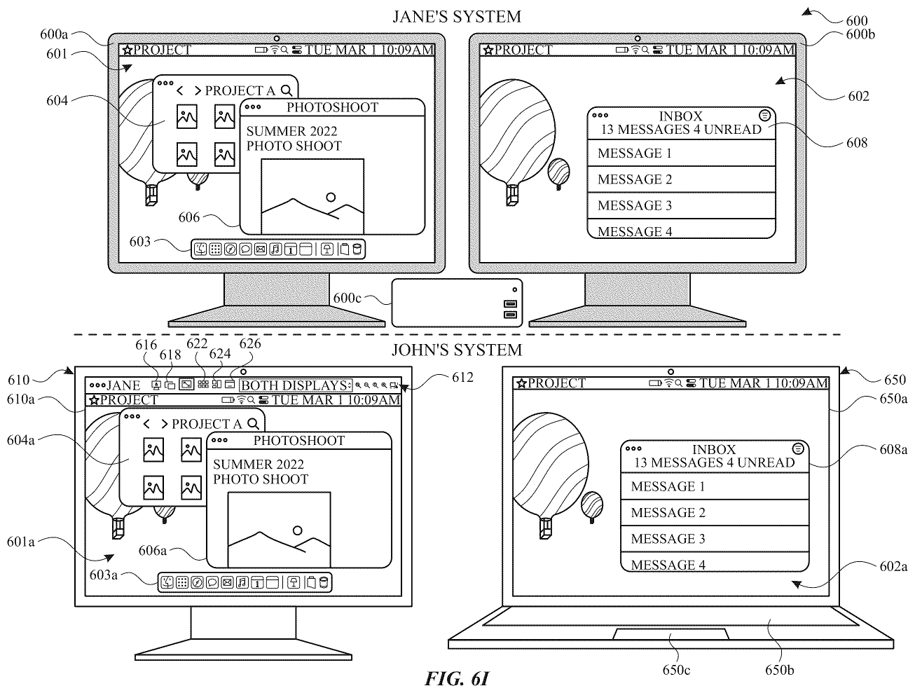

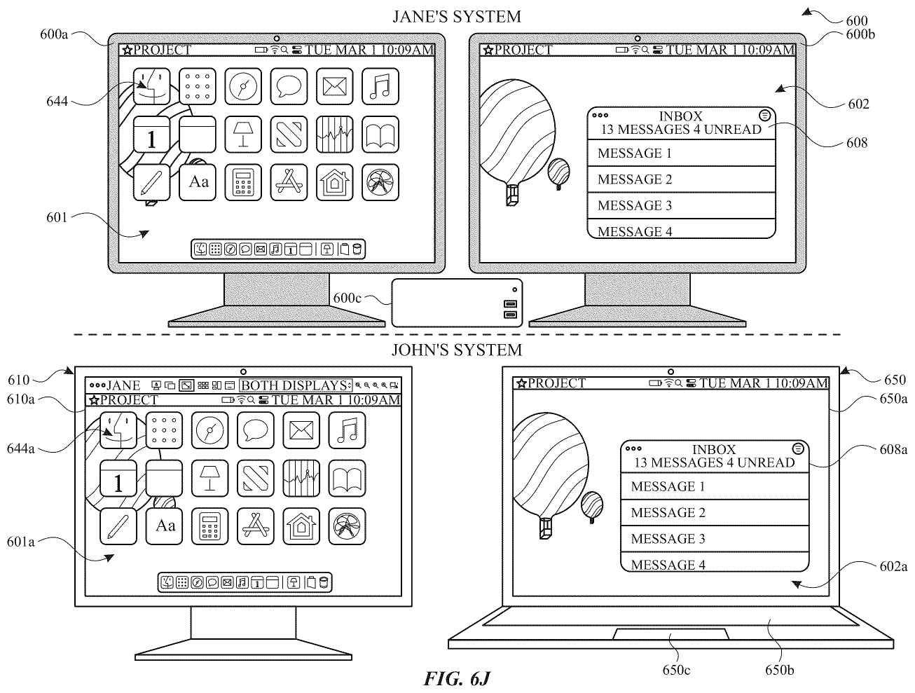

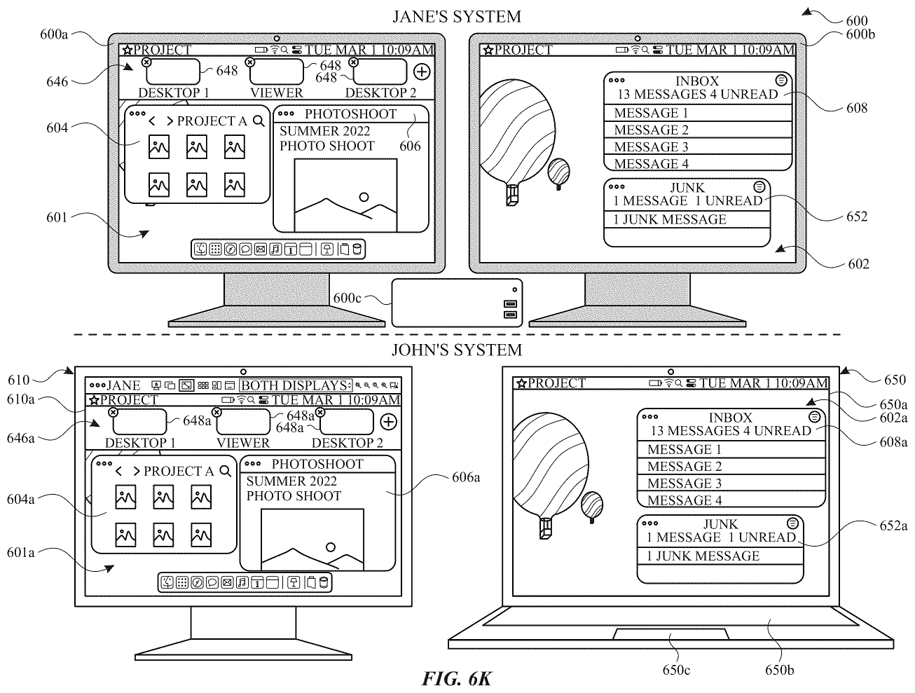

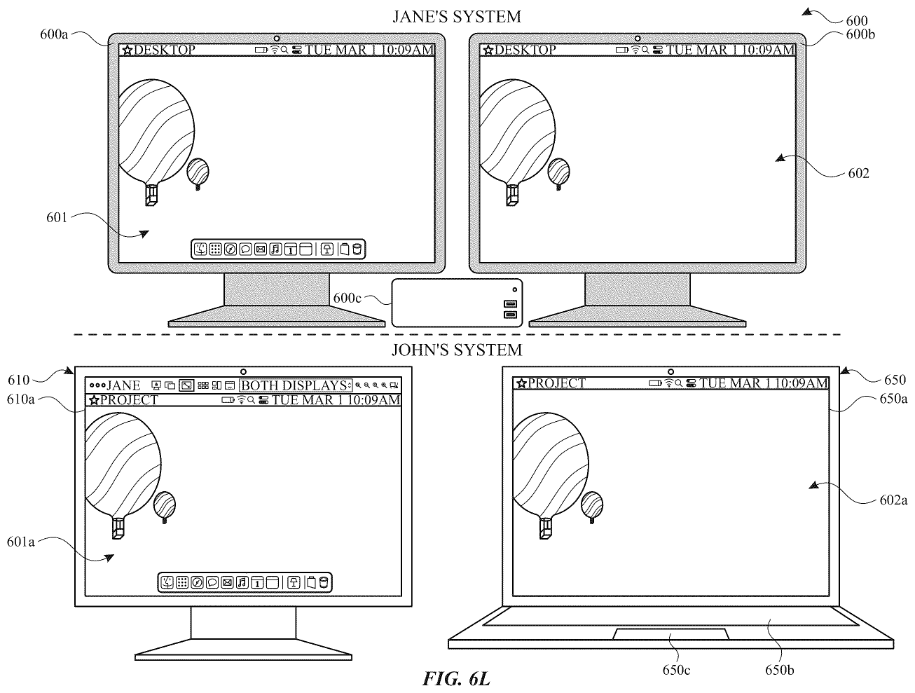

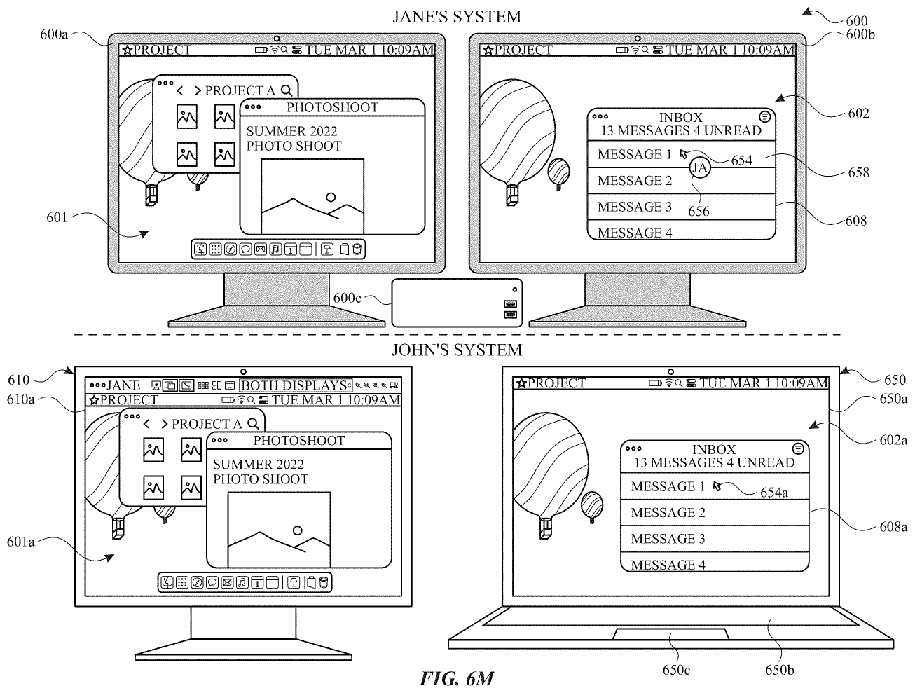

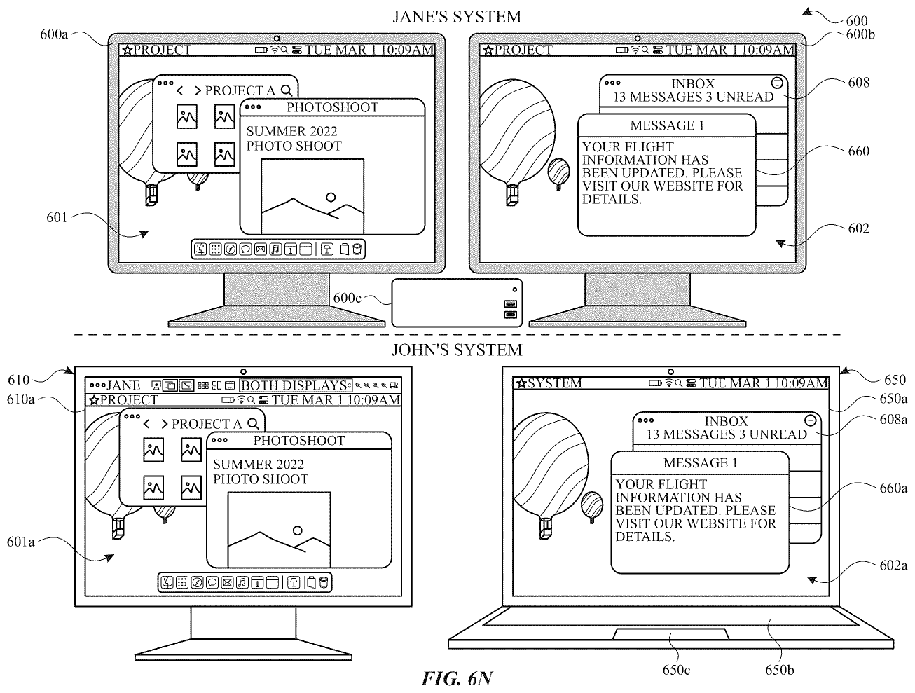

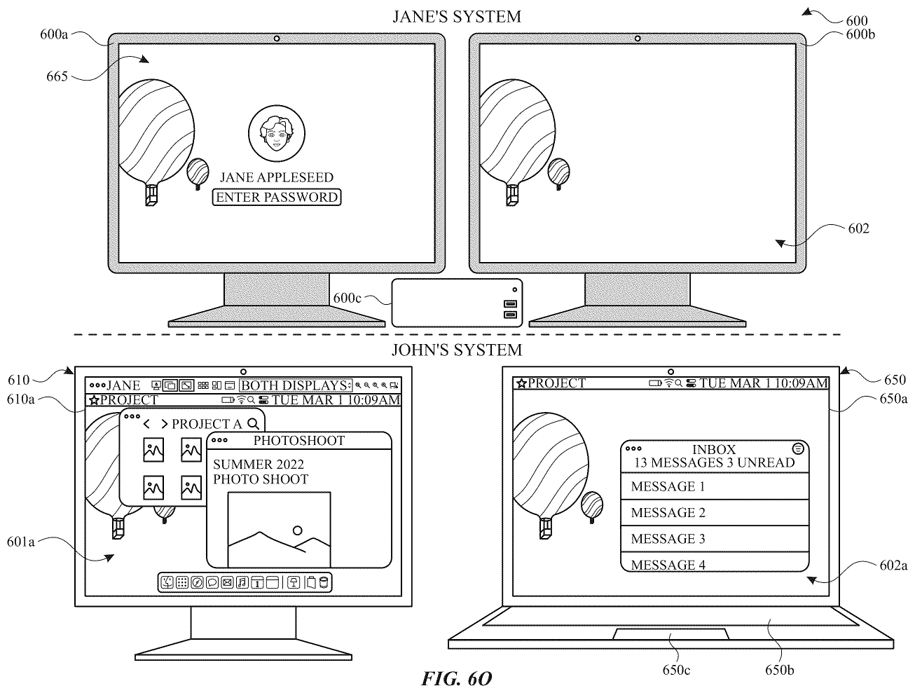

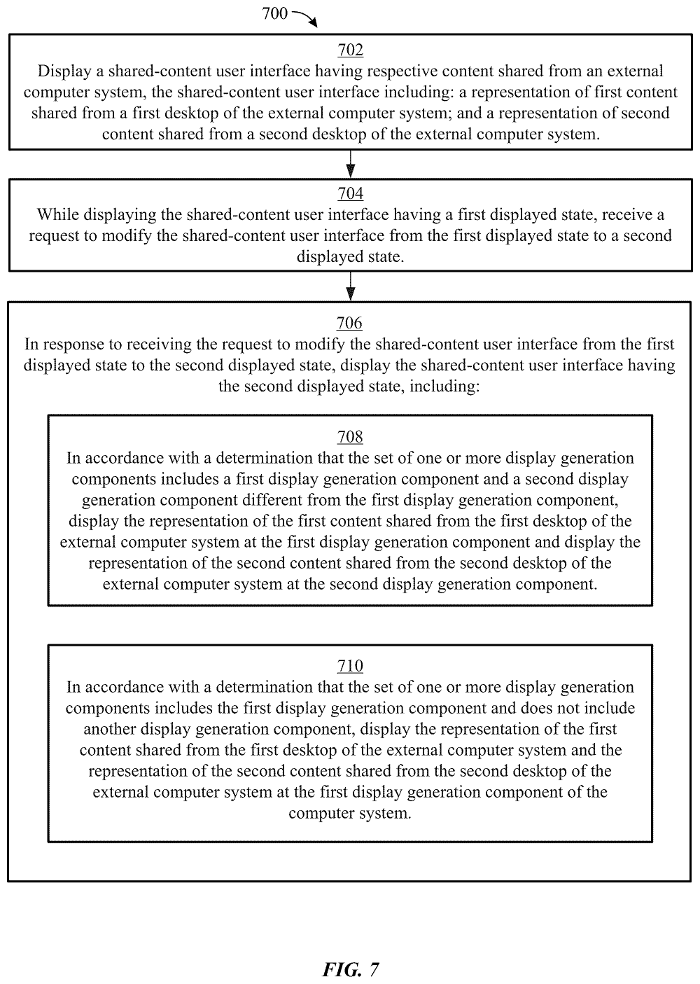

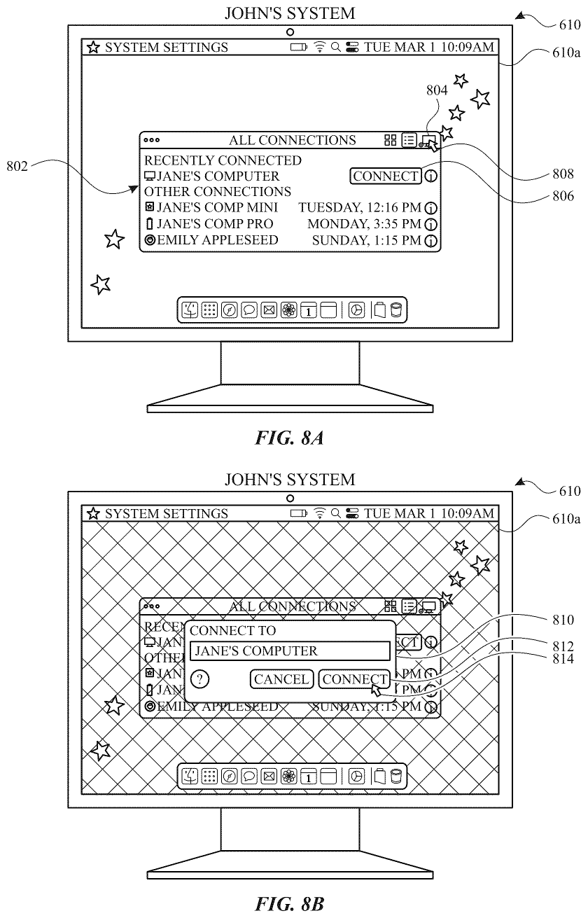

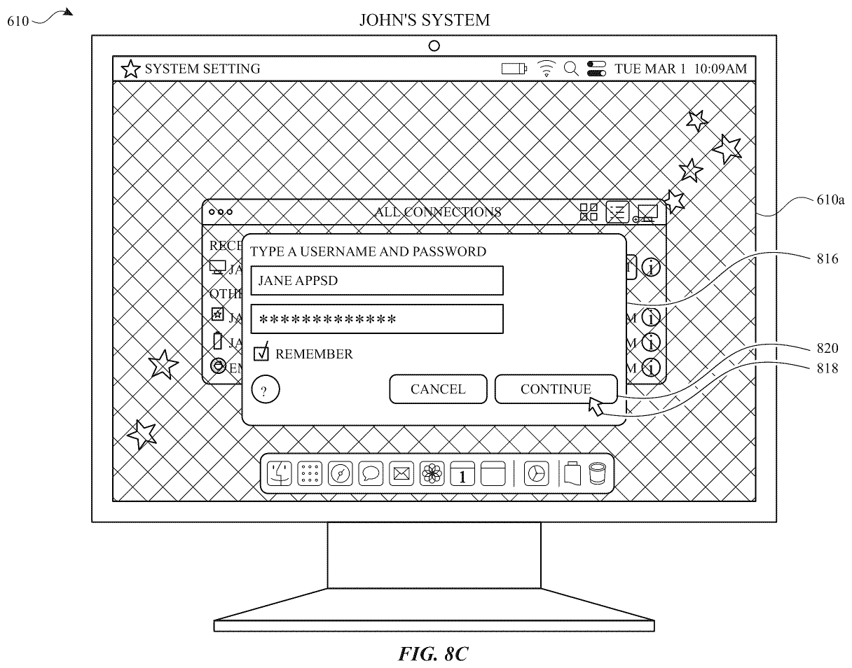

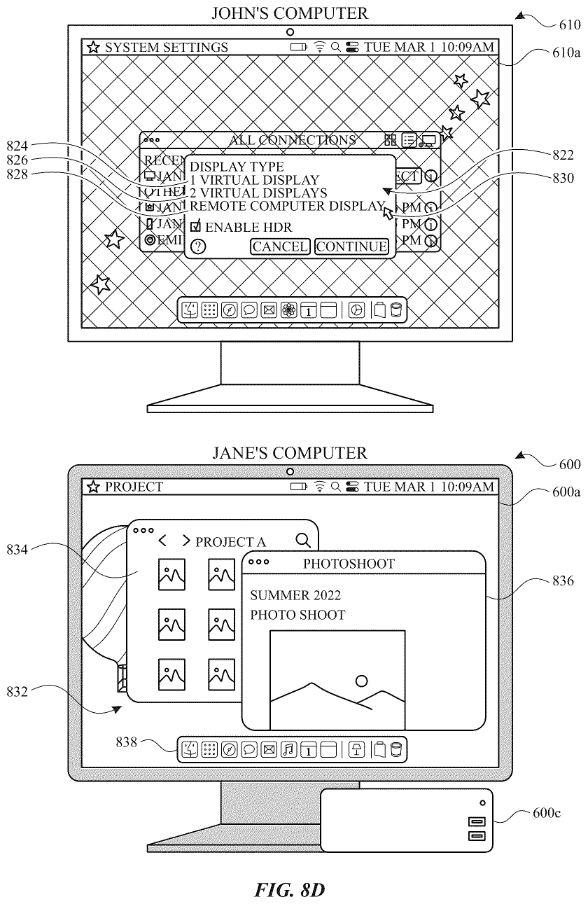

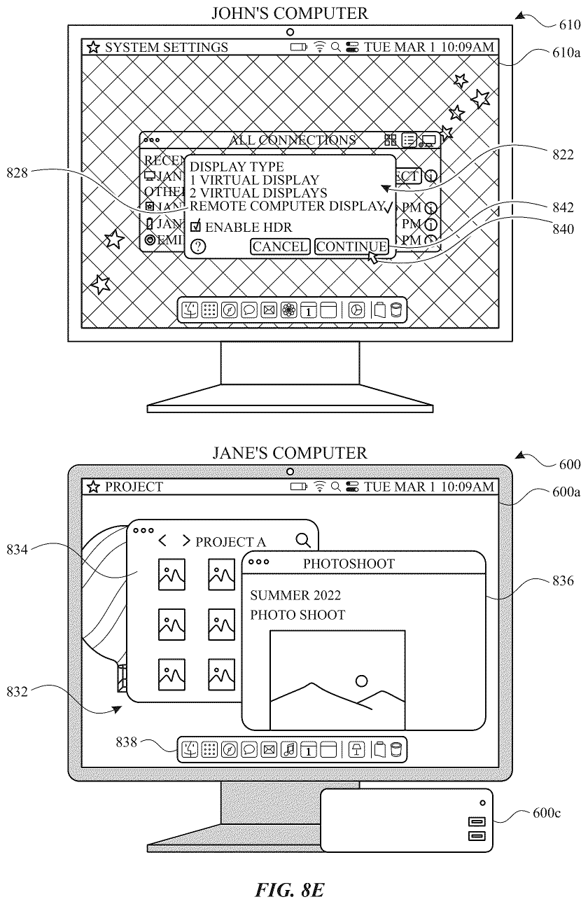

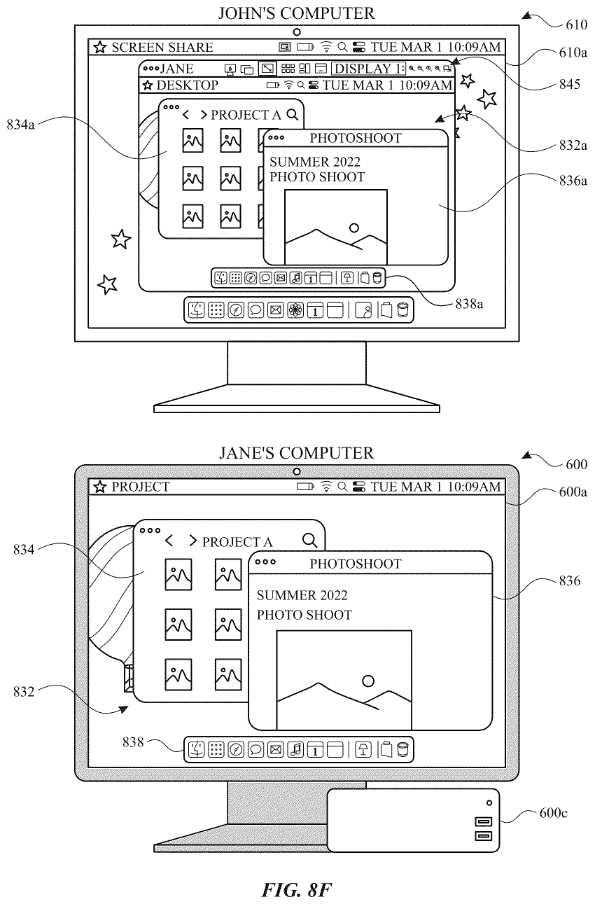

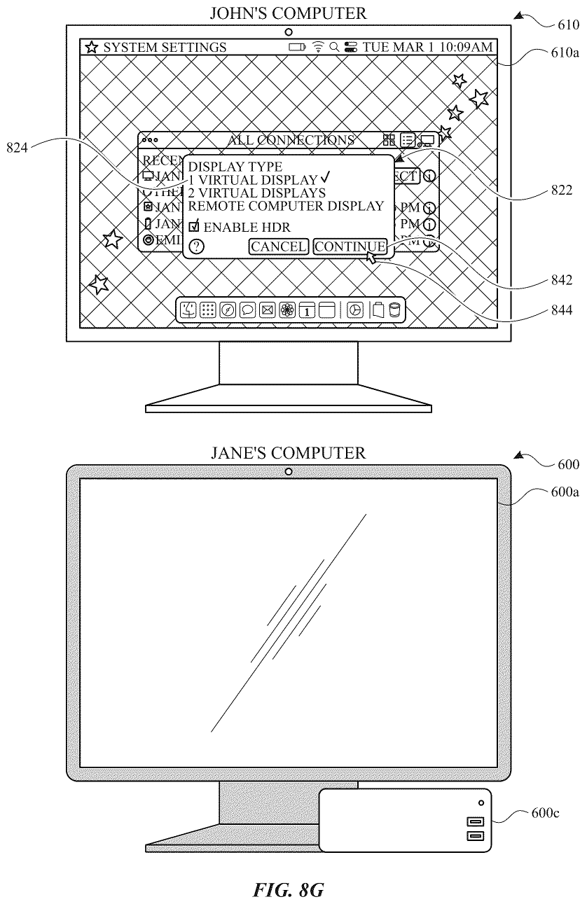

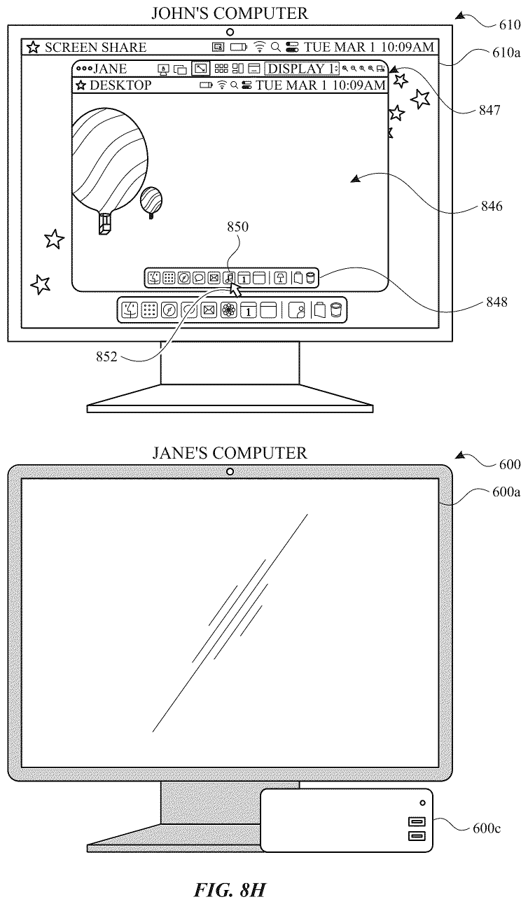

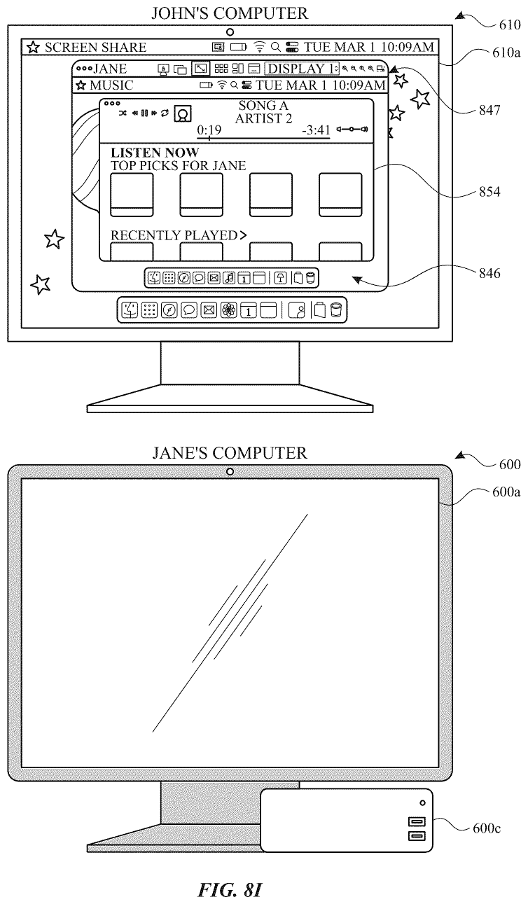

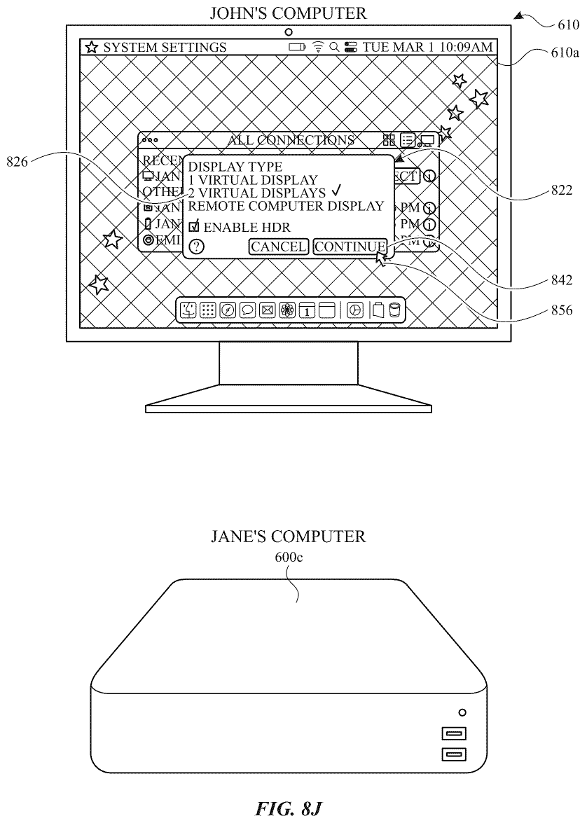

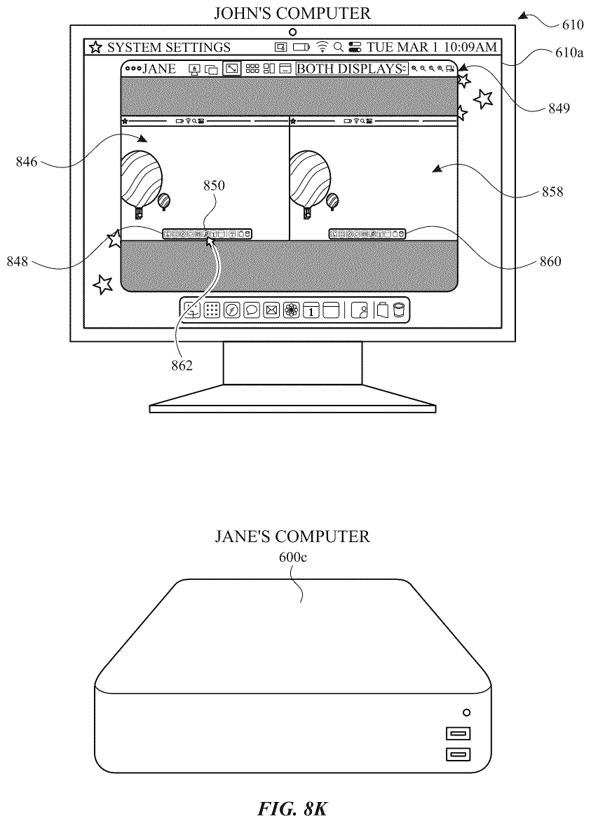

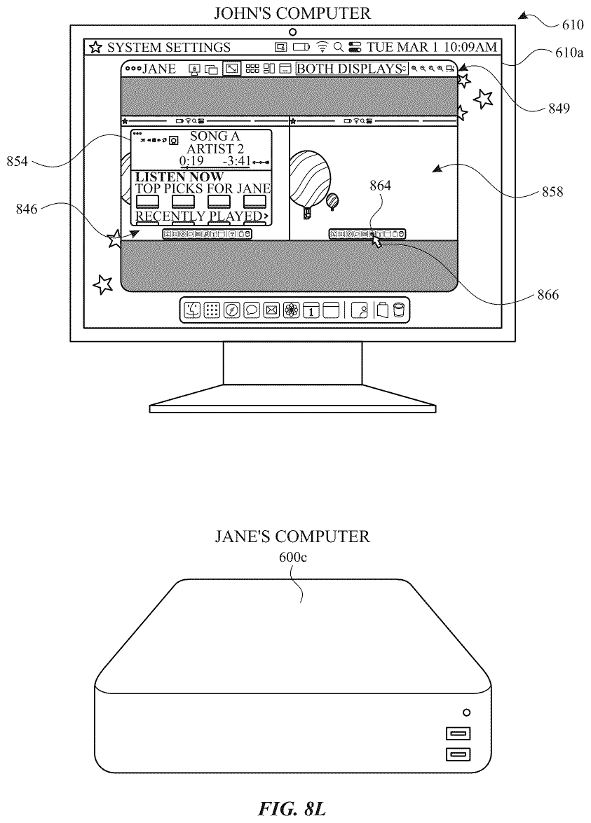

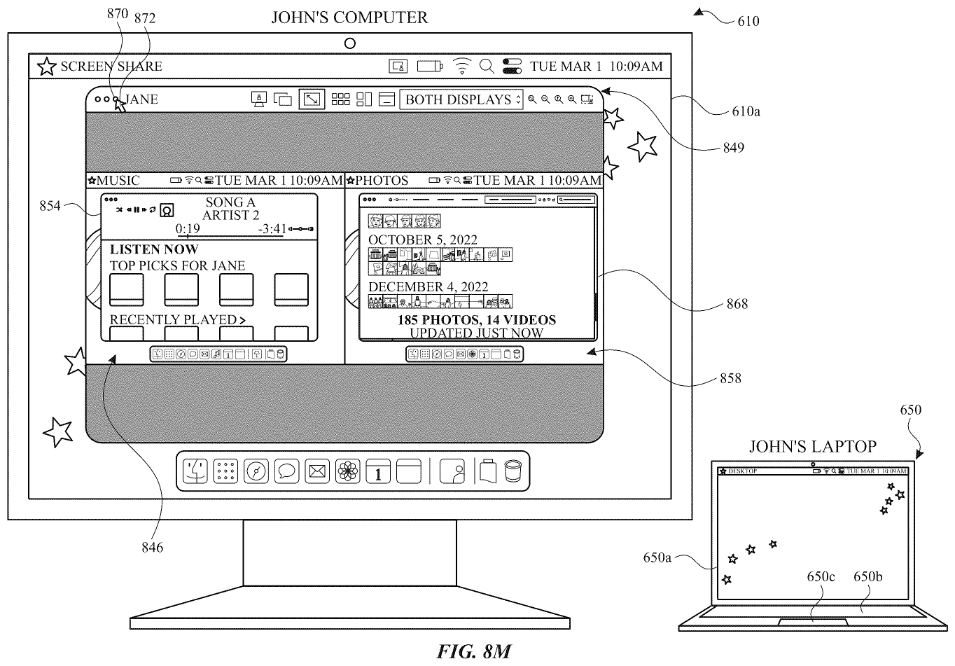

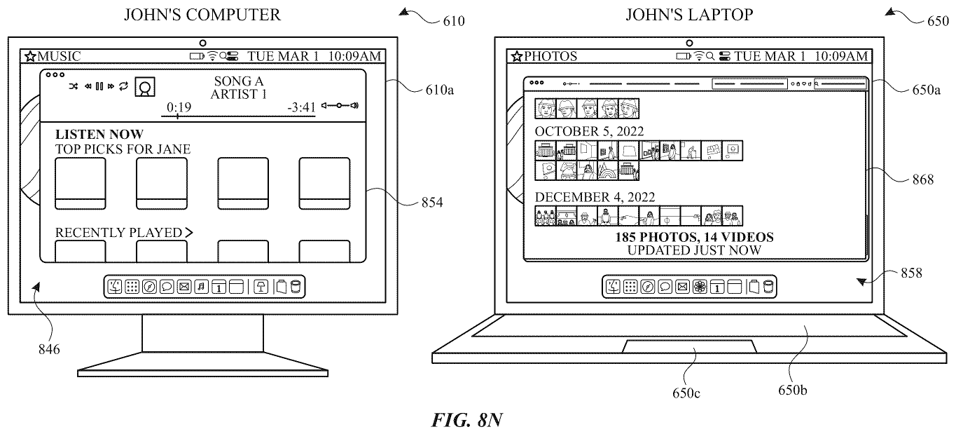

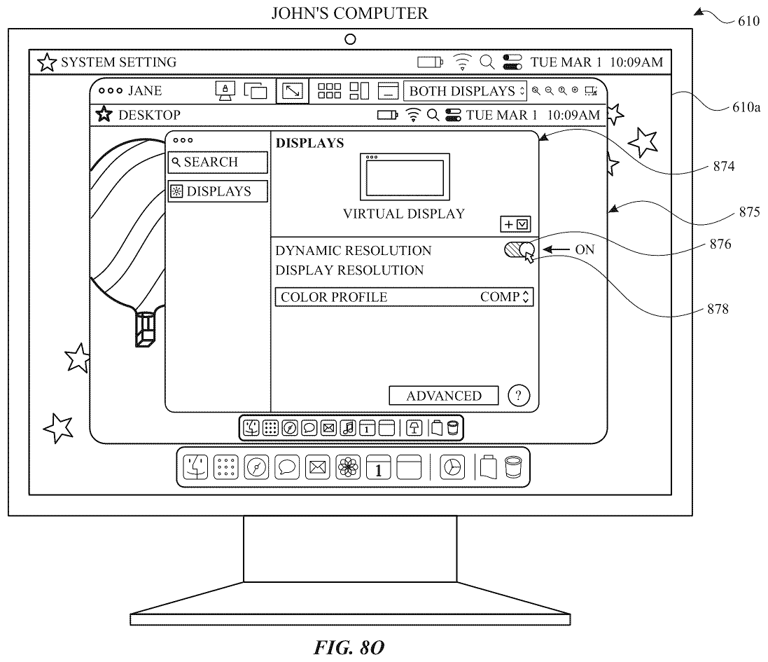

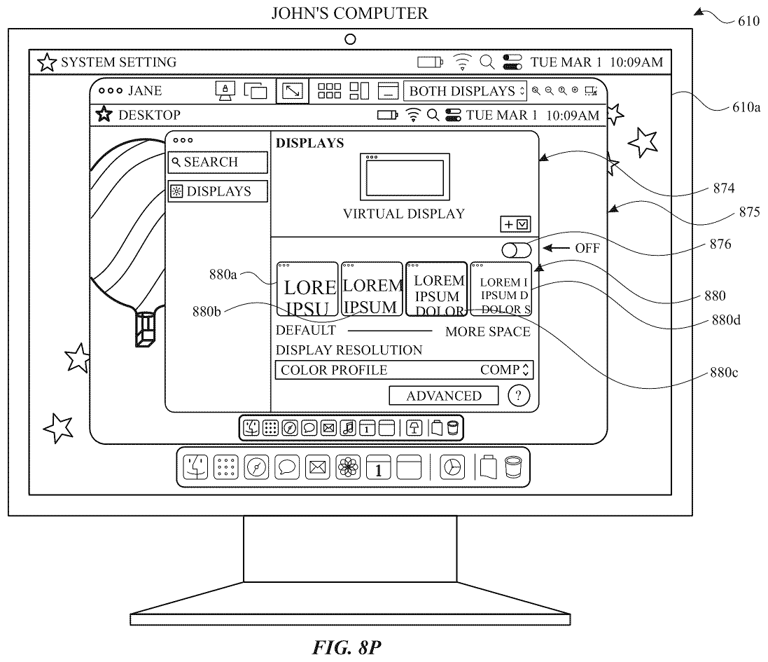

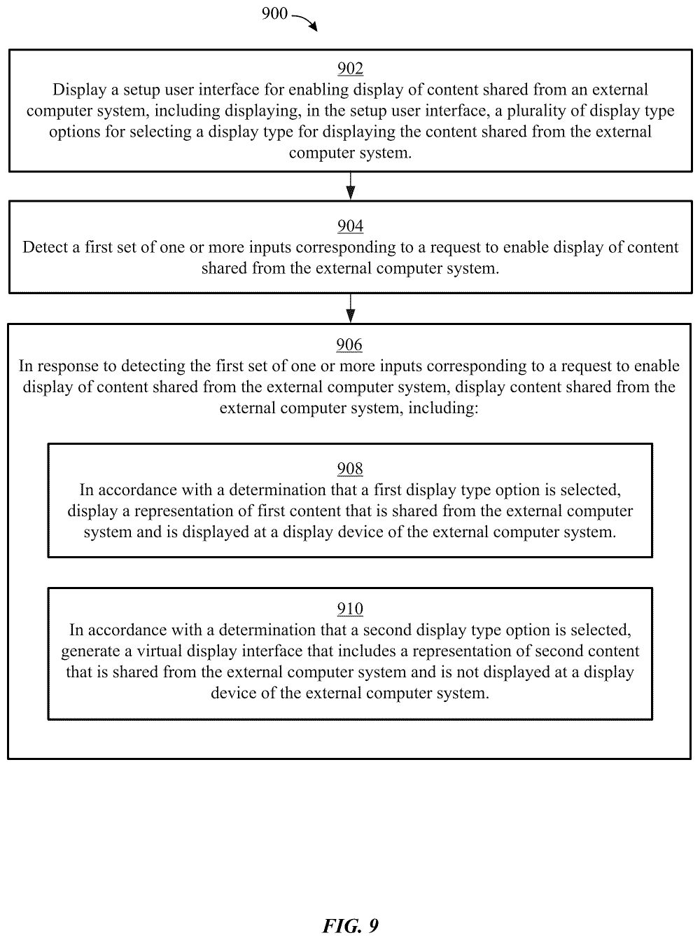

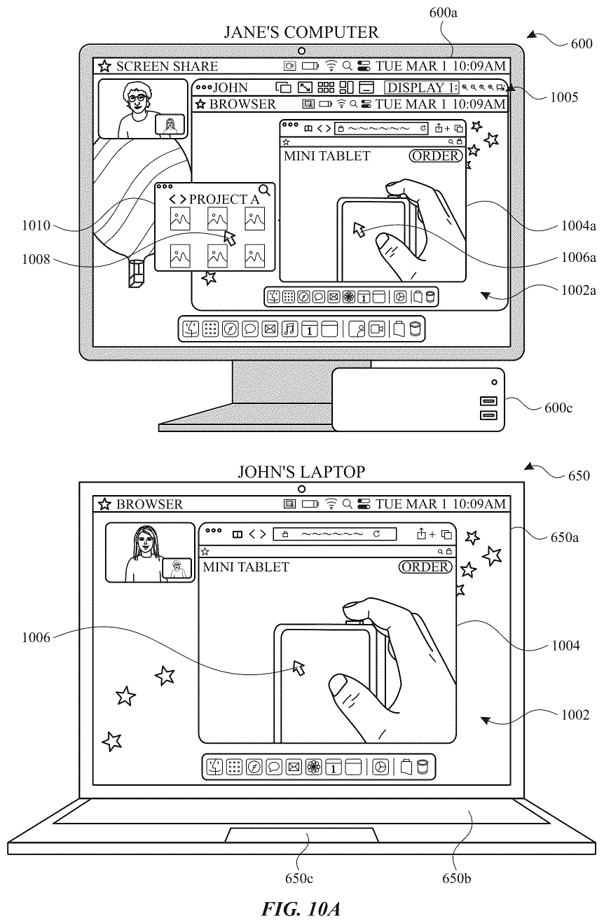

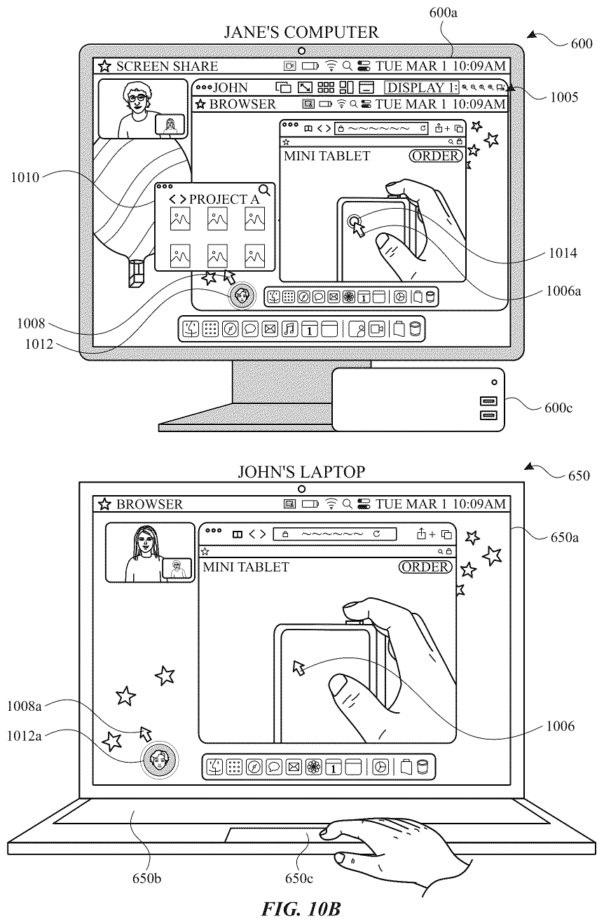

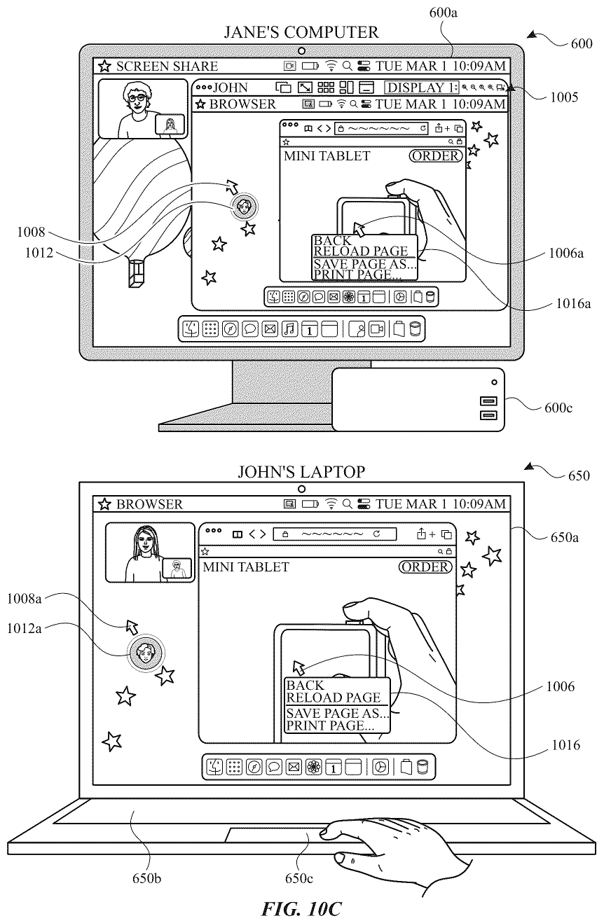

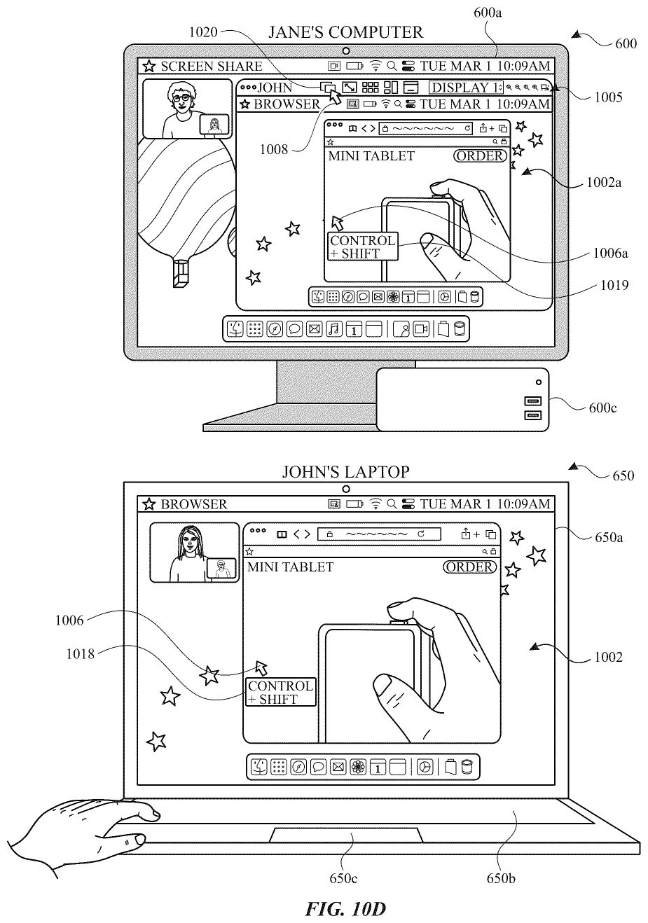

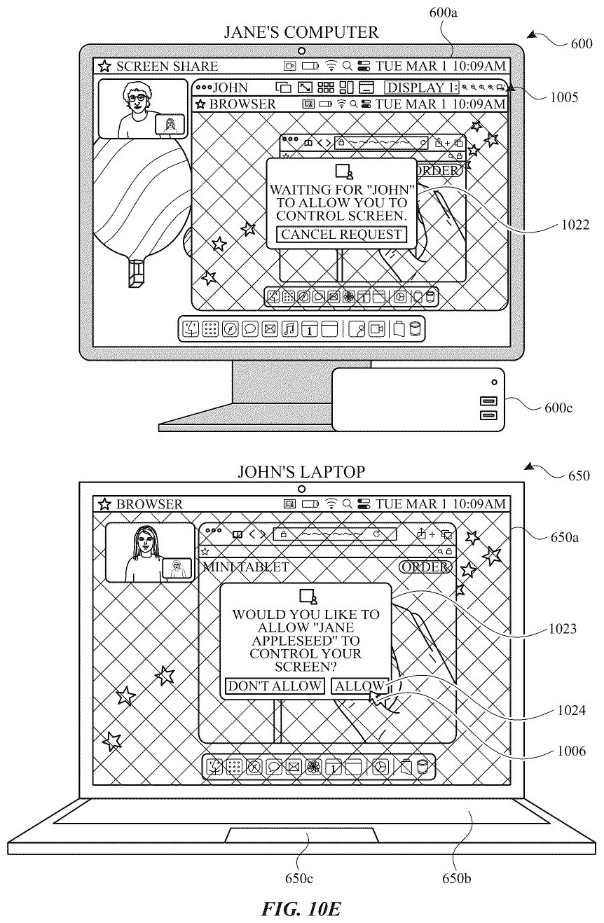

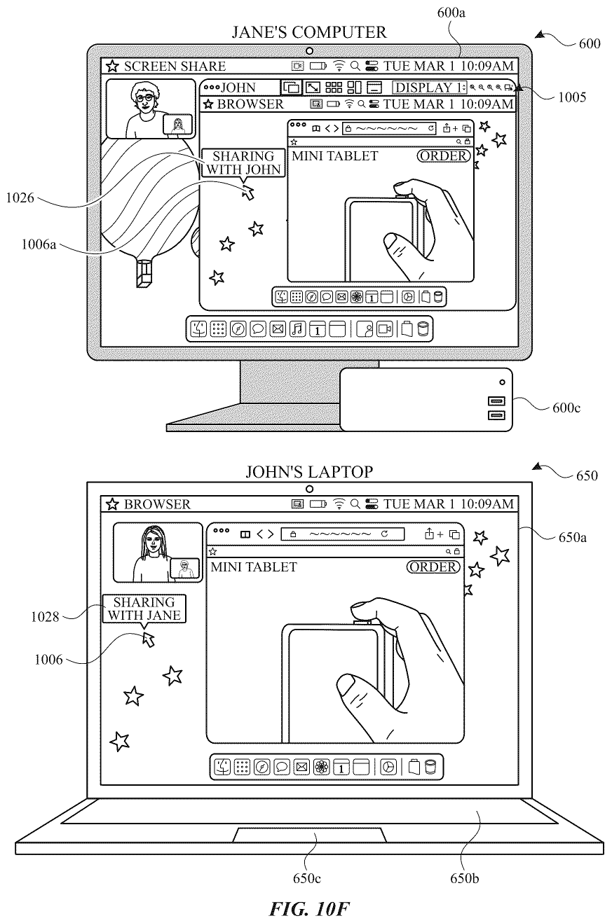

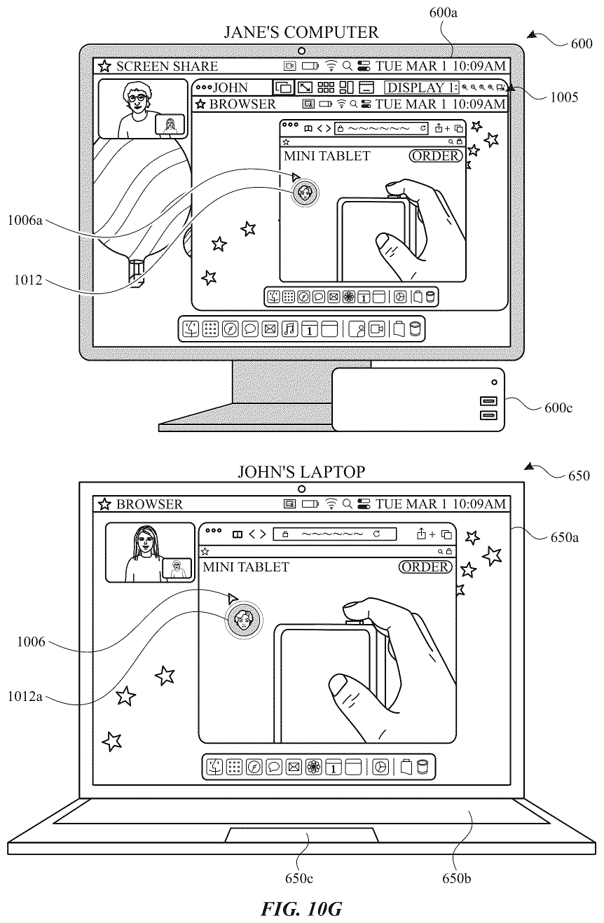

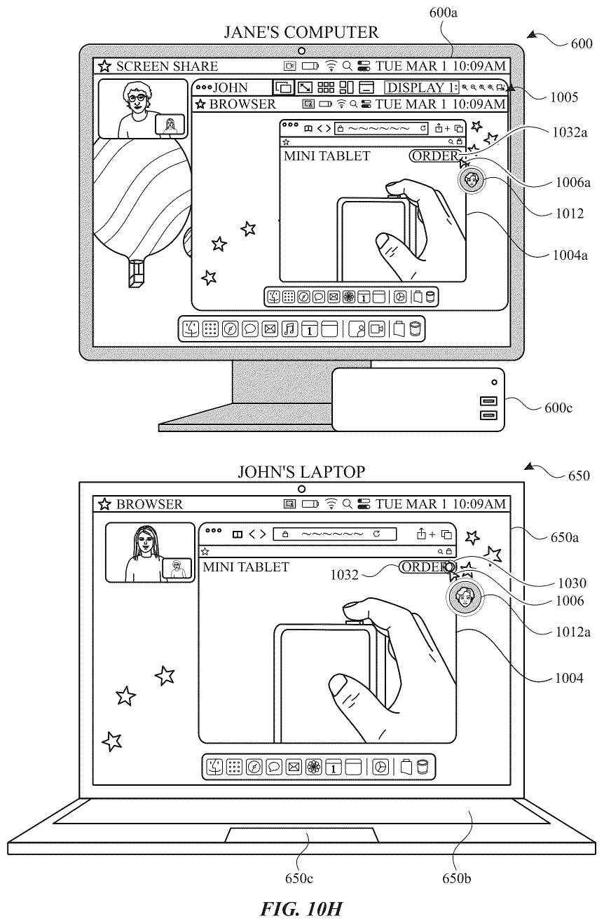

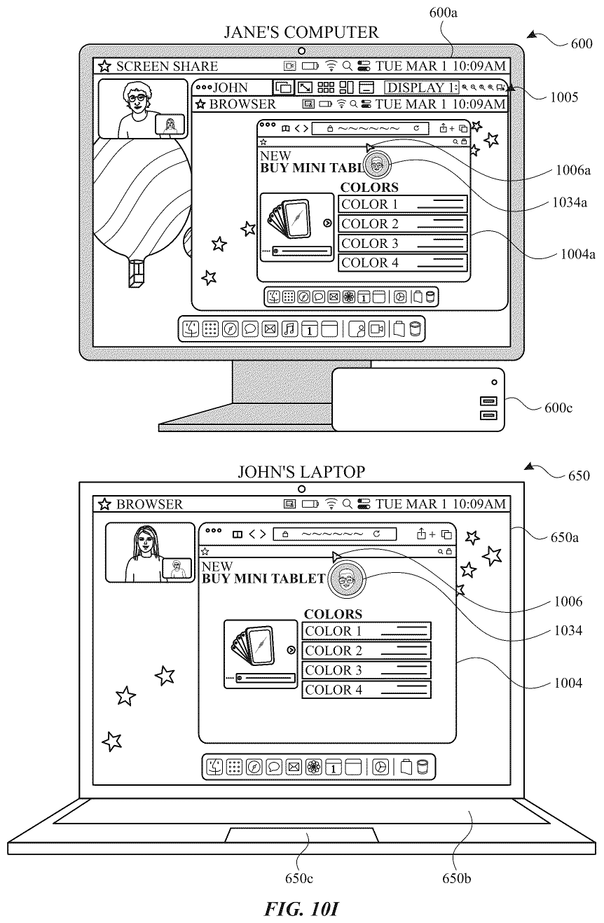

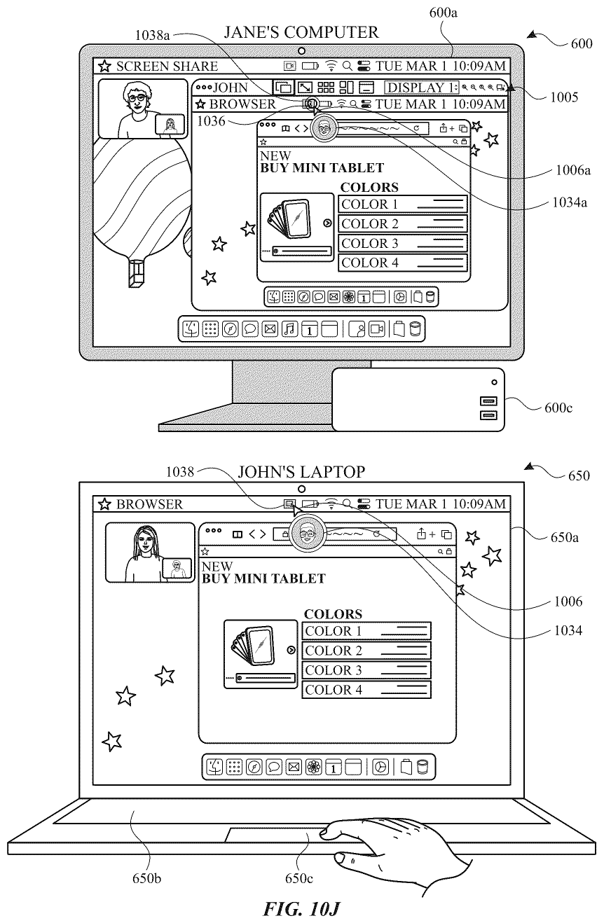

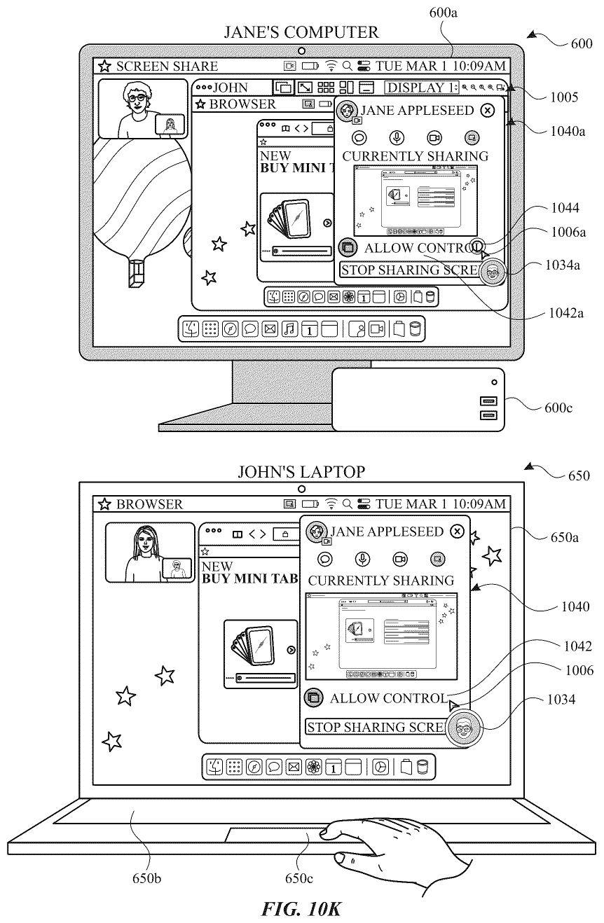

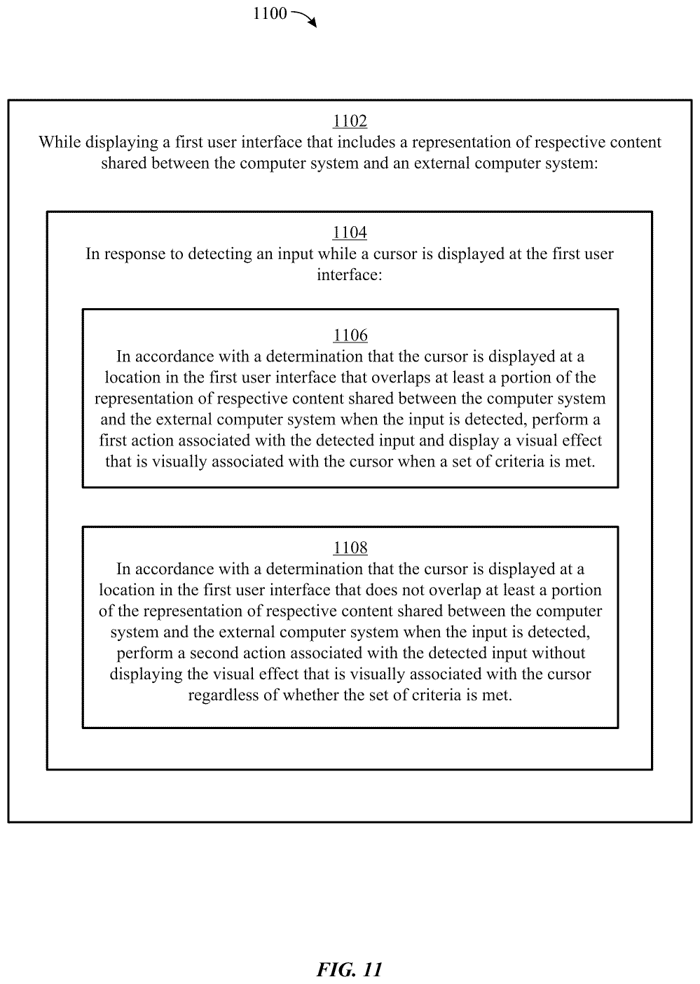

Below, FIGS. 1A-1B, 2, 3, 4A-4B, and 5A-5B provide a description of exemplary devices for performing the techniques for editing, creating, and using stickers. FIGS. 6A-6O illustrate exemplary user interfaces for displaying remote content. FIG. 7 is a flow diagram illustrating methods of displaying remote content, in accordance with some embodiments. The user interfaces in FIGS. 6A-6O are used to illustrate the processes described below, including the processes in FIG. 7. FIGS. 8A-8P illustrate exemplary user interfaces for generating virtual displays for displaying remote content. FIG. 9 is a flow diagram illustrating methods of generating virtual displays for displaying remote content, in accordance with some embodiments. The user interfaces in FIGS. 8A-8P are used to illustrate the processes described below, including the processes in FIG. 9. FIGS. 10A-10K illustrate exemplary user interfaces for displaying shared content. FIG. 11 is a flow diagram illustrating methods of displaying shared content, in accordance with some embodiments. The user interfaces in FIGS. 10A-10K are used to illustrate the processes described below, including the processes in FIG. 11.

The processes described below enhance the operability of the devices and make the user-device interfaces more efficient (e.g., by helping the user to provide proper inputs and reducing user mistakes when operating/interacting with the device) through various techniques, including by providing improved visual feedback to the user, reducing the number of inputs needed to perform an operation, providing additional control options without cluttering the user interface with additional displayed controls, performing an operation when a set of conditions has been met without requiring further user input, providing improved control schemes for viewing shared content, providing improved control schemes for accessing content at remote computer systems, reducing the computational workload of the computer system, and/or additional techniques. These techniques also reduce power usage and improve battery life of the device by enabling the user to use the device more quickly and efficiently.

In addition, in methods described herein where one or more steps are contingent upon one or more conditions having been met, it should be understood that the described method can be repeated in multiple repetitions so that over the course of the repetitions all of the conditions upon which steps in the method are contingent have been met in different repetitions of the method. For example, if a method requires performing a first step if a condition is satisfied, and a second step if the condition is not satisfied, then a person of ordinary skill would appreciate that the claimed steps are repeated until the condition has been both satisfied and not satisfied, in no particular order. Thus, a method described with one or more steps that are contingent upon one or more conditions having been met could be rewritten as a method that is repeated until each of the conditions described in the method has been met. This, however, is not required of system or computer readable medium claims where the system or computer readable medium contains instructions for performing the contingent operations based on the satisfaction of the corresponding one or more conditions and thus is capable of determining whether the contingency has or has not been satisfied without explicitly repeating steps of a method until all of the conditions upon which steps in the method are contingent have been met. A person having ordinary skill in the art would also understand that, similar to a method with contingent steps, a system or computer readable storage medium can repeat the steps of a method as many times as are needed to ensure that all of the contingent steps have been performed.

Although the following description uses terms “first,” “second,” etc. to describe various elements, these elements should not be limited by the terms. In some embodiments, these terms are used to distinguish one element from another. For example, a first touch could be termed a second touch, and, similarly, a second touch could be termed a first touch, without departing from the scope of the various described embodiments. In some embodiments, the first touch and the second touch are two separate references to the same touch. In some embodiments, the first touch and the second touch are both touches, but they are not the same touch.

The terminology used in the description of the various described embodiments herein is for the purpose of describing particular embodiments only and is not intended to be limiting. As used in the description of the various described embodiments and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

The term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

Embodiments of electronic devices, user interfaces for such devices, and associated processes for using such devices are described. In some embodiments, the device is a portable communications device, such as a mobile telephone, that also contains other functions, such as PDA and/or music player functions. Exemplary embodiments of portable multifunction devices include, without limitation, the iPhone®, iPod Touch®, and iPad® devices from Apple Inc. of Cupertino, California. Other portable electronic devices, such as laptops or tablet computers with touch-sensitive surfaces (e.g., touch screen displays and/or touchpads), are, optionally, used. It should also be understood that, in some embodiments, the device is not a portable communications device, but is a desktop computer with a touch-sensitive surface (e.g., a touch screen display and/or a touchpad). In some embodiments, the electronic device is a computer system that is in communication (e.g., via wireless communication, via wired communication) with a display generation component. The display generation component is configured to provide visual output, such as display via a CRT display, display via an LED display, or display via image projection. In some embodiments, the display generation component is integrated with the computer system. In some embodiments, the display generation component is separate from the computer system. As used herein, “displaying” content includes causing to display the content (e.g., video data rendered or decoded by display controller 156) by transmitting, via a wired or wireless connection, data (e.g., image data or video data) to an integrated or external display generation component to visually produce the content.

In the discussion that follows, an electronic device that includes a display and a touch-sensitive surface is described. It should be understood, however, that the electronic device optionally includes one or more other physical user-interface devices, such as a physical keyboard, a mouse, and/or a joystick.

The device typically supports a variety of applications, such as one or more of the following: a drawing application, a presentation application, a word processing application, a website creation application, a disk authoring application, a spreadsheet application, a gaming application, a telephone application, a video conferencing application, an e-mail application, an instant messaging application, a workout support application, a photo management application, a digital camera application, a digital video camera application, a web browsing application, a digital music player application, and/or a digital video player application.

The various applications that are executed on the device optionally use at least one common physical user-interface device, such as the touch-sensitive surface. One or more functions of the touch-sensitive surface as well as corresponding information displayed on the device are, optionally, adjusted and/or varied from one application to the next and/or within a respective application. In this way, a common physical architecture (such as the touch-sensitive surface) of the device optionally supports the variety of applications with user interfaces that are intuitive and transparent to the user.

Attention is now directed toward embodiments of portable devices with touch-sensitive displays. FIG. 1A is a block diagram illustrating portable multifunction device 100 with touch-sensitive display system 112 in accordance with some embodiments. Touch-sensitive display 112 is sometimes called a “touch screen” for convenience and is sometimes known as or called a “touch-sensitive display system.” Device 100 includes memory 102 (which optionally includes one or more computer-readable storage mediums), memory controller 122, one or more processing units (CPUs) 120, peripherals interface 118, RF circuitry 108, audio circuitry 110, speaker 111, microphone 113, input/output (I/O) subsystem 106, other input control devices 116, and external port 124. Device 100 optionally includes one or more optical sensors 164. Device 100 optionally includes one or more contact intensity sensors 165 for detecting intensity of contacts on device 100 (e.g., a touch-sensitive surface such as touch-sensitive display system 112 of device 100). Device 100 optionally includes one or more tactile output generators 167 for generating tactile outputs on device 100 (e.g., generating tactile outputs on a touch-sensitive surface such as touch-sensitive display system 112 of device 100 or touchpad 355 of device 300). These components optionally communicate over one or more communication buses or signal lines 103.

As used in the specification and claims, the term “intensity” of a contact on a touch-sensitive surface refers to the force or pressure (force per unit area) of a contact (e.g., a finger contact) on the touch-sensitive surface, or to a substitute (proxy) for the force or pressure of a contact on the touch-sensitive surface. The intensity of a contact has a range of values that includes at least four distinct values and more typically includes hundreds of distinct values (e.g., at least 256). Intensity of a contact is, optionally, determined (or measured) using various approaches and various sensors or combinations of sensors. For example, one or more force sensors underneath or adjacent to the touch-sensitive surface are, optionally, used to measure force at various points on the touch-sensitive surface. In some implementations, force measurements from multiple force sensors are combined (e.g., a weighted average) to determine an estimated force of a contact. Similarly, a pressure-sensitive tip of a stylus is, optionally, used to determine a pressure of the stylus on the touch-sensitive surface. Alternatively, the size of the contact area detected on the touch-sensitive surface and/or changes thereto, the capacitance of the touch-sensitive surface proximate to the contact and/or changes thereto, and/or the resistance of the touch-sensitive surface proximate to the contact and/or changes thereto are, optionally, used as a substitute for the force or pressure of the contact on the touch-sensitive surface. In some implementations, the substitute measurements for contact force or pressure are used directly to determine whether an intensity threshold has been exceeded (e.g., the intensity threshold is described in units corresponding to the substitute measurements). In some implementations, the substitute measurements for contact force or pressure are converted to an estimated force or pressure, and the estimated force or pressure is used to determine whether an intensity threshold has been exceeded (e.g., the intensity threshold is a pressure threshold measured in units of pressure). Using the intensity of a contact as an attribute of a user input allows for user access to additional device functionality that may otherwise not be accessible by the user on a reduced-size device with limited real estate for displaying affordances (e.g., on a touch-sensitive display) and/or receiving user input (e.g., via a touch-sensitive display, a touch-sensitive surface, or a physical/mechanical control such as a knob or a button).

As used in the specification and claims, the term “tactile output” refers to physical displacement of a device relative to a previous position of the device, physical displacement of a component (e.g., a touch-sensitive surface) of a device relative to another component (e.g., housing) of the device, or displacement of the component relative to a center of mass of the device that will be detected by a user with the user's sense of touch. For example, in situations where the device or the component of the device is in contact with a surface of a user that is sensitive to touch (e.g., a finger, palm, or other part of a user's hand), the tactile output generated by the physical displacement will be interpreted by the user as a tactile sensation corresponding to a perceived change in physical characteristics of the device or the component of the device. For example, movement of a touch-sensitive surface (e.g., a touch-sensitive display or trackpad) is, optionally, interpreted by the user as a “down click” or “up click” of a physical actuator button. In some cases, a user will feel a tactile sensation such as an “down click” or “up click” even when there is no movement of a physical actuator button associated with the touch-sensitive surface that is physically pressed (e.g., displaced) by the user's movements. As another example, movement of the touch-sensitive surface is, optionally, interpreted or sensed by the user as “roughness” of the touch-sensitive surface, even when there is no change in smoothness of the touch-sensitive surface. While such interpretations of touch by a user will be subject to the individualized sensory perceptions of the user, there are many sensory perceptions of touch that are common to a large majority of users. Thus, when a tactile output is described as corresponding to a particular sensory perception of a user (e.g., an “up click,” a “down click,” “roughness”), unless otherwise stated, the generated tactile output corresponds to physical displacement of the device or a component thereof that will generate the described sensory perception for a typical (or average) user.

It should be appreciated that device 100 is only one example of a portable multifunction device, and that device 100 optionally has more or fewer components than shown, optionally combines two or more components, or optionally has a different configuration or arrangement of the components. The various components shown in FIG. 1A are implemented in hardware, software, or a combination of both hardware and software, including one or more signal processing and/or application-specific integrated circuits.

Memory 102 optionally includes high-speed random access memory and optionally also includes non-volatile memory, such as one or more magnetic disk storage devices, flash memory devices, or other non-volatile solid-state memory devices. Memory controller 122 optionally controls access to memory 102 by other components of device 100.

Peripherals interface 118 can be used to couple input and output peripherals of the device to CPU 120 and memory 102. The one or more processors 120 run or execute various software programs (such as computer programs (e.g., including instructions)) and/or sets of instructions stored in memory 102 to perform various functions for device 100 and to process data. In some embodiments, peripherals interface 118, CPU 120, and memory controller 122 are, optionally, implemented on a single chip, such as chip 104. In some other embodiments, they are, optionally, implemented on separate chips.

RF (radio frequency) circuitry 108 receives and sends RF signals, also called electromagnetic signals. RF circuitry 108 converts electrical signals to/from electromagnetic signals and communicates with communications networks and other communications devices via the electromagnetic signals. RF circuitry 108 optionally includes well-known circuitry for performing these functions, including but not limited to an antenna system, an RF transceiver, one or more amplifiers, a tuner, one or more oscillators, a digital signal processor, a CODEC chipset, a subscriber identity module (SIM) card, memory, and so forth. RF circuitry 108 optionally communicates with networks, such as the Internet, also referred to as the World Wide Web (WWW), an intranet and/or a wireless network, such as a cellular telephone network, a wireless local area network (LAN) and/or a metropolitan area network (MAN), and other devices by wireless communication. The RF circuitry 108 optionally includes well-known circuitry for detecting near field communication (NFC) fields, such as by a short-range communication radio. The wireless communication optionally uses any of a plurality of communications standards, protocols, and technologies, including but not limited to Global System for Mobile Communications (GSM), Enhanced Data GSM Environment (EDGE), high-speed downlink packet access (HSDPA), high-speed uplink packet access (HSUPA), Evolution, Data-Only (EV-DO), HSPA, HSPA+, Dual-Cell HSPA (DC-HSPDA), long term evolution (LTE), near field communication (NFC), wideband code division multiple access (W-CDMA), code division multiple access (CDMA), time division multiple access (TDMA), Bluetooth, Bluetooth Low Energy (BTLE), Wireless Fidelity (Wi-Fi) (e.g., IEEE 802.11a, IEEE 802.11b, IEEE 802.11g, IEEE 802.11n, and/or IEEE 802.11ac), voice over Internet Protocol (VOIP), Wi-MAX, a protocol for e-mail (e.g., Internet message access protocol (IMAP) and/or post office protocol (POP)), instant messaging (e.g., extensible messaging and presence protocol (XMPP), Session Initiation Protocol for Instant Messaging and Presence Leveraging Extensions (SIMPLE), Instant Messaging and Presence Service (IMPS)), and/or Short Message Service (SMS), or any other suitable communication protocol, including communication protocols not yet developed as of the filing date of this document.

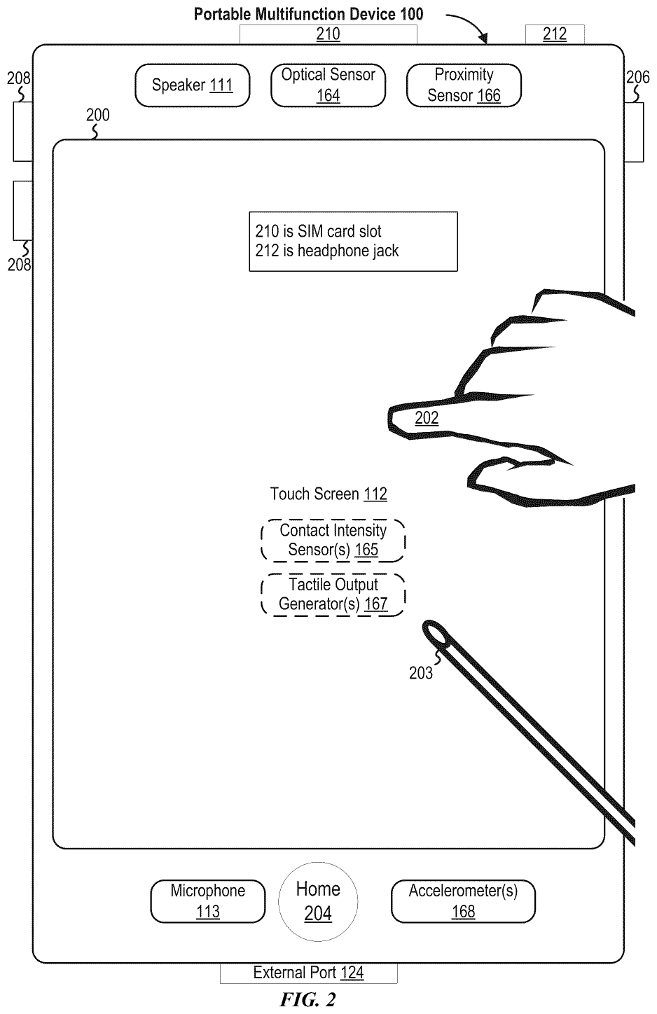

Audio circuitry 110, speaker 111, and microphone 113 provide an audio interface between a user and device 100. Audio circuitry 110 receives audio data from peripherals interface 118, converts the audio data to an electrical signal, and transmits the electrical signal to speaker 111. Speaker 111 converts the electrical signal to human-audible sound waves. Audio circuitry 110 also receives electrical signals converted by microphone 113 from sound waves. Audio circuitry 110 converts the electrical signal to audio data and transmits the audio data to peripherals interface 118 for processing. Audio data is, optionally, retrieved from and/or transmitted to memory 102 and/or RF circuitry 108 by peripherals interface 118. In some embodiments, audio circuitry 110 also includes a headset jack (e.g., 212, FIG. 2). The headset jack provides an interface between audio circuitry 110 and removable audio input/output peripherals, such as output-only headphones or a headset with both output (e.g., a headphone for one or both ears) and input (e.g., a microphone).

I/O subsystem 106 couples input/output peripherals on device 100, such as touch screen 112 and other input control devices 116, to peripherals interface 118. I/O subsystem 106 optionally includes display controller 156, optical sensor controller 158, depth camera controller 169, intensity sensor controller 159, haptic feedback controller 161, and one or more input controllers 160 for other input or control devices. The one or more input controllers 160 receive/send electrical signals from/to other input control devices 116. The other input control devices 116 optionally include physical buttons (e.g., push buttons, rocker buttons, etc.), dials, slider switches, joysticks, click wheels, and so forth. In some embodiments, input controller(s) 160 are, optionally, coupled to any (or none) of the following: a keyboard, an infrared port, a USB port, and a pointer device such as a mouse. The one or more buttons (e.g., 208, FIG. 2) optionally include an up/down button for volume control of speaker 111 and/or microphone 113. The one or more buttons optionally include a push button (e.g., 206, FIG. 2). In some embodiments, the electronic device is a computer system that is in communication (e.g., via wireless communication, via wired communication) with one or more input devices. In some embodiments, the one or more input devices include a touch-sensitive surface (e.g., a trackpad, as part of a touch-sensitive display). In some embodiments, the one or more input devices include one or more camera sensors (e.g., one or more optical sensors 164 and/or one or more depth camera sensors 175), such as for tracking a user's gestures (e.g., hand gestures and/or air gestures) as input. In some embodiments, the one or more input devices are integrated with the computer system. In some embodiments, the one or more input devices are separate from the computer system. In some embodiments, an air gesture is a gesture that is detected without the user touching an input element that is part of the device (or independently of an input element that is a part of the device) and is based on detected motion of a portion of the user's body through the air including motion of the user's body relative to an absolute reference (e.g., an angle of the user's arm relative to the ground or a distance of the user's hand relative to the ground), relative to another portion of the user's body (e.g., movement of a hand of the user relative to a shoulder of the user, movement of one hand of the user relative to another hand of the user, and/or movement of a finger of the user relative to another finger or portion of a hand of the user), and/or absolute motion of a portion of the user's body (e.g., a tap gesture that includes movement of a hand in a predetermined pose by a predetermined amount and/or speed, or a shake gesture that includes a predetermined speed or amount of rotation of a portion of the user's body).

A quick press of the push button optionally disengages a lock of touch screen 112 or optionally begins a process that uses gestures on the touch screen to unlock the device, as described in U.S. patent application Ser. No. 11/322,549, “Unlocking a Device by Performing Gestures on an Unlock Image,” filed Dec. 23, 2005, U.S. Pat. No. 7,657,849, which is hereby incorporated by reference in its entirety. A longer press of the push button (e.g., 206) optionally turns power to device 100 on or off. The functionality of one or more of the buttons are, optionally, user-customizable. Touch screen 112 is used to implement virtual or soft buttons and one or more soft keyboards.

Touch-sensitive display 112 provides an input interface and an output interface between the device and a user. Display controller 156 receives and/or sends electrical signals from/to touch screen 112. Touch screen 112 displays visual output to the user. The visual output optionally includes graphics, text, icons, video, and any combination thereof (collectively termed “graphics”). In some embodiments, some or all of the visual output optionally corresponds to user-interface objects.

Touch screen 112 has a touch-sensitive surface, sensor, or set of sensors that accepts input from the user based on haptic and/or tactile contact. Touch screen 112 and display controller 156 (along with any associated modules and/or sets of instructions in memory 102) detect contact (and any movement or breaking of the contact) on touch screen 112 and convert the detected contact into interaction with user-interface objects (e.g., one or more soft keys, icons, web pages, or images) that are displayed on touch screen 112. In an exemplary embodiment, a point of contact between touch screen 112 and the user corresponds to a finger of the user.

Touch screen 112 optionally uses LCD (liquid crystal display) technology, LPD (light emitting polymer display) technology, or LED (light emitting diode) technology, although other display technologies are used in other embodiments. Touch screen 112 and display controller 156 optionally detect contact and any movement or breaking thereof using any of a plurality of touch sensing technologies now known or later developed, including but not limited to capacitive, resistive, infrared, and surface acoustic wave technologies, as well as other proximity sensor arrays or other elements for determining one or more points of contact with touch screen 112. In an exemplary embodiment, projected mutual capacitance sensing technology is used, such as that found in the iPhone® and iPod Touch® from Apple Inc. of Cupertino, California.

A touch-sensitive display in some embodiments of touch screen 112 is, optionally, analogous to the multi-touch sensitive touchpads described in the following U.S. Pat. No. 6,323,846 (Westerman et al.), U.S. Pat. No. 6,570,557 (Westerman et al.), and/or U.S. Pat. No. 6,677,932 (Westerman), and/or U.S. Patent Publication 2002/0015024A1, each of which is hereby incorporated by reference in its entirety. However, touch screen 112 displays visual output from device 100, whereas touch-sensitive touchpads do not provide visual output.

A touch-sensitive display in some embodiments of touch screen 112 is described in the following applications: (1) U.S. patent application Ser. No. 11/381,313, “Multipoint Touch Surface Controller,” filed May 2, 2006; (2) U.S. patent application Ser. No. 10/840,862, “Multipoint Touchscreen,” filed May 6, 2004; (3) U.S. patent application Ser. No. 10/903,964, “Gestures For Touch Sensitive Input Devices,” filed Jul. 30, 2004; (4) U.S. patent application Ser. No. 11/048,264, “Gestures For Touch Sensitive Input Devices,” filed Jan. 31, 2005; (5) U.S. patent application Ser. No. 11/038,590, “Mode-Based Graphical User Interfaces For Touch Sensitive Input Devices,” filed Jan. 18, 2005; (6) U.S. patent application Ser. No. 11/228,758, “Virtual Input Device Placement On A Touch Screen User Interface,” filed Sep. 16, 2005; (7) U.S. patent application Ser. No. 11/228,700, “Operation Of A Computer With A Touch Screen Interface,” filed Sep. 16, 2005; (8) U.S. patent application Ser. No. 11/228,737, “Activating Virtual Keys Of A Touch-Screen Virtual Keyboard,” filed Sep. 16, 2005; and (9) U.S. patent application Ser. No. 11/367,749, “Multi-Functional Hand-Held Device,” filed Mar. 3, 2006. All of these applications are incorporated by reference herein in their entirety.

Touch screen 112 optionally has a video resolution in excess of 100 dpi. In some embodiments, the touch screen has a video resolution of approximately 160 dpi. The user optionally makes contact with touch screen 112 using any suitable object or appendage, such as a stylus, a finger, and so forth. In some embodiments, the user interface is designed to work primarily with finger-based contacts and gestures, which can be less precise than stylus-based input due to the larger area of contact of a finger on the touch screen. In some embodiments, the device translates the rough finger-based input into a precise pointer/cursor position or command for performing the actions desired by the user.

In some embodiments, in addition to the touch screen, device 100 optionally includes a touchpad for activating or deactivating particular functions. In some embodiments, the touchpad is a touch-sensitive area of the device that, unlike the touch screen, does not display visual output. The touchpad is, optionally, a touch-sensitive surface that is separate from touch screen 112 or an extension of the touch-sensitive surface formed by the touch screen.

Device 100 also includes power system 162 for powering the various components. Power system 162 optionally includes a power management system, one or more power sources (e.g., battery, alternating current (AC)), a recharging system, a power failure detection circuit, a power converter or inverter, a power status indicator (e.g., a light-emitting diode (LED)) and any other components associated with the generation, management and distribution of power in portable devices.

Device 100 optionally also includes one or more optical sensors 164. FIG. 1A shows an optical sensor coupled to optical sensor controller 158 in I/O subsystem 106. Optical sensor 164 optionally includes charge-coupled device (CCD) or complementary metal-oxide semiconductor (CMOS) phototransistors. Optical sensor 164 receives light from the environment, projected through one or more lenses, and converts the light to data representing an image. In conjunction with imaging module 143 (also called a camera module), optical sensor 164 optionally captures still images or video. In some embodiments, an optical sensor is located on the back of device 100, opposite touch screen display 112 on the front of the device so that the touch screen display is enabled for use as a viewfinder for still and/or video image acquisition. In some embodiments, an optical sensor is located on the front of the device so that the user's image is, optionally, obtained for video conferencing while the user views the other video conference participants on the touch screen display. In some embodiments, the position of optical sensor 164 can be changed by the user (e.g., by rotating the lens and the sensor in the device housing) so that a single optical sensor 164 is used along with the touch screen display for both video conferencing and still and/or video image acquisition.

Device 100 optionally also includes one or more depth camera sensors 175. FIG. 1A shows a depth camera sensor coupled to depth camera controller 169 in I/O subsystem 106. Depth camera sensor 175 receives data from the environment to create a three dimensional model of an object (e.g., a face) within a scene from a viewpoint (e.g., a depth camera sensor). In some embodiments, in conjunction with imaging module 143 (also called a camera module), depth camera sensor 175 is optionally used to determine a depth map of different portions of an image captured by the imaging module 143. In some embodiments, a depth camera sensor is located on the front of device 100 so that the user's image with depth information is, optionally, obtained for video conferencing while the user views the other video conference participants on the touch screen display and to capture selfies with depth map data. In some embodiments, the depth camera sensor 175 is located on the back of device, or on the back and the front of the device 100. In some embodiments, the position of depth camera sensor 175 can be changed by the user (e.g., by rotating the lens and the sensor in the device housing) so that a depth camera sensor 175 is used along with the touch screen display for both video conferencing and still and/or video image acquisition.

Device 100 optionally also includes one or more contact intensity sensors 165. FIG. 1A shows a contact intensity sensor coupled to intensity sensor controller 159 in I/O subsystem 106. Contact intensity sensor 165 optionally includes one or more piezoresistive strain gauges, capacitive force sensors, electric force sensors, piezoelectric force sensors, optical force sensors, capacitive touch-sensitive surfaces, or other intensity sensors (e.g., sensors used to measure the force (or pressure) of a contact on a touch-sensitive surface). Contact intensity sensor 165 receives contact intensity information (e.g., pressure information or a proxy for pressure information) from the environment. In some embodiments, at least one contact intensity sensor is collocated with, or proximate to, a touch-sensitive surface (e.g., touch-sensitive display system 112). In some embodiments, at least one contact intensity sensor is located on the back of device 100, opposite touch screen display 112, which is located on the front of device 100.

Device 100 optionally also includes one or more proximity sensors 166. FIG. 1A shows proximity sensor 166 coupled to peripherals interface 118. Alternately, proximity sensor 166 is, optionally, coupled to input controller 160 in I/O subsystem 106. Proximity sensor 166 optionally performs as described in U.S. patent application Ser. No. 11/241,839, “Proximity Detector In Handheld Device”; Ser. No. 11/240,788, “Proximity Detector In Handheld Device”; Ser. No. 11/620,702, “Using Ambient Light Sensor To Augment Proximity Sensor Output”; Ser. No. 11/586,862, “Automated Response To And Sensing Of User Activity In Portable Devices”; and Ser. No. 11/638,251, “Methods And Systems For Automatic Configuration Of Peripherals,” which are hereby incorporated by reference in their entirety. In some embodiments, the proximity sensor turns off and disables touch screen 112 when the multifunction device is placed near the user's ear (e.g., when the user is making a phone call).

Device 100 optionally also includes one or more tactile output generators 167. FIG. 1A shows a tactile output generator coupled to haptic feedback controller 161 in I/O subsystem 106. Tactile output generator 167 optionally includes one or more electroacoustic devices such as speakers or other audio components and/or electromechanical devices that convert energy into linear motion such as a motor, solenoid, electroactive polymer, piezoelectric actuator, electrostatic actuator, or other tactile output generating component (e.g., a component that converts electrical signals into tactile outputs on the device). Contact intensity sensor 165 receives tactile feedback generation instructions from haptic feedback module 133 and generates tactile outputs on device 100 that are capable of being sensed by a user of device 100. In some embodiments, at least one tactile output generator is collocated with, or proximate to, a touch-sensitive surface (e.g., touch-sensitive display system 112) and, optionally, generates a tactile output by moving the touch-sensitive surface vertically (e.g., in/out of a surface of device 100) or laterally (e.g., back and forth in the same plane as a surface of device 100). In some embodiments, at least one tactile output generator sensor is located on the back of device 100, opposite touch screen display 112, which is located on the front of device 100.

Device 100 optionally also includes one or more accelerometers 168. FIG. 1A shows accelerometer 168 coupled to peripherals interface 118. Alternately, accelerometer 168 is, optionally, coupled to an input controller 160 in I/O subsystem 106. Accelerometer 168 optionally performs as described in U.S. Patent Publication No. 20050190059, “Acceleration-based Theft Detection System for Portable Electronic Devices,” and U.S. Patent Publication No. 20060017692, “Methods And Apparatuses For Operating A Portable Device Based On An Accelerometer,” both of which are incorporated by reference herein in their entirety. In some embodiments, information is displayed on the touch screen display in a portrait view or a landscape view based on an analysis of data received from the one or more accelerometers. Device 100 optionally includes, in addition to accelerometer(s) 168, a magnetometer and a GPS (or GLONASS or other global navigation system) receiver for obtaining information concerning the location and orientation (e.g., portrait or landscape) of device 100.

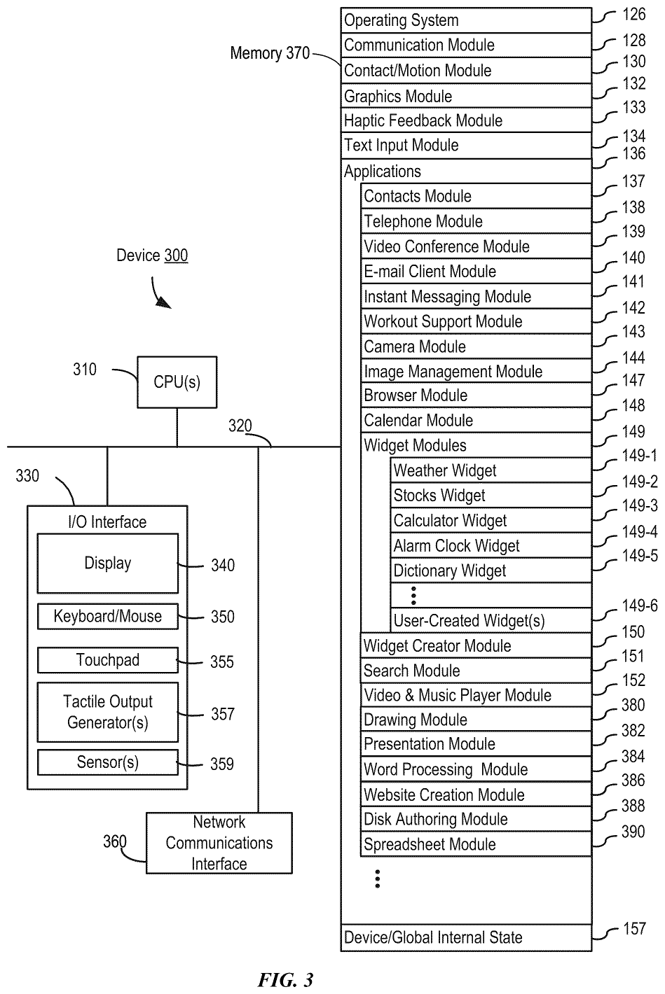

In some embodiments, the software components stored in memory 102 include operating system 126, communication module (or set of instructions) 128, contact/motion module (or set of instructions) 130, graphics module (or set of instructions) 132, text input module (or set of instructions) 134, Global Positioning System (GPS) module (or set of instructions) 135, and applications (or sets of instructions) 136. Furthermore, in some embodiments, memory 102 (FIG. 1A) or 370 (FIG. 3) stores device/global internal state 157, as shown in FIGS. 1A and 3. Device/global internal state 157 includes one or more of: active application state, indicating which applications, if any, are currently active; display state, indicating what applications, views or other information occupy various regions of touch screen display 112; sensor state, including information obtained from the device's various sensors and input control devices 116; and location information concerning the device's location and/or attitude.

Operating system 126 (e.g., Darwin, RTXC, LINUX, UNIX, OS X, IOS, WINDOWS, or an embedded operating system such as VxWorks) includes various software components and/or drivers for controlling and managing general system tasks (e.g., memory management, storage device control, power management, etc.) and facilitates communication between various hardware and software components.

Communication module 128 facilitates communication with other devices over one or more external ports 124 and also includes various software components for handling data received by RF circuitry 108 and/or external port 124. External port 124 (e.g., Universal Serial Bus (USB), FIREWIRE, etc.) is adapted for coupling directly to other devices or indirectly over a network (e.g., the Internet, wireless LAN, etc.). In some embodiments, the external port is a multi-pin (e.g., 30-pin) connector that is the same as, or similar to and/or compatible with, the 30-pin connector used on iPod® (trademark of Apple Inc.) devices.

Contact/motion module 130 optionally detects contact with touch screen 112 (in conjunction with display controller 156) and other touch-sensitive devices (e.g., a touchpad or physical click wheel). Contact/motion module 130 includes various software components for performing various operations related to detection of contact, such as determining if contact has occurred (e.g., detecting a finger-down event), determining an intensity of the contact (e.g., the force or pressure of the contact or a substitute for the force or pressure of the contact), determining if there is movement of the contact and tracking the movement across the touch-sensitive surface (e.g., detecting one or more finger-dragging events), and determining if the contact has ceased (e.g., detecting a finger-up event or a break in contact). Contact/motion module 130 receives contact data from the touch-sensitive surface. Determining movement of the point of contact, which is represented by a series of contact data, optionally includes determining speed (magnitude), velocity (magnitude and direction), and/or an acceleration (a change in magnitude and/or direction) of the point of contact. These operations are, optionally, applied to single contacts (e.g., one finger contacts) or to multiple simultaneous contacts (e.g., “multitouch”/multiple finger contacts). In some embodiments, contact/motion module 130 and display controller 156 detect contact on a touchpad.

In some embodiments, contact/motion module 130 uses a set of one or more intensity thresholds to determine whether an operation has been performed by a user (e.g., to determine whether a user has “clicked” on an icon). In some embodiments, at least a subset of the intensity thresholds are determined in accordance with software parameters (e.g., the intensity thresholds are not determined by the activation thresholds of particular physical actuators and can be adjusted without changing the physical hardware of device 100). For example, a mouse “click” threshold of a trackpad or touch screen display can be set to any of a large range of predefined threshold values without changing the trackpad or touch screen display hardware. Additionally, in some implementations, a user of the device is provided with software settings for adjusting one or more of the set of intensity thresholds (e.g., by adjusting individual intensity thresholds and/or by adjusting a plurality of intensity thresholds at once with a system-level click “intensity” parameter).

Contact/motion module 130 optionally detects a gesture input by a user. Different gestures on the touch-sensitive surface have different contact patterns (e.g., different motions, timings, and/or intensities of detected contacts). Thus, a gesture is, optionally, detected by detecting a particular contact pattern. For example, detecting a finger tap gesture includes detecting a finger-down event followed by detecting a finger-up (liftoff) event at the same position (or substantially the same position) as the finger-down event (e.g., at the position of an icon). As another example, detecting a finger swipe gesture on the touch-sensitive surface includes detecting a finger-down event followed by detecting one or more finger-dragging events, and subsequently followed by detecting a finger-up (liftoff) event.

Graphics module 132 includes various known software components for rendering and displaying graphics on touch screen 112 or other display, including components for changing the visual impact (e.g., brightness, transparency, saturation, contrast, or other visual property) of graphics that are displayed. As used herein, the term “graphics” includes any object that can be displayed to a user, including, without limitation, text, web pages, icons (such as user-interface objects including soft keys), digital images, videos, animations, and the like.

In some embodiments, graphics module 132 stores data representing graphics to be used. Each graphic is, optionally, assigned a corresponding code. Graphics module 132 receives, from applications etc., one or more codes specifying graphics to be displayed along with, if necessary, coordinate data and other graphic property data, and then generates screen image data to output to display controller 156.

Haptic feedback module 133 includes various software components for generating instructions used by tactile output generator(s) 167 to produce tactile outputs at one or more locations on device 100 in response to user interactions with device 100.

Text input module 134, which is, optionally, a component of graphics module 132, provides soft keyboards for entering text in various applications (e.g., contacts module 137, e-mail client module 140, IM module 141, browser module 147, and any other application that needs text input).

GPS module 135 determines the location of the device and provides this information for use in various applications (e.g., to telephone module 138 for use in location-based dialing; to camera module 143 as picture/video metadata; and to applications that provide location-based services such as weather widgets, local yellow page widgets, and map/navigation widgets).

Applications 136 optionally include the following modules (or sets of instructions), or a subset or superset thereof:
Contacts module 137 (sometimes called an address book or contact list);
Telephone module 138;
Video conference module 139;
E-mail client module 140;
Instant messaging (IM) module 141;
Workout support module 142;
Camera module 143 for still and/or video images;
Image management module 144;
Video player module;
Music player module;
Browser module 147;
Calendar module 148;
Widget modules 149, which optionally include one or more of: weather widget 149-1, stocks widget 149-2, calculator widget 149-3, alarm clock widget 149-4, dictionary widget 149-5, and other widgets obtained by the user, as well as user-created widgets 149-6;
Widget creator module 150 for making user-created widgets 149-6;
Search module 151;
Video and music player module 152, which merges video player module and music player module;
Notes module 153;
Map module 154; and/or
Online video module 155.

Examples of other applications 136 that are, optionally, stored in memory 102 include other word processing applications, other image editing applications, drawing applications, presentation applications, JAVA-enabled applications, encryption, digital rights management, voice recognition, and voice replication.

In conjunction with touch screen 112, display controller 156, contact/motion module 130, graphics module 132, and text input module 134, contacts module 137 are, optionally, used to manage an address book or contact list (e.g., stored in application internal state 192 of contacts module 137 in memory 102 or memory 370), including: adding name(s) to the address book; deleting name(s) from the address book; associating telephone number(s), e-mail address(es), physical address(es) or other information with a name; associating an image with a name; categorizing and sorting names; providing telephone numbers or e-mail addresses to initiate and/or facilitate communications by telephone module 138, video conference module 139, e-mail client module 140, or IM module 141; and so forth.

In conjunction with RF circuitry 108, audio circuitry 110, speaker 111, microphone 113, touch screen 112, display controller 156, contact/motion module 130, graphics module 132, and text input module 134, telephone module 138 are optionally, used to enter a sequence of characters corresponding to a telephone number, access one or more telephone numbers in contacts module 137, modify a telephone number that has been entered, dial a respective telephone number, conduct a conversation, and disconnect or hang up when the conversation is completed. As noted above, the wireless communication optionally uses any of a plurality of communications standards, protocols, and technologies.

In conjunction with RF circuitry 108, audio circuitry 110, speaker 111, microphone 113, touch screen 112, display controller 156, optical sensor 164, optical sensor controller 158, contact/motion module 130, graphics module 132, text input module 134, contacts module 137, and telephone module 138, video conference module 139 includes executable instructions to initiate, conduct, and terminate a video conference between a user and one or more other participants in accordance with user instructions.

In conjunction with RF circuitry 108, touch screen 112, display controller 156, contact/motion module 130, graphics module 132, and text input module 134, e-mail client module 140 includes executable instructions to create, send, receive, and manage e-mail in response to user instructions. In conjunction with image management module 144, e-mail client module 140 makes it very easy to create and send e-mails with still or video images taken with camera module 143.

In conjunction with RF circuitry 108, touch screen 112, display controller 156, contact/motion module 130, graphics module 132, and text input module 134, the instant messaging module 141 includes executable instructions to enter a sequence of characters corresponding to an instant message, to modify previously entered characters, to transmit a respective instant message (for example, using a Short Message Service (SMS) or Multimedia Message Service (MMS) protocol for telephony-based instant messages or using XMPP, SIMPLE, or IMPS for Internet-based instant messages), to receive instant messages, and to view received instant messages. In some embodiments, transmitted and/or received instant messages optionally include graphics, photos, audio files, video files and/or other attachments as are supported in an MMS and/or an Enhanced Messaging Service (EMS). As used herein, “instant messaging” refers to both telephony-based messages (e.g., messages sent using SMS or MMS) and Internet-based messages (e.g., messages sent using XMPP, SIMPLE, or IMPS).

In conjunction with RF circuitry 108, touch screen 112, display controller 156, contact/motion module 130, graphics module 132, text input module 134, GPS module 135, map module 154, and music player module, workout support module 142 includes executable instructions to create workouts (e.g., with time, distance, and/or calorie burning goals); communicate with workout sensors (sports devices); receive workout sensor data; calibrate sensors used to monitor a workout; select and play music for a workout; and display, store, and transmit workout data.

In conjunction with touch screen 112, display controller 156, optical sensor(s) 164, optical sensor controller 158, contact/motion module 130, graphics module 132, and image management module 144, camera module 143 includes executable instructions to capture still images or video (including a video stream) and store them into memory 102, modify characteristics of a still image or video, or delete a still image or video from memory 102.

In conjunction with touch screen 112, display controller 156, contact/motion module 130, graphics module 132, text input module 134, and camera module 143, image management module 144 includes executable instructions to arrange, modify (e.g., edit), or otherwise manipulate, label, delete, present (e.g., in a digital slide show or album), and store still and/or video images.

In conjunction with RF circuitry 108, touch screen 112, display controller 156, contact/motion module 130, graphics module 132, and text input module 134, browser module 147 includes executable instructions to browse the Internet in accordance with user instructions, including searching, linking to, receiving, and displaying web pages or portions thereof, as well as attachments and other files linked to web pages.

In conjunction with RF circuitry 108, touch screen 112, display controller 156, contact/motion module 130, graphics module 132, text input module 134, e-mail client module 140, and browser module 147, calendar module 148 includes executable instructions to create, display, modify, and store calendars and data associated with calendars (e.g., calendar entries, to-do lists, etc.) in accordance with user instructions.

In conjunction with RF circuitry 108, touch screen 112, display controller 156, contact/motion module 130, graphics module 132, text input module 134, and browser module 147, widget modules 149 are mini-applications that are, optionally, downloaded and used by a user (e.g., weather widget 149-1, stocks widget 149-2, calculator widget 149-3, alarm clock widget 149-4, and dictionary widget 149-5) or created by the user (e.g., user-created widget 149-6). In some embodiments, a widget includes an HTML (Hypertext Markup Language) file, a CSS (Cascading Style Sheets) file, and a JavaScript file. In some embodiments, a widget includes an XML (Extensible Markup Language) file and a JavaScript file (e.g., Yahoo! Widgets).

In conjunction with RF circuitry 108, touch screen 112, display controller 156, contact/motion module 130, graphics module 132, text input module 134, and browser module 147, the widget creator module 150 are, optionally, used by a user to create widgets (e.g., turning a user-specified portion of a web page into a widget).

In conjunction with touch screen 112, display controller 156, contact/motion module 130, graphics module 132, and text input module 134, search module 151 includes executable instructions to search for text, music, sound, image, video, and/or other files in memory 102 that match one or more search criteria (e.g., one or more user-specified search terms) in accordance with user instructions.

In conjunction with touch screen 112, display controller 156, contact/motion module 130, graphics module 132, audio circuitry 110, speaker 111, RF circuitry 108, and browser module 147, video and music player module 152 includes executable instructions that allow the user to download and play back recorded music and other sound files stored in one or more file formats, such as MP3 or AAC files, and executable instructions to display, present, or otherwise play back videos (e.g., on touch screen 112 or on an external, connected display via external port 124). In some embodiments, device 100 optionally includes the functionality of an MP3 player, such as an iPod (trademark of Apple Inc.).

In conjunction with touch screen 112, display controller 156, contact/motion module 130, graphics module 132, and text input module 134, notes module 153 includes executable instructions to create and manage notes, to-do lists, and the like in accordance with user instructions.

In conjunction with RF circuitry 108, touch screen 112, display controller 156, contact/motion module 130, graphics module 132, text input module 134, GPS module 135, and browser module 147, map module 154 are, optionally, used to receive, display, modify, and store maps and data associated with maps (e.g., driving directions, data on stores and other points of interest at or near a particular location, and other location-based data) in accordance with user instructions.

In conjunction with touch screen 112, display controller 156, contact/motion module 130, graphics module 132, audio circuitry 110, speaker 111, RF circuitry 108, text input module 134, e-mail client module 140, and browser module 147, online video module 155 includes instructions that allow the user to access, browse, receive (e.g., by streaming and/or download), play back (e.g., on the touch screen or on an external, connected display via external port 124), send an e-mail with a link to a particular online video, and otherwise manage online videos in one or more file formats, such as H.264. In some embodiments, instant messaging module 141, rather than e-mail client module 140, is used to send a link to a particular online video. Additional description of the online video application can be found in U.S. Provisional Patent Application No. 60/936,562, “Portable Multifunction Device, Method, and Graphical User Interface for Playing Online Videos,” filed Jun. 20, 2007, and U.S. patent application Ser. No. 11/968,067, “Portable Multifunction Device, Method, and Graphical User Interface for Playing Online Videos,” filed Dec. 31, 2007, the contents of which are hereby incorporated by reference in their entirety.

Each of the above-identified modules and applications corresponds to a set of executable instructions for performing one or more functions described above and the methods described in this application (e.g., the computer-implemented methods and other information processing methods described herein). These modules (e.g., sets of instructions) need not be implemented as separate software programs (such as computer programs (e.g., including instructions)), procedures, or modules, and thus various subsets of these modules are, optionally, combined or otherwise rearranged in various embodiments. For example, video player module is, optionally, combined with music player module into a single module (e.g., video and music player module 152, FIG. 1A). In some embodiments, memory 102 optionally stores a subset of the modules and data structures identified above. Furthermore, memory 102 optionally stores additional modules and data structures not described above.

In some embodiments, device 100 is a device where operation of a predefined set of functions on the device is performed exclusively through a touch screen and/or a touchpad. By using a touch screen and/or a touchpad as the primary input control device for operation of device 100, the number of physical input control devices (such as push buttons, dials, and the like) on device 100 is, optionally, reduced.

The predefined set of functions that are performed exclusively through a touch screen and/or a touchpad optionally include navigation between user interfaces. In some embodiments, the touchpad, when touched by the user, navigates device 100 to a main, home, or root menu from any user interface that is displayed on device 100. In such embodiments, a “menu button” is implemented using a touchpad. In some other embodiments, the menu button is a physical push button or other physical input control device instead of a touchpad.

FIG. 1B is a block diagram illustrating exemplary components for event handling in accordance with some embodiments. In some embodiments, memory 102 (FIG. 1A) or 370 (FIG. 3) includes event sorter 170 (e.g., in operating system 126) and a respective application 136-1 (e.g., any of the aforementioned applications 137-151, 155, 380-390).

Event sorter 170 receives event information and determines the application 136-1 and application view 191 of application 136-1 to which to deliver the event information. Event sorter 170 includes event monitor 171 and event dispatcher module 174. In some embodiments, application 136-1 includes application internal state 192, which indicates the current application view(s) displayed on touch-sensitive display 112 when the application is active or executing. In some embodiments, device/global internal state 157 is used by event sorter 170 to determine which application(s) is (are) currently active, and application internal state 192 is used by event sorter 170 to determine application views 191 to which to deliver event information.

In some embodiments, application internal state 192 includes additional information, such as one or more of: resume information to be used when application 136-1 resumes execution, user interface state information that indicates information being displayed or that is ready for display by application 136-1, a state queue for enabling the user to go back to a prior state or view of application 136-1, and a redo/undo queue of previous actions taken by the user.

Event monitor 171 receives event information from peripherals interface 118. Event information includes information about a sub-event (e.g., a user touch on touch-sensitive display 112, as part of a multi-touch gesture). Peripherals interface 118 transmits information it receives from I/O subsystem 106 or a sensor, such as proximity sensor 166, accelerometer(s) 168, and/or microphone 113 (through audio circuitry 110). Information that peripherals interface 118 receives from I/O subsystem 106 includes information from touch-sensitive display 112 or a touch-sensitive surface.

In some embodiments, event monitor 171 sends requests to the peripherals interface 118 at predetermined intervals. In response, peripherals interface 118 transmits event information. In other embodiments, peripherals interface 118 transmits event information only when there is a significant event (e.g., receiving an input above a predetermined noise threshold and/or for more than a predetermined duration).

In some embodiments, event sorter 170 also includes a hit view determination module 172 and/or an active event recognizer determination module 173.

Hit view determination module 172 provides software procedures for determining where a sub-event has taken place within one or more views when touch-sensitive display 112 displays more than one view. Views are made up of controls and other elements that a user can see on the display.

Another aspect of the user interface associated with an application is a set of views, sometimes herein called application views or user interface windows, in which information is displayed and touch-based gestures occur. The application views (of a respective application) in which a touch is detected optionally correspond to programmatic levels within a programmatic or view hierarchy of the application. For example, the lowest level view in which a touch is detected is, optionally, called the hit view, and the set of events that are recognized as proper inputs are, optionally, determined based, at least in part, on the hit view of the initial touch that begins a touch-based gesture.

Hit view determination module 172 receives information related to sub-events of a touch-based gesture. When an application has multiple views organized in a hierarchy, hit view determination module 172 identifies a hit view as the lowest view in the hierarchy which should handle the sub-event. In most circumstances, the hit view is the lowest level view in which an initiating sub-event occurs (e.g., the first sub-event in the sequence of sub-events that form an event or potential event). Once the hit view is identified by the hit view determination module 172, the hit view typically receives all sub-events related to the same touch or input source for which it was identified as the hit view.

Active event recognizer determination module 173 determines which view or views within a view hierarchy should receive a particular sequence of sub-events. In some embodiments, active event recognizer determination module 173 determines that only the hit view should receive a particular sequence of sub-events. In other embodiments, active event recognizer determination module 173 determines that all views that include the physical location of a sub-event are actively involved views, and therefore determines that all actively involved views should receive a particular sequence of sub-events. In other embodiments, even if touch sub-events were entirely confined to the area associated with one particular view, views higher in the hierarchy would still remain as actively involved views.

Event dispatcher module 174 dispatches the event information to an event recognizer (e.g., event recognizer 180). In embodiments including active event recognizer determination module 173, event dispatcher module 174 delivers the event information to an event recognizer determined by active event recognizer determination module 173. In some embodiments, event dispatcher module 174 stores in an event queue the event information, which is retrieved by a respective event receiver 182.

In some embodiments, operating system 126 includes event sorter 170. Alternatively, application 136-1 includes event sorter 170. In yet other embodiments, event sorter 170 is a stand-alone module, or a part of another module stored in memory 102, such as contact/motion module 130.

In some embodiments, application 136-1 includes a plurality of event handlers 190 and one or more application views 191, each of which includes instructions for handling touch events that occur within a respective view of the application's user interface. Each application view 191 of the application 136-1 includes one or more event recognizers 180. Typically, a respective application view 191 includes a plurality of event recognizers 180. In other embodiments, one or more of event recognizers 180 are part of a separate module, such as a user interface kit or a higher level object from which application 136-1 inherits methods and other properties. In some embodiments, a respective event handler 190 includes one or more of: data updater 176, object updater 177, GUI updater 178, and/or event data 179 received from event sorter 170. Event handler 190 optionally utilizes or calls data updater 176, object updater 177, or GUI updater 178 to update the application internal state 192. Alternatively, one or more of the application views 191 include one or more respective event handlers 190. Also, in some embodiments, one or more of data updater 176, object updater 177, and GUI updater 178 are included in a respective application view 191.

A respective event recognizer 180 receives event information (e.g., event data 179) from event sorter 170 and identifies an event from the event information. Event recognizer 180 includes event receiver 182 and event comparator 184. In some embodiments, event recognizer 180 also includes at least a subset of: metadata 183, and event delivery instructions 188 (which optionally include sub-event delivery instructions).

Event receiver 182 receives event information from event sorter 170. The event information includes information about a sub-event, for example, a touch or a touch movement. Depending on the sub-event, the event information also includes additional information, such as location of the sub-event. When the sub-event concerns motion of a touch, the event information optionally also includes speed and direction of the sub-event. In some embodiments, events include rotation of the device from one orientation to another (e.g., from a portrait orientation to a landscape orientation, or vice versa), and the event information includes corresponding information about the current orientation (also called device attitude) of the device.

Event comparator 184 compares the event information to predefined event or sub-event definitions and, based on the comparison, determines an event or sub-event, or determines or updates the state of an event or sub-event. In some embodiments, event comparator 184 includes event definitions 186. Event definitions 186 contain definitions of events (e.g., predefined sequences of sub-events), for example, event 1 (187-1), event 2 (187-2), and others. In some embodiments, sub-events in an event (e.g., 187-1 and/or 187-2) include, for example, touch begin, touch end, touch movement, touch cancellation, and multiple touching. In one example, the definition for event 1 (187-1) is a double tap on a displayed object. The double tap, for example, comprises a first touch (touch begin) on the displayed object for a predetermined phase, a first liftoff (touch end) for a predetermined phase, a second touch (touch begin) on the displayed object for a predetermined phase, and a second liftoff (touch end) for a predetermined phase. In another example, the definition for event 2 (187-2) is a dragging on a displayed object. The dragging, for example, comprises a touch (or contact) on the displayed object for a predetermined phase, a movement of the touch across touch-sensitive display 112, and liftoff of the touch (touch end). In some embodiments, the event also includes information for one or more associated event handlers 190.

In some embodiments, event definitions 186 include a definition of an event for a respective user-interface object. In some embodiments, event comparator 184 performs a hit test to determine which user-interface object is associated with a sub-event. For example, in an application view in which three user-interface objects are displayed on touch-sensitive display 112, when a touch is detected on touch-sensitive display 112, event comparator 184 performs a hit test to determine which of the three user-interface objects is associated with the touch (sub-event). If each displayed object is associated with a respective event handler 190, the event comparator uses the result of the hit test to determine which event handler 190 should be activated. For example, event comparator 184 selects an event handler associated with the sub-event and the object triggering the hit test.

In some embodiments, the definition for a respective event (187) also includes delayed actions that delay delivery of the event information until after it has been determined whether the sequence of sub-events does or does not correspond to the event recognizer's event type.

When a respective event recognizer 180 determines that the series of sub-events do not match any of the events in event definitions 186, the respective event recognizer 180 enters an event impossible, event failed, or event ended state, after which it disregards subsequent sub-events of the touch-based gesture. In this situation, other event recognizers, if any, that remain active for the hit view continue to track and process sub-events of an ongoing touch-based gesture.

In some embodiments, a respective event recognizer 180 includes metadata 183 with configurable properties, flags, and/or lists that indicate how the event delivery system should perform sub-event delivery to actively involved event recognizers. In some embodiments, metadata 183 includes configurable properties, flags, and/or lists that indicate how event recognizers interact, or are enabled to interact, with one another. In some embodiments, metadata 183 includes configurable properties, flags, and/or lists that indicate whether sub-events are delivered to varying levels in the view or programmatic hierarchy.

In some embodiments, a respective event recognizer 180 activates event handler 190 associated with an event when one or more particular sub-events of an event are recognized. In some embodiments, a respective event recognizer 180 delivers event information associated with the event to event handler 190. Activating an event handler 190 is distinct from sending (and deferred sending) sub-events to a respective hit view. In some embodiments, event recognizer 180 throws a flag associated with the recognized event, and event handler 190 associated with the flag catches the flag and performs a predefined process.

In some embodiments, event delivery instructions 188 include sub-event delivery instructions that deliver event information about a sub-event without activating an event handler. Instead, the sub-event delivery instructions deliver event information to event handlers associated with the series of sub-events or to actively involved views. Event handlers associated with the series of sub-events or with actively involved views receive the event information and perform a predetermined process.

In some embodiments, data updater 176 creates and updates data used in application 136-1. For example, data updater 176 updates the telephone number used in contacts module 137, or stores a video file used in video player module. In some embodiments, object updater 177 creates and updates objects used in application 136-1. For example, object updater 177 creates a new user-interface object or updates the position of a user-interface object. GUI updater 178 updates the GUI. For example, GUI updater 178 prepares display information and sends it to graphics module 132 for display on a touch-sensitive display.

In some embodiments, event handler(s) 190 includes or has access to data updater 176, object updater 177, and GUI updater 178. In some embodiments, data updater 176, object updater 177, and GUI updater 178 are included in a single module of a respective application 136-1 or application view 191. In other embodiments, they are included in two or more software modules.

It shall be understood that the foregoing discussion regarding event handling of user touches on touch-sensitive displays also applies to other forms of user inputs to operate multifunction devices 100 with input devices, not all of which are initiated on touch screens. For example, mouse movement and mouse button presses, optionally coordinated with single or multiple keyboard presses or holds; contact movements such as taps, drags, scrolls, etc. on touchpads; pen stylus inputs; movement of the device; oral instructions; detected eye movements; biometric inputs; and/or any combination thereof are optionally utilized as inputs corresponding to sub-events which define an event to be recognized.

FIG. 2 illustrates a portable multifunction device 100 having a touch screen 112 in accordance with some embodiments. The touch screen optionally displays one or more graphics within user interface (UI) 200. In this embodiment, as well as others described below, a user is enabled to select one or more of the graphics by making a gesture on the graphics, for example, with one or more fingers 202 (not drawn to scale in the figure) or one or more styluses 203 (not drawn to scale in the figure). In some embodiments, selection of one or more graphics occurs when the user breaks contact with the one or more graphics. In some embodiments, the gesture optionally includes one or more taps, one or more swipes (from left to right, right to left, upward and/or downward), and/or a rolling of a finger (from right to left, left to right, upward and/or downward) that has made contact with device 100. In some implementations or circumstances, inadvertent contact with a graphic does not select the graphic. For example, a swipe gesture that sweeps over an application icon optionally does not select the corresponding application when the gesture corresponding to selection is a tap.

Device 100 optionally also include one or more physical buttons, such as “home” or menu button 204. As described previously, menu button 204 is, optionally, used to navigate to any application 136 in a set of applications that are, optionally, executed on device 100. Alternatively, in some embodiments, the menu button is implemented as a soft key in a GUI displayed on touch screen 112.

In some embodiments, device 100 includes touch screen 112, menu button 204, push button 206 for powering the device on/off and locking the device, volume adjustment button(s) 208, subscriber identity module (SIM) card slot 210, headset jack 212, and docking/charging external port 124. Push button 206 is, optionally, used to turn the power on/off on the device by depressing the button and holding the button in the depressed state for a predefined time interval; to lock the device by depressing the button and releasing the button before the predefined time interval has elapsed; and/or to unlock the device or initiate an unlock process. In an alternative embodiment, device 100 also accepts verbal input for activation or deactivation of some functions through microphone 113. Device 100 also, optionally, includes one or more contact intensity sensors 165 for detecting intensity of contacts on touch screen 112 and/or one or more tactile output generators 167 for generating tactile outputs for a user of device 100.

FIG. 3 is a block diagram of an exemplary multifunction device with a display and a touch-sensitive surface in accordance with some embodiments. Device 300 need not be portable. In some embodiments, device 300 is a laptop computer, a desktop computer, a tablet computer, a multimedia player device, a navigation device, an educational device (such as a child's learning toy), a gaming system, or a control device (e.g., a home or industrial controller). Device 300 typically includes one or more processing units (CPUs) 310, one or more network or other communications interfaces 360, memory 370, and one or more communication buses 320 for interconnecting these components. Communication buses 320 optionally include circuitry (sometimes called a chipset) that interconnects and controls communications between system components. Device 300 includes input/output (I/O) interface 330 comprising display 340, which is typically a touch screen display. I/O interface 330 also optionally includes a keyboard and/or mouse (or other pointing device) 350 and touchpad 355, tactile output generator 357 for generating tactile outputs on device 300 (e.g., similar to tactile output generator(s) 167 described above with reference to FIG. 1A), sensors 359 (e.g., optical, acceleration, proximity, touch-sensitive, and/or contact intensity sensors similar to contact intensity sensor(s) 165 described above with reference to FIG. 1A). Memory 370 includes high-speed random access memory, such as DRAM, SRAM, DDR RAM, or other random access solid state memory devices; and optionally includes non-volatile memory, such as one or more magnetic disk storage devices, optical disk storage devices, flash memory devices, or other non-volatile solid state storage devices. Memory 370 optionally includes one or more storage devices remotely located from CPU(s) 310. In some embodiments, memory 370 stores programs, modules, and data structures analogous to the programs, modules, and data structures stored in memory 102 of portable multifunction device 100 (FIG. 1A), or a subset thereof. Furthermore, memory 370 optionally stores additional programs, modules, and data structures not present in memory 102 of portable multifunction device 100. For example, memory 370 of device 300 optionally stores drawing module 380, presentation module 382, word processing module 384, website creation module 386, disk authoring module 388, and/or spreadsheet module 390, while memory 102 of portable multifunction device 100 (FIG. 1A) optionally does not store these modules.

Each of the above-identified elements in FIG. 3 is, optionally, stored in one or more of the previously mentioned memory devices. Each of the above-identified modules corresponds to a set of instructions for performing a function described above. The above-identified modules or computer programs (e.g., sets of instructions or including instructions) need not be implemented as separate software programs (such as computer programs (e.g., including instructions)), procedures, or modules, and thus various subsets of these modules are, optionally, combined or otherwise rearranged in various embodiments. In some embodiments, memory 370 optionally stores a subset of the modules and data structures identified above. Furthermore, memory 370 optionally stores additional modules and data structures not described above.

Attention is now directed towards embodiments of user interfaces that are, optionally, implemented on, for example, portable multifunction device 100.

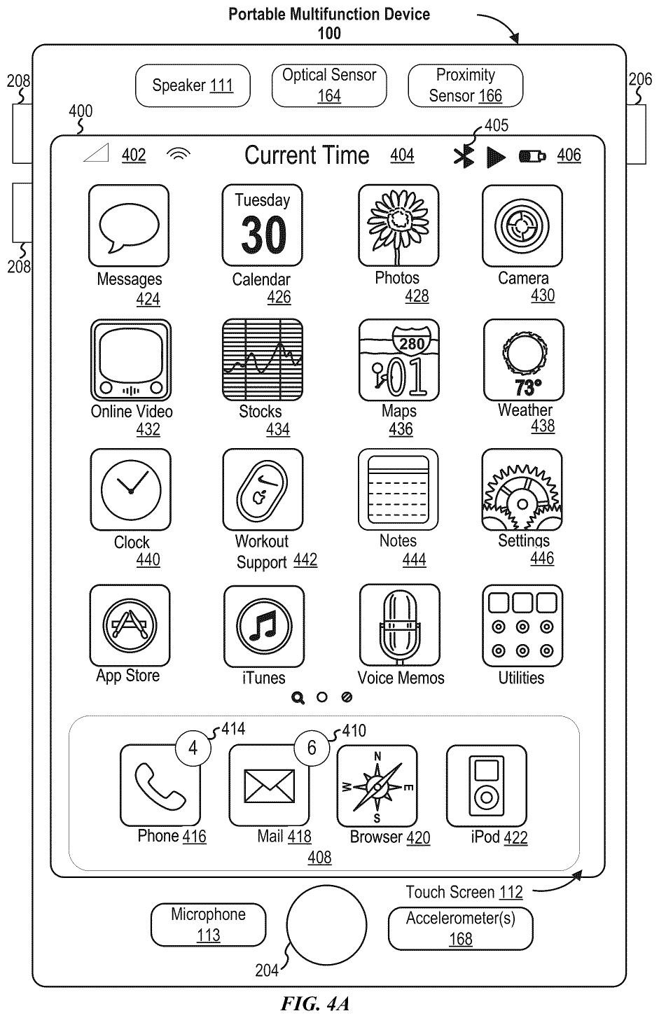

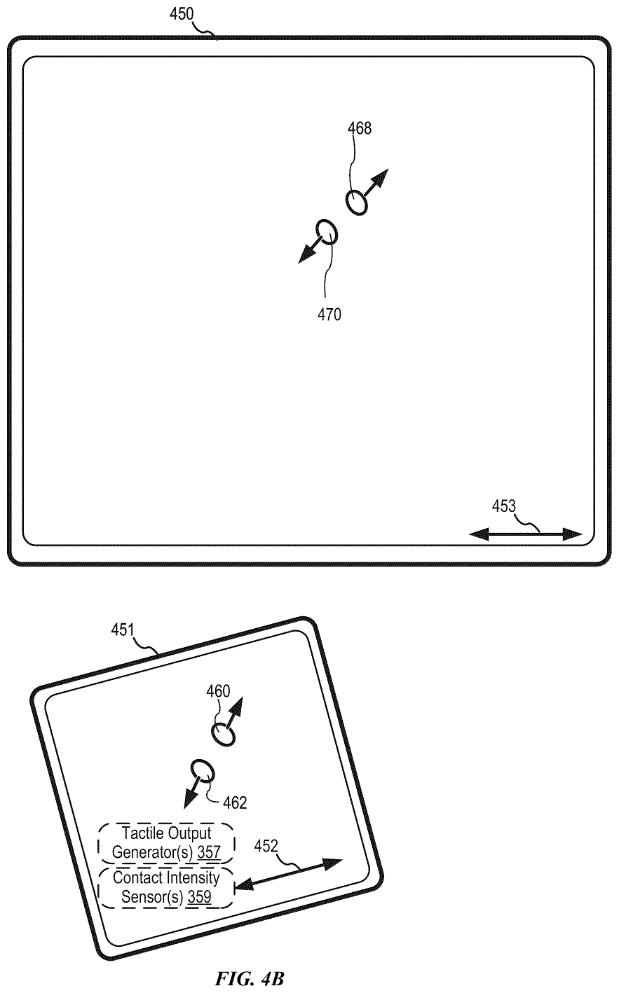

FIG. 4A illustrates an exemplary user interface for a menu of applications on portable multifunction device 100 in accordance with some embodiments. Similar user interfaces are, optionally, implemented on device 300. In some embodiments, user interface 400 includes the following elements, or a subset or superset thereof:
Signal strength indicator(s) 402 for wireless communication(s), such as cellular and Wi-Fi signals;
Time 404;
Bluetooth indicator 405;
Battery status indicator 406;
Tray 408 with icons for frequently used applications, such as:
   Icon 416 for telephone module 138, labeled “Phone,” which optionally includes an indicator 414 of the number of missed calls or voicemail messages;
   Icon 418 for e-mail client module 140, labeled “Mail,” which optionally includes an indicator 410 of the number of unread e-mails;
   Icon 420 for browser module 147, labeled “Browser;” and
   Icon 422 for video and music player module 152, also referred to as iPod (trademark of Apple Inc.) module 152, labeled “iPod;” and
Icons for other applications, such as:
   Icon 424 for IM module 141, labeled “Messages;”
   Icon 426 for calendar module 148, labeled “Calendar;”
   Icon 428 for image management module 144, labeled “Photos;”
   Icon 430 for camera module 143, labeled “Camera;”
   Icon 432 for online video module 155, labeled “Online Video;”
   Icon 434 for stocks widget 149-2, labeled “Stocks;”
   Icon 436 for map module 154, labeled “Maps;”
   Icon 438 for weather widget 149-1, labeled “Weather;”
   Icon 440 for alarm clock widget 149-4, labeled “Clock;”
   Icon 442 for workout support module 142, labeled “Workout Support;”
   Icon 444 for notes module 153, labeled “Notes;” and
   Icon 446 for a settings application or module, labeled “Settings,” which provides access to settings for device 100 and its various applications 136.

It should be noted that the icon labels illustrated in FIG. 4A are merely exemplary. For example, icon 422 for video and music player module 152 is labeled “Music” or “Music Player.” Other labels are, optionally, used for various application icons. In some embodiments, a label for a respective application icon includes a name of an application corresponding to the respective application icon. In some embodiments, a label for a particular application icon is distinct from a name of an application corresponding to the particular application icon.

FIG. 4B illustrates an exemplary user interface on a device (e.g., device 300, FIG. 3) with a touch-sensitive surface 451 (e.g., a tablet or touchpad 355, FIG. 3) that is separate from the display 450 (e.g., touch screen display 112). Device 300 also, optionally, includes one or more contact intensity sensors (e.g., one or more of sensors 359) for detecting intensity of contacts on touch-sensitive surface 451 and/or one or more tactile output generators 357 for generating tactile outputs for a user of device 300.

Although some of the examples that follow will be given with reference to inputs on touch screen display 112 (where the touch-sensitive surface and the display are combined), in some embodiments, the device detects inputs on a touch-sensitive surface that is separate from the display, as shown in FIG. 4B. In some embodiments, the touch-sensitive surface (e.g., 451 in FIG. 4B) has a primary axis (e.g., 452 in FIG. 4B) that corresponds to a primary axis (e.g., 453 in FIG. 4B) on the display (e.g., 450). In accordance with these embodiments, the device detects contacts (e.g., 460 and 462 in FIG. 4B) with the touch-sensitive surface 451 at locations that correspond to respective locations on the display (e.g., in FIG. 4B, 460 corresponds to 468 and 462 corresponds to 470). In this way, user inputs (e.g., contacts 460 and 462, and movements thereof) detected by the device on the touch-sensitive surface (e.g., 451 in FIG. 4B) are used by the device to manipulate the user interface on the display (e.g., 450 in FIG. 4B) of the multifunction device when the touch-sensitive surface is separate from the display. It should be understood that similar methods are, optionally, used for other user interfaces described herein.

Additionally, while the following examples are given primarily with reference to finger inputs (e.g., finger contacts, finger tap gestures, finger swipe gestures), it should be understood that, in some embodiments, one or more of the finger inputs are replaced with input from another input device (e.g., a mouse-based input or stylus input). For example, a swipe gesture is, optionally, replaced with a mouse click (e.g., instead of a contact) followed by movement of the cursor along the path of the swipe (e.g., instead of movement of the contact). As another example, a tap gesture is, optionally, replaced with a mouse click while the cursor is located over the location of the tap gesture (e.g., instead of detection of the contact followed by ceasing to detect the contact). Similarly, when multiple user inputs are simultaneously detected, it should be understood that multiple computer mice are, optionally, used simultaneously, or a mouse and finger contacts are, optionally, used simultaneously.

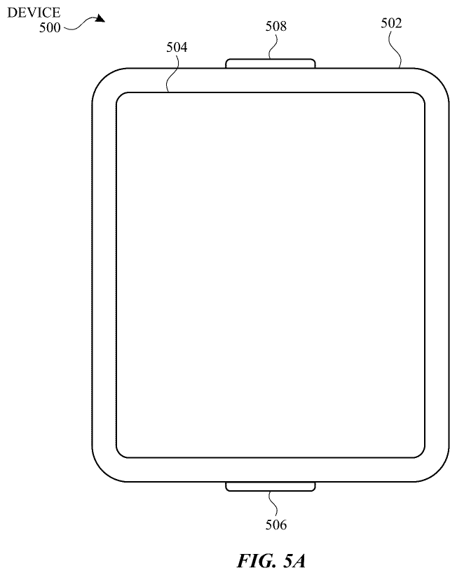

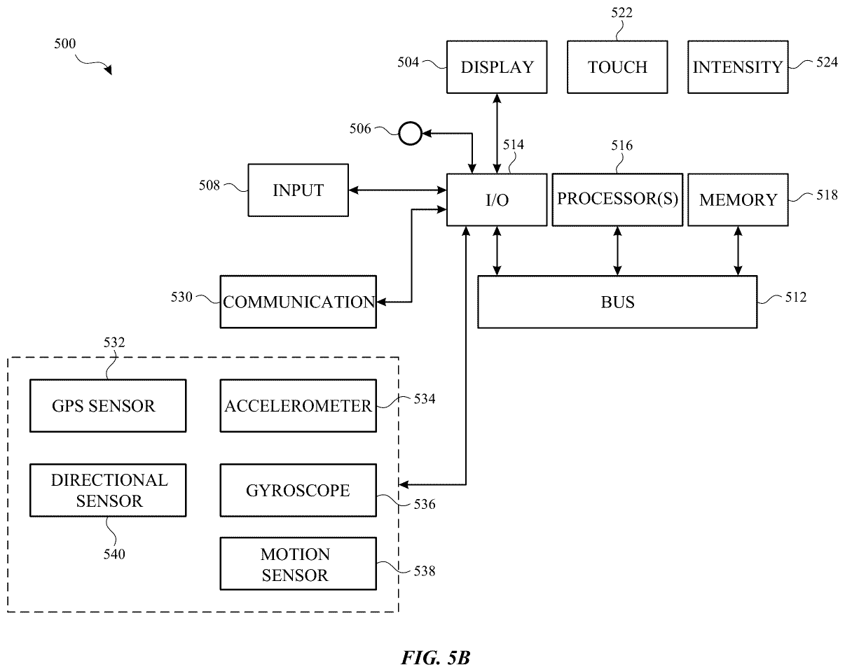

FIG. 5A illustrates exemplary personal electronic device 500. Device 500 includes body 502. In some embodiments, device 500 can include some or all of the features described with respect to devices 100 and 300 (e.g., FIGS. 1A-4B). In some embodiments, device 500 has touch-sensitive display screen 504, hereafter touch screen 504. Alternatively, or in addition to touch screen 504, device 500 has a display and a touch-sensitive surface. As with devices 100 and 300, in some embodiments, touch screen 504 (or the touch-sensitive surface) optionally includes one or more intensity sensors for detecting intensity of contacts (e.g., touches) being applied. The one or more intensity sensors of touch screen 504 (or the touch-sensitive surface) can provide output data that represents the intensity of touches. The user interface of device 500 can respond to touches based on their intensity, meaning that touches of different intensities can invoke different user interface operations on device 500.

Exemplary techniques for detecting and processing touch intensity are found, for example, in related applications: International Patent Application Serial No. PCT/US2013/040061, titled “Device, Method, and Graphical User Interface for Displaying User Interface Objects Corresponding to an Application,” filed May 8, 2013, published as WIPO Publication No. WO/2013/169849, and International Patent Application Serial No. PCT/US2013/069483, titled “Device, Method, and Graphical User Interface for Transitioning Between Touch Input to Display Output Relationships,” filed Nov. 11, 2013, published as WIPO Publication No. WO/2014/105276, each of which is hereby incorporated by reference in their entirety.

In some embodiments, device 500 has one or more input mechanisms 506 and 508. Input mechanisms 506 and 508, if included, can be physical. Examples of physical input mechanisms include push buttons and rotatable mechanisms. In some embodiments, device 500 has one or more attachment mechanisms. Such attachment mechanisms, if included, can permit attachment of device 500 with, for example, hats, eyewear, earrings, necklaces, shirts, jackets, bracelets, watch straps, chains, trousers, belts, shoes, purses, backpacks, and so forth. These attachment mechanisms permit device 500 to be worn by a user.

FIG. 5B depicts exemplary personal electronic device 500. In some embodiments, device 500 can include some or all of the components described with respect to FIGS. 1A, 1B, and 3. Device 500 has bus 512 that operatively couples I/O section 514 with one or more computer processors 516 and memory 518. I/O section 514 can be connected to display 504, which can have touch-sensitive component 522 and, optionally, intensity sensor 524 (e.g., contact intensity sensor). In addition, I/O section 514 can be connected with communication unit 530 for receiving application and operating system data, using Wi-Fi, Bluetooth, near field communication (NFC), cellular, and/or other wireless communication techniques. Device 500 can include input mechanisms 506 and/or 508. Input mechanism 506 is, optionally, a rotatable input device or a depressible and rotatable input device, for example. Input mechanism 508 is, optionally, a button, in some examples.

Input mechanism 508 is, optionally, a microphone, in some examples. Personal electronic device 500 optionally includes various sensors, such as GPS sensor 532, accelerometer 534, directional sensor 540 (e.g., compass), gyroscope 536, motion sensor 538, and/or a combination thereof, all of which can be operatively connected to I/O section 514.

Memory 518 of personal electronic device 500 can include one or more non-transitory computer-readable storage mediums, for storing computer-executable instructions, which, when executed by one or more computer processors 516, for example, can cause the computer processors to perform the techniques described below, including processes 700, 900, and/or 1100 (FIGS. 7, 9, and/or 11). A computer-readable storage medium can be any medium that can tangibly contain or store computer-executable instructions for use by or in connection with the instruction execution system, apparatus, or device. In some examples, the storage medium is a transitory computer-readable storage medium. In some examples, the storage medium is a non-transitory computer-readable storage medium. The non-transitory computer-readable storage medium can include, but is not limited to, magnetic, optical, and/or semiconductor storages. Examples of such storage include magnetic disks, optical discs based on CD, DVD, or Blu-ray technologies, as well as persistent solid-state memory such as flash, solid-state drives, and the like. Personal electronic device 500 is not limited to the components and configuration of FIG. 5B, but can include other or additional components in multiple configurations.

As used here, the term “affordance” refers to a user-interactive graphical user interface object that is, optionally, displayed on the display screen of devices 100, 300, and/or 500 (FIGS. 1A, 3, and 5A-5B). For example, an image (e.g., icon), a button, and text (e.g., hyperlink) each optionally constitute an affordance.

As used herein, the term “focus selector” refers to an input element that indicates a current part of a user interface with which a user is interacting. In some implementations that include a cursor or other location marker, the cursor acts as a “focus selector” so that when an input (e.g., a press input) is detected on a touch-sensitive surface (e.g., touchpad 355 in FIG. 3 or touch-sensitive surface 451 in FIG. 4B) while the cursor is over a particular user interface element (e.g., a button, window, slider, or other user interface element), the particular user interface element is adjusted in accordance with the detected input. In some implementations that include a touch screen display (e.g., touch-sensitive display system 112 in FIG. 1A or touch screen 112 in FIG. 4A) that enables direct interaction with user interface elements on the touch screen display, a detected contact on the touch screen acts as a “focus selector” so that when an input (e.g., a press input by the contact) is detected on the touch screen display at a location of a particular user interface element (e.g., a button, window, slider, or other user interface element), the particular user interface element is adjusted in accordance with the detected input. In some implementations, focus is moved from one region of a user interface to another region of the user interface without corresponding movement of a cursor or movement of a contact on a touch screen display (e.g., by using a tab key or arrow keys to move focus from one button to another button); in these implementations, the focus selector moves in accordance with movement of focus between different regions of the user interface. Without regard to the specific form taken by the focus selector, the focus selector is generally the user interface element (or contact on a touch screen display) that is controlled by the user so as to communicate the user's intended interaction with the user interface (e.g., by indicating, to the device, the element of the user interface with which the user is intending to interact). For example, the location of a focus selector (e.g., a cursor, a contact, or a selection box) over a respective button while a press input is detected on the touch-sensitive surface (e.g., a touchpad or touch screen) will indicate that the user is intending to activate the respective button (as opposed to other user interface elements shown on a display of the device).

As used in the specification and claims, the term “characteristic intensity” of a contact refers to a characteristic of the contact based on one or more intensities of the contact. In some embodiments, the characteristic intensity is based on multiple intensity samples. The characteristic intensity is, optionally, based on a predefined number of intensity samples, or a set of intensity samples collected during a predetermined time period (e.g., 0.05, 0.1, 0.2, 0.5, 1, 2, 5, 10 seconds) relative to a predefined event (e.g., after detecting the contact, prior to detecting liftoff of the contact, before or after detecting a start of movement of the contact, prior to detecting an end of the contact, before or after detecting an increase in intensity of the contact, and/or before or after detecting a decrease in intensity of the contact). A characteristic intensity of a contact is, optionally, based on one or more of: a maximum value of the intensities of the contact, a mean value of the intensities of the contact, an average value of the intensities of the contact, a top 10 percentile value of the intensities of the contact, a value at the half maximum of the intensities of the contact, a value at the 90 percent maximum of the intensities of the contact, or the like. In some embodiments, the duration of the contact is used in determining the characteristic intensity (e.g., when the characteristic intensity is an average of the intensity of the contact over time). In some embodiments, the characteristic intensity is compared to a set of one or more intensity thresholds to determine whether an operation has been performed by a user. For example, the set of one or more intensity thresholds optionally includes a first intensity threshold and a second intensity threshold. In this example, a contact with a characteristic intensity that does not exceed the first threshold results in a first operation, a contact with a characteristic intensity that exceeds the first intensity threshold and does not exceed the second intensity threshold results in a second operation, and a contact with a characteristic intensity that exceeds the second threshold results in a third operation. In some embodiments, a comparison between the characteristic intensity and one or more thresholds is used to determine whether or not to perform one or more operations (e.g., whether to perform a respective operation or forgo performing the respective operation), rather than being used to determine whether to perform a first operation or a second operation.

As used herein, an “installed application” refers to a software application that has been downloaded onto an electronic device (e.g., devices 100, 300, and/or 500) and is ready to be launched (e.g., become opened) on the device. In some embodiments, a downloaded application becomes an installed application by way of an installation program that extracts program portions from a downloaded package and integrates the extracted portions with the operating system of the computer system.

As used herein, the terms “open application” or “executing application” refer to a software application with retained state information (e.g., as part of device/global internal state 157 and/or application internal state 192). An open or executing application is, optionally, any one of the following types of applications:
an active application, which is currently displayed on a display screen of the device that the application is being used on;
a background application (or background processes), which is not currently displayed, but one or more processes for the application are being processed by one or more processors; and
a suspended or hibernated application, which is not running, but has state information that is stored in memory (volatile and non-volatile, respectively) and that can be used to resume execution of the application.

As used herein, the term “closed application” refers to software applications without retained state information (e.g., state information for closed applications is not stored in a memory of the device). Accordingly, closing an application includes stopping and/or removing application processes for the application and removing state information for the application from the memory of the device. Generally, opening a second application while in a first application does not close the first application. When the second application is displayed and the first application ceases to be displayed, the first application becomes a background application.

In some embodiments, the computer system is in a locked state or an unlocked state. In the locked state, the computer system is powered on and operational but is prevented from performing a predefined set of operations in response to user input. The predefined set of operations optionally includes navigation between user interfaces, activation or deactivation of a predefined set of functions, and activation or deactivation of certain applications. The locked state can be used to prevent unintentional or unauthorized use of some functionality of the computer system or activation or deactivation of some functions on the computer system. In some embodiments, in the unlocked state, the computer system is powered on and operational and is not prevented from performing at least a portion of the predefined set of operations that cannot be performed while in the locked state. When the computer system is in the locked state, the computer system is said to be locked. When the computer system is in the unlocked state, the computer is said to be unlocked. In some embodiments, the computer system in the locked state optionally responds to a limited set of user inputs, including input that corresponds to an attempt to transition the computer system to the unlocked state or input that corresponds to powering the computer system off.

Attention is now directed towards embodiments of user interfaces (“UI”) and associated processes that are implemented on an electronic device, such as portable multifunction device 100, device 300, or device 500.

FIGS. 6A-6O illustrate exemplary user interfaces for displaying remote content, in accordance with some embodiments. The user interfaces in these figures are used to illustrate the processes described below, including the processes in FIG. 7.

The present disclosure describes embodiments in which respective content can be concurrently output at devices participating in a shared-content session (e.g., a screen sharing session). In some embodiments, the respective content is screen-share content. For example, the content of a host device's displayed screen(s) is shared with one or more participants of the screen sharing session such that the participant(s) can view, at their respective device or devices, the screen content of the host device (the sharing device, or, the device whose screen content is being shared), including any changes to the displayed screen content, in real time. In some embodiments, the screen-share content is referred to as remote content because the content originates from a computer (e.g., the host computer) that is remote from the computer that is displaying the screen-share content. In some embodiments, screen-share content is used to refer to content that is available at a host computer, but is not necessarily displayed at a display device of the host computer. For example, the host computer can provide content for the screen sharing session even if the content is not being displayed at the host computer (e.g., the host computer does not have a display device (for example the host computer is a server) or the display device is inactive). In some embodiments, the screen-share content is synchronized in its output (e.g., via an application local to the devices of the participants) at the devices of the participants of the screen sharing session. In some embodiments, each device of the participants outputs the content at a size and quality that is appropriate for the respective device and connectivity (e.g., data connection conditions such as data transmission and/or processing speeds) of the device, thereby providing a more customized, yet synchronized, playback or viewing experience at each of the participants' devices. In some embodiments, an application (or “app”) is available (e.g., downloaded and/or installed) at a respective device to enable the device to participate in screen sharing sessions. In some embodiments, devices participating in a shared-content session (e.g., a screen sharing session) can communicate with each other to provide data that is relevant for the shared-content session. For example, a host device may transmit information to a participant device to indicate one or more inputs received at the host device. Similarly, a participant device may transmit information to the host device to indicate one or more inputs received at the participant device.

In some embodiments, the screen-share content is displayed in a window that is optionally overlaid on another user interface (e.g., a home screen and/or an application user interface) and can be moved and/or resized separately from the user interface over which it is displayed. In some embodiments, a window can be moved, resized, minimized, docked, undocked, and/or expanded in response to various inputs and/or gestures.

Unless specified otherwise, as discussed herein, the term “share,” “sharing,” or “shared” is used generally to refer to a situation in which content (e.g., screen-share content) is, or is capable of, being output (e.g., viewed and/or played) concurrently at devices that are participating in a screen sharing session. In some embodiments, screen sharing content is shared with participants of the screen sharing session by transmitting, from a host device to participant devices of the screen sharing session, image data representing content that is available at the host device and, in some embodiments, is displayed on display screens of the host device. In some embodiments, the shared content is content that is available at the host device, but is not displayed at a display screen of the host device. For example, in some embodiments, the host device is a computer processor that does not include any display components. In some embodiments, control rights can be granted to a participant device of the screen-share session, even if the participant device is not providing the screen-share content. For example, a participant device that is displaying the shared content can be given access to control the content at the host device such that the displayed screen-share content is modified in response to inputs provided by the participant device.

In some embodiments, a real-time communication session can be active for a screen sharing session through one or more audio and/or video channels that, when active (e.g., open), enable real-time communication for one or more participants of the screen sharing session. For example, when one or more audio channels are active during the screen sharing session, a real-time communication session is considered to be enabled and participants of the screen sharing session can speak to one another in real time (e.g., via an audio call and/or live audio feed) while the screen sharing session is ongoing and, optionally, while content is being shared via the screen sharing session. As another example, when one or more video channels are active (e.g., via a video conferencing application that is local to respective devices), a real-time communication session is considered to be enabled and participants of the screen sharing session can participate in a live video communication (e.g., video chat, video call, video conference, and/or live video feed) while the screen sharing session is ongoing and, optionally, while content is being shared via the screen sharing session. In some embodiments, a real-time communication session can be audio only (e.g., an audio channel is active without a video channel), video only (e.g., a video channel is active without an audio channel), or both audio and video enabled (e.g., the audio channel and video channel are both active). In some embodiments, the audio or video channel can be active with the respective audio feed or video feed temporarily disabled or muted (e.g., the microphone providing the audio feed is muted and/or the camera providing the video feed is disabled). In some embodiments, a real-time communication session can be active (e.g., real-time communication is enabled) separate from a screen sharing session (e.g., without an active screen sharing session). In some embodiments, a screen sharing session can be active separate from a real-time communication session (e.g., without real-time communication enabled). Various aspects of these embodiments, and further details of a screen sharing session and real-time communication session, are discussed below with reference to the figures.

FIGS. 6A-6O illustrate exemplary systems or devices for participating in screen sharing sessions, in accordance with some embodiments. Specifically, these systems or devices include Jane's system 600 (also referred to as Jane's computer 600 in some embodiments) and John's system (including John's computer 610, John's laptop 650, or in some embodiments, both), which are shown concurrently in some figures to illustrate concurrent states of the respective devices, including the user interfaces and inputs at the respective devices.

In the embodiments provided herein, John's system can be described as performing a set of functions associated with the screen sharing session, and Jane's system can be described as performing a different set of functions associated with the screen sharing session. These descriptions are not intended to limit the functions performed by the respective systems, but rather, are provided to illustrate various aspects and embodiments of a screen sharing session. Thus, unless specified otherwise, the functions that are described as being performed using John's system are similarly capable of being performed using Jane's system. Likewise, the functions that are described as being performed by Jane's system are similarly capable of being performed by John's system, unless specified otherwise.

FIG. 6A depicts Jane's system 600, which is a computer system that, in some embodiments, is comprised of first display screen 600a, second display screen 600b, and hardware 600c. Hardware 600c includes processors, memory, and other components for operating Jane's system 600. In some embodiments, Jane's system 600 includes one or more elements of devices 100, 300, and/or 500. Jane's system 600 displays first desktop 601 on first display screen 600a and second desktop 602 on second display screen 600b. First desktop 601 includes menu bar 603, system window 604, and application window 606. Menu bar 603 includes icons that can be selected to launch applications operating on Jane's system 600. Second desktop 602 includes messaging application window 608. A balloon-themed wallpaper is shown on first desktop 601 and second desktop 602.

In the embodiments described with respect to FIGS. 6A-6O, the content displayed at Jane's system 600 is being shared with John's system so that John's system is displaying screen-share content from Jane's system 600. In some embodiments, the sharing of content is enabled through a sharing application operating at Jane's system 600 and at John's system. As described in greater detail below, the sharing application permits John's system to display the content shared from Jane's system 600 and, in some embodiments, to perform actions at Jane's system 600. In the embodiments described herein, Jane's system is sharing content with John's system. However, it should be appreciated that John's system can be configured to share content with Jane's system in an analogous manner. For the sake of brevity, these details are not repeated.

FIG. 6B depicts John's computer 610, which is a part of John's system. John's computer 610 includes display 610a and other hardware for operating John's computer 610. In some embodiments, John's computer 610 includes one or more elements of devices 100, 300, and/or 500. In some embodiments, John's system includes John's computer 610 without other devices. In some embodiments, John's system includes John's computer 610 and other devices such as John's laptop 650, as described in greater detail below. In some embodiments, John's system can include John's laptop without other devices.

As shown in FIG. 6B, John's computer 610 displays John's desktop 611 and menu bar 613. John's desktop 611 is the desktop for John's computer 610, which is shown with a star-themed wallpaper and includes menu bar 613. Menu bar 613 includes icons that can be selected to launch an application operating at John's computer 610. John's computer 610 also displays sharing application window 615, which is a user interface for the sharing application being used to display the remote content being shared from Jane's system 600. Sharing application window 615 includes menu region 612, which includes information associated with the sharing application and/or shared content and icons for controlling aspects of the shared content, as described in greater detail below.

Content in menu region 612 includes indicator 614, display lock option 616, control access option 618, dynamic resolution option 620, show application icons option 622, show open applications option 624, show desktop option 626, and display menu 628. Indicator 614 indicates that the screen-share content is being shared from Jane (by way of Jane's system 600). Options 616, 622, 624, and 626 are selectable to perform system-level functions at Jane's system 600. For example, display lock option 616 can be selected to cause Jane's system 600 to lock display screens 600a and 600b while the shared screen content remains displayed at John's computer 610. Show application icons option 622 can be selected to cause Jane's system 600 to display an arrangement of application icons corresponding to applications available at Jane's system 600. Show open applications option 624 can be selected to cause Jane's system 600 to display an arrangement of application windows that are open at Jane's system 600. Show desktop option 626 can be selected to cause Jane's system 600 to display a desktop view. Control access option 618 can be selected to request control of the content at Jane's system 600. Dynamic resolution option 620 can be selected to enable or disable a mode for automatically adjusting a resolution of the displayed screen-share content. The mode is currently enabled, as indicated by the border around dynamic resolution option 620 in FIG. 6B. Display menu 628 can be selected to change which of Jane's shared desktops are shown in sharing application window 615. The functions and operations of the various options in menu region 612 are described in greater detail below.

In FIG. 6B, John's computer 610 is displaying content from Jane's display screen 600a. Display menu 628 indicates that “Display 1” is selected for display in sharing application window 615. Accordingly, John's computer 610 is displaying the content from Jane's first desktop, as depicted by representation 601a of first desktop 601, including the balloon wallpaper and representation 603a of menu bar 603, representation 604a of system window 604, and representation 606a of application window 606. John's computer 610 detects input 630, which is a selection (e.g., via a mouse click, trackpad click, a touch input on a touch-sensitive surface, or the like) of display menu 628, and in response, displays expanded display menu 632, as shown in FIG. 6C.

In FIG. 6C, John's computer 610 displays expanded display menu 632 with options for selecting which of Jane's display screens are shown in sharing application window 615. Both displays option 632a can be selected to show the content of both of Jane's first desktop 601 and second desktop 602 in sharing application window 615. Display 1 option 632b can be selected to show the representation of Jane's first desktop 601 in sharing application window 615 (e.g., as shown in FIGS. 6B and 6C). Display 2 option 632c can be selected to show the representation of Jane's second desktop 602 in sharing application window 615 in a manner that is analogous to the display of the representation of Jane's first desktop 610 in FIGS. 6B and 6C. John's computer 610 detects input 634 selecting both displays option 632a, and in response, updates sharing application window 615 to show the content from both Jane's first desktop 601 and second desktop 602, as shown in FIG. 6D.

In FIG. 6D, John's computer 610 updates the shared content displayed in sharing application window 615 to include representation 601a of first desktop 601 and representation 602a of second desktop 602. Representation 602a of second desktop 602 includes representation 608a of messaging application window 608. Display menu 628 is updated to indicate that content from both displays (e.g., the content shared from display screen 600a and display screen 600b) are shown in sharing application window 615.

FIGS. 6D-6H depict example user interfaces for various embodiments in which the sharing application window 615 is enlarged (e.g., to a full-screen mode) while displaying the shared content from both of Jane's display screens. In the embodiment depicted in FIGS. 6D and 6E, John's system includes John's computer 610 without another display device. In FIG. 6D, John's computer 610 detects input 636 selecting expand option 638 and, in response, expands sharing application window to an enlarged (e.g., full-screen) display mode on John's computer 610, as shown in FIG. 6E.

In the embodiments depicted in FIGS. 6F-6H, John's system includes John's computer 610 and John's laptop 650. John's laptop 650 includes display 650a, keyboard 650b, and trackpad 650c. In some embodiments, John's laptop 650 includes one or more elements of devices 100, 300, and/or 500. In FIG. 6F, John's laptop 650 displays second desktop 640 for John's system, and John's computer 610 displays sharing application window 615, including the shared content from Jane's first and second desktops. In FIG. 6F, John's computer 610 detects input 642 selecting expand option 638. Because John's system includes a second display component (e.g., display 650a of John's laptop 650), the shared content in shared application window 615 is displayed in an enlarged (e.g., full-screen) display mode and split across the two display components, as shown in FIG. 6G. In the embodiments provided herein, the second display component is provided by John's laptop 650, however, it should be appreciated that other display components can be used such as, for example, a monitor, tablet, smartphone, or other display devices. In some embodiments, the sizes of the respective devices are not shown to scale for the sake of clarity. For example, in FIG. 6F, John's laptop 650 is shown smaller than John's computer 610 so that the content displayed on John's computer 610 is easier to view in the figures. As another example, in some embodiments John's laptop 650 is smaller than John's computer 610, but is shown in the figures (e.g., FIG. 6G) as having a similar size so that the content displayed on John's laptop 650 is easier to view in the figures.

In FIG. 6G, John's system displays the shared content from Jane's system in the enlarged display mode and split (e.g., separated) across the two display devices in John's system (e.g., John's computer 610 and John's laptop 650). Accordingly, John's computer 610 displays representation 601a of first desktop 601 in expanded (e.g., full-screen) display mode, including the balloon wallpaper, representation 603a of menu bar 603, representation 604a of system window 604, and representation 606a of application window 606. Similarly, John's laptop 650 displays representation 602a of second desktop 602 in expanded (e.g., full-screen) display mode, including the balloon wallpaper and representation 608a of messaging application window 608.

In the embodiment depicted in FIGS. 6F and 6G, the dynamic resolution mode is enabled (as indicated by the display of a border around dynamic resolution option 620 in FIG. 6F). Accordingly, the resolution of the content displayed on John's computer 610 and John's laptop 650 (e.g., representation 601a and representation 602a, respectively) is automatically adjusted to fit the display capabilities of John's computer 610 and John's laptop 650, respectively. For example, the physical size of display 650a of John's laptop 650 is smaller than the physical size of Jane's second display screen 600b. Therefore, when the shared content is displayed in expanded (e.g., full-screen) display mode as shown in FIG. 6G, John's laptop 650 automatically adjusts the displayed resolution of representation 602a of second desktop 602 to fit the size dimensions of display 650a, thereby maintaining the dimensions of the shared content as originally displayed on Jane's second display screen 600b. In the embodiment depicted in FIG. 6G, John's computer 610 has the same size dimensions as Jane's first display screen 600a. Therefore, the automatic adjustments to the displayed resolution of representation 601a of first desktop 601 are not apparent. By splitting the shared content across the two display devices, John's system is able to utilize a greater amount of display space to display the shared content in an expanded view, better presenting the shared content for John's viewing. Because the dynamic resolution mode is enabled, the benefits of the expanded view are maintained, even if the display capabilities of the devices in John's system are not consistent with those of Jane's displays.

FIG. 6H depicts an alternate embodiment to that shown in FIG. 6G, wherein the shared content is expanded while the dynamic resolution mode is disabled. In this embodiment, the displayed resolution of the shared content is not automatically adjusted for the display capabilities of John's computer 610 and John's laptop 650, because the dynamic resolution mode is disabled. Because the physical size of display 650a of John's laptop 650 is smaller than the physical size of Jane's second display screen 600b, the shared content from Jane's second display screen 600a does not fit properly onto display 650a when representation 602a of second desktop 602 is displayed in expanded (e.g., full-screen) display mode, as shown in FIG. 6H. In the embodiment depicted in FIG. 6H, John's computer 610 has the same size dimensions as Jane's first display screen 600a. Therefore, representation 601a of first desktop 601 fits properly onto display 610a, even though the dynamic resolution mode is disabled.

FIGS. 6I-6O depict example user interfaces for various embodiments in which the options in menu region 612 are selected while the content being shared from Jane's system 600 is displayed in the expanded (e.g., full-screen) display mode at John's computer 610 and John's laptop 650. In some embodiments, when the shared application window is in the expanded (e.g., full-screen) display mode, menu region 612 is hidden. In some embodiments, menu region 612 can be displayed (or redisplayed), for example, by positioning a cursor near the top of display 610a or display 650a, or in response to another command or setting. FIG. 6I depicts John's computer 610 displaying menu region 612 and representation 601a of first desktop 601 in the expanded display mode, and depicts John's laptop 650 displaying representation 602a of second desktop 602 in the expanded display mode.

FIG. 6J depicts Jane's system 600 and John's system (e.g., John's computer 610 and John's laptop 650) in response to John's computer 610 detecting selection of show application icons option 622 in FIG. 6I. The show application icons option 622 is an option for invoking a system function at Jane's system 600 that causes Jane's system to display an arrangement (e.g., a grid) of application icons that correspond to applications available at Jane's system 600. The resulting action at Jane's system 600 is displayed at John's system because the content from Jane's system 600 is being shared with John's system. For example, in response to detecting selection of show application icons option 622 at John's computer 610, Jane's system 600 ceases display of system window 604 and application window 606 and displays application icons 644 in a grid view in first desktop 601. Respective application icons 644 can be selected to launch corresponding applications at Jane's system 600, similar to selecting application icons from menu bar 603. Jane's system 600 continues to display second desktop 602 with messaging application window 608. Because the content at Jane's system 600 continues to be shared at John's system, John's computer 610 displays representation 601a of first desktop 601 including representations 644a of application icons 644 in the grid view, and John's laptop 650 continues to display representation 602a of second desktop 602 including representation 608a of messaging application window 608.

FIG. 6K depicts Jane's system 600 and John's system (e.g., John's computer 610 and John's laptop 650) in response to John's computer 610 detecting selection of show open applications option 624 in FIG. 6I. The show open applications option 624 is an option for invoking a system function at Jane's system 600 that causes Jane's system to display an arrangement (e.g., a non-overlapping arrangement) of application windows that are open at Jane's system 600. The resulting action at Jane's system 600 is displayed at John's system because the content from Jane's system 600 is being shared with John's system. For example, in response to detecting selection of show open applications option 624 at John's computer 610, Jane's system 600 displays system window 604 and application window 606 in a non-overlapping arrangement and displays region 646 including tabs 648 that can be selected to access content opened at Jane's system 600. Jane's system 600 also displays messaging application window 608 and message window 652 in a non-overlapping arrangement on second desktop 602. Message window 652 is a window that is open at Jane's system 600, but was previously not displayed (for example, window 652 was hidden behind messaging application window 608). Because the content at Jane's system 600 continues to be shared at John's system, John's computer 610 displays representation 601a of first desktop 601 including the non-overlapping arrangement of representation 604a of system window 604 and representation 606a of application window 606, and representation 646a of region 646 including representations 648a of tabs 648. John's laptop 650 displays the non-overlapping arrangement of representation 608a of messaging application window 608 and representation 652a of message window 652 on representation 602a of second desktop 602.

FIG. 6L depicts Jane's system 600 and John's system (e.g., John's computer 610 and John's laptop 650) in response to John's computer 610 detecting selection of show desktop option 626 in FIG. 6I. The show desktop option 626 is an option for invoking a system function at Jane's system 600 that causes Jane's system to display default or homescreen views of first desktop 601 and second desktop 602 without open application windows. The resulting action at Jane's system 600 is displayed at John's system because the content from Jane's system 600 is being shared with John's system. For example, in response to detecting selection of show desktop option 626 at John's computer 610, Jane's system 600 displays first desktop 601 and second desktop 602 without any open application windows such as system window 604, application window 606, or messaging application window 608. Because the content at Jane's system 600 continues to be shared at John's system, John's computer 610 displays representation 601a of first desktop 601 without representations of the system window and application window, and John's laptop 650 displays representation 602a of second desktop 602 without representation 608a of messaging application window 608.

FIG. 6M depicts Jane's system 600 and John's system (e.g., John's computer 610 and John's laptop 650) in response to John's computer 610 detecting selection of control access option 618 in FIG. 6I, and after permission is granted from Jane's system 600 to allow John's system to control Jane's system 600 (permission can be granted in a manner similar to that described below with respect to FIG. 10E). In this embodiment, John's system is configured to control movement of the cursor at Jane's system 600 and, as a result, to provide inputs using the cursor such as selecting content displayed at Jane's system 600, which is also being shared with John's system. In some embodiments, the cursor is controlled using a mouse or other input device associated with John's computer 610. In some embodiments, the cursor is controlled using trackpad 650c of John's laptop 650. In FIG. 6M, Jane's system 600 displays cursor 654 positioned on second desktop 602. In the embodiment depicted in FIG. 6M, Jane's system 600 also displays indicator 656, which indicates that John's system (e.g., John's computer 610 or John's laptop 650) has control of cursor 654 (additional details of such embodiments are described with respect to FIGS. 10A-10K). Because the content at Jane's system 600 is being shared at John's system, John's laptop 650 shows representation 602a of desktop 602 including representation 654a of cursor 654 positioned on representation 608a of messaging application window 608. In some embodiments, John's computer 650 does not display a representation of indicator 656 because it is apparent to John that he is controlling cursor 654. In the embodiment in FIG. 6M, John's system (either via John's computer 610 or via John's laptop 650) selects message 658 at Jane's system 600. In response, Jane's system 600 displays message window 660, as shown in FIG. 6N. Accordingly, John's laptop 650 also displays representation 660a of message window 660 in representation 602a of second desktop 602.

FIG. 6O depicts Jane's system 600 and John's system (e.g., John's computer 610 and John's laptop 650) in response to John's computer 610 detecting selection of display lock option 616 in FIG. 6I (or in some embodiments, in FIG. 6M). The display lock option 616 is an option for invoking a system function at Jane's system 600 that causes Jane's system to lock display screens 600a and 600b, displaying login screen 665 at Jane's system 600. In this embodiment, Jane is restricted from accessing the content at Jane's system 600, while John maintains access to the content at Jane's system 600, even though the content from Jane's system 600 is not actively displayed at first display screen 600a and second display screen 600b. Accordingly, John's computer 610 continues to display representation 601a of first desktop 601 and John's laptop 650 continues to display representation 602a of second desktop 602. In some embodiments, if John's system is granted control of the content at Jane's system 600 (in a manner similar to that described above with respect to FIGS. 6M and 6N), John's system can continue to control Jane's system 600 while display screens 600a and 600b remain locked. In some embodiments, the display lock feature can be implemented as a security feature to enhance privacy for John's operation of Jane's system 600 when John is a trusted user of Jane's system 600.

FIG. 7 is a flow diagram illustrating a method for displaying remote content using a computer system in accordance with some embodiments. Method 700 is performed at a computer system (e.g., 100, 300, 500, 600, 610, and/or 650) (e.g., a smartphone, a tablet computer, a desktop computer, a laptop computer, and/or a head-mounted device (e.g., a head-mounted augmented reality and/or extended reality device)) that is in communication with (e.g., includes and/or is connected to) a set of one or more display generation components (600a, 600b, 610a, and/or 650a) (e.g., a display controller, a monitor, a touch-sensitive display system, a display screen, a projector, a holographic display, and/or a head-mounted display system) and one or more input devices (e.g., 650b and/or 650c) (e.g., a touch-sensitive surface, a keyboard, mouse, trackpad, one or more optical sensors for detecting gestures, one or more capacitive sensors for detecting hover inputs, and/or accelerometer/gyroscope/inertial measurement units). Some operations in method 700 are, optionally, combined, the orders of some operations are, optionally, changed, and some operations are, optionally, omitted.

As described below, method 700 provides an intuitive way for displaying remote content. The method reduces the cognitive burden on a user for manipulating user interfaces displaying remote content, thereby creating a more efficient human-machine interface. For battery-operated computing devices, enabling a user to manipulate user interfaces displaying remote content faster and more efficiently conserves power and increases the time between battery charges.

In method 700, the computer system (e.g., 610 and/or 650) displays (702), via the set of one or more display generation components (e.g., 610a and/or 650a), a shared-content user interface (e.g., 615) (e.g., a screen-sharing interface and/or a screen sharing application window) having respective content (e.g., 601a and/or 602a) shared from an external computer system (e.g., 600) (e.g., a remote computer system having two or more desktops). In some embodiments, the respective content is shared (e.g., transmitted) from the external computer system (directly, or indirectly such as, for example, through a server) to the computer system for display at the computer system. In some embodiments, the respective content is concurrently displayed at both the computer system and the external computer system. In some embodiments, the respective content is not displayed at the external computer system. The shared-content user interface includes: a representation (e.g., 601a) of first content shared from a first desktop (e.g., 601) (e.g., content that represents a first desktop of the external computer system and/or is displayed on a first display screen (e.g., 600a) of the external computer system and is being shared with the computer system) of the external computer system (e.g., a first remote desktop); and a representation (e.g., 602a) of second content shared from a second desktop (e.g., 602) (e.g., content that represents a second desktop of the external computer system and/or is displayed on a second display screen (e.g., 600b) of the external computer system and is being shared with the computer system) of the external computer system (e.g., a second remote desktop).

While displaying the shared-content user interface (e.g., 615) having a first displayed state (e.g., as shown in FIG. 6F) (e.g., a state in which the shared-content user interface is not displayed in a full-screen mode and/or is displayed at a smaller size than the second displayed state), the computer system (e.g., 610 and/or 650) receives (704) a request (e.g., 642) to modify (e.g., expand and/or enlarge) the shared-content user interface from the first displayed state to a second displayed state (e.g., a state in which the shared-content user interface is displayed in a full-screen mode and/or is displayed at a larger size than the first displayed state).

In response to receiving the request to modify the shared-content user interface (e.g., 615) from the first displayed state to the second displayed state, the computer system (e.g., 610 and/or 650) displays (706) the shared-content user interface having the second displayed state, including the following. In accordance with a determination that the set of one or more display generation components includes a first display generation component (e.g., 610a) and a second display generation component (e.g., 650a) different from the first display generation component (e.g., the computer system is in communication with, or includes, two or more display screens that are available for use at the computer system), the computer system displays (708) (or causes display of) the representation (e.g., 601a) of the first content shared from the first desktop (e.g., 601) of the external computer system (e.g., 600) at the first display generation component (e.g., 610a) (e.g., without displaying the representation of the second content at the first display generation component) and displays the representation (e.g., 602a) of the second content shared from the second desktop (e.g., 602) of the external computer system at the second display generation component (e.g., 650a) (e.g., as shown in FIG. 6G) (e.g., without displaying the representation of the first content at the second display generation component). In some embodiments, the computer system displays the representation of the first content shared from the first desktop of the external computer system having the second displayed state (e.g., enlarged and/or full-screen) at the first display generation component. In some embodiments, the computer system displays the representation of the second content shared from the second desktop of the external computer system having the second displayed state (e.g., enlarged and/or full-screen) at the second display generation component.

In accordance with a determination that the set of one or more display generation components includes the first display generation component (e.g., 610a or 650a) and does not include another display generation component (e.g., the computer system is in communication with, or includes, only a single display screen, and/or only a single display screen is available for use at the computer system), the computer system (e.g., 610) displays (710) the representation (e.g., 601a) of the first content shared from the first desktop (e.g., 601) of the external computer system (e.g., 600) and the representation (e.g., 602a) of the second content shared from the second desktop (e.g., 602) of the external computer system at the first display generation component (e.g., 610a) of the computer system (e.g., as shown in FIG. 6E) (e.g., without displaying the shared-content user interface at any other display screen) (e.g., the representation of the first remote desktop and the representation of the second remote desktop are displayed having the second displayed state (e.g., enlarged and/or full-screen) at the first display screen of the computer system and are not displayed at any other display screen). Displaying the representation of the first content shared from the first desktop of the external computer system at the first display generation component and displaying the representation of the second content shared from the second desktop of the external computer system at the second display generation component when the set of one or more display generation components includes a first display generation component and a second display generation component different from the first display generation component provides an improved control scheme for viewing content shared from two different remote desktops. In some embodiments, the computer system displays the representation of the first remote desktop and the representation of the second remote desktop in a single enlarged and/or full-screen window (e.g., in the same window) at the first display screen.

In some embodiments, the request to modify the shared-content session user interface (e.g., 615) from the first displayed state (e.g., a state as shown in FIGS. 6B and/or 6C) to the second displayed state (e.g., a state as shown in FIGS. 6D, 6E, 6F, and/or 6G) includes a selection (e.g., 630 and/or 634) of a user interface element (e.g., 628 and/or 632a) (e.g., a “both displays” option) for concurrently displaying (e.g., at the first display generation component and/or at the second display generation component) the representation (e.g., 601a) of the first content shared from the first desktop (e.g., 601) of the external computer system (e.g., 600) and the representation (e.g., 602a) of the second content shared from the second desktop (e.g., 602) of the external computer system. In some embodiments, the representation of the first content shared from the first desktop of external computer system is displayed at the first display generation component (e.g., 610a) and the representation of the second content shared from the second desktop of the external computer system is displayed at the second display generation component (e.g., 650a) when the “both displays” option (e.g., 632a) is selected while the shared-content user interface (e.g., 615) is in an enlarged and/or full-screen mode.

In some embodiments, the computer system (e.g., 610 and/or 650) displays (e.g., in response to receiving a selection of a dropdown menu (e.g., 628 and/or 632) having options (e.g., 632a-632c) for selecting the first remote desktop content, the second remote desktop content, or both) a set of display options (e.g., user interface elements) for selecting content for display in the shared-content user interface, wherein the set of display options includes: a first selectable option (e.g., a “Display 1” option) for displaying (e.g., at the first display generation component or at the second display generation component) the representation of the first content shared from the first desktop of the external computer system (e.g., without displaying the representation of the second content shared from the second desktop of the external computer system); a second selectable option (e.g., a “Display 2” option) for displaying (e.g., at the first display generation component or at the second display generation component) the representation of the second content shared from the second desktop of the external computer system (e.g., without displaying the representation of the first content shared from the first desktop of the external computer system); and a third selectable option (e.g., a “both displays” option) for concurrently displaying (e.g., at the first display generation component and/or at the second display generation component) the representation of the first content shared from the first desktop of the external computer system and the representation of the second content shared from the second desktop of the external computer system. In some embodiments, in response to detecting a selection of the third selectable option (in some embodiments, the selection of the third selectable option is part of the request to modify the shared-content session user interface from the first displayed state to the second displayed state), the computer system performs the following: in accordance with a determination that the set of one or more display generation components includes the first display generation component and the second display generation component, displaying the representation of the first content shared from the first desktop of the external computer system at the first display generation component and displaying the representation of the second content shared from the second desktop of the external computer system at the second display generation component; and in accordance with a determination that the set of one or more display generation components includes the first display generation component and does not include another display generation component, displaying the representation of the first content shared from the first desktop of the external computer system and the representation of the second content shared from the second desktop of the external computer system at the first display generation component of the computer system.

In some embodiments, the representation (e.g., 601a) of the first content shared from the first desktop (e.g., 601) of the external computer system (e.g., 600) is displayed having a first resolution at the first display generation component (e.g., 610a) (e.g., a resolution that is determined based on the display settings of the first display generation component). In some embodiments, the representation (e.g., 602a) of the second content shared from the second desktop (e.g., 602) of the external computer system is displayed having a second resolution at the second display generation component (e.g., 650a) (e.g., a resolution that is determined based on the display settings of the second display generation component). In some embodiments, the first resolution is different from the second resolution (e.g., as shown in FIG. 6G). Displaying the representation of the first content shared from the first desktop of the external computer system having a first resolution at the first display generation component and displaying the representation of the second content shared from the second desktop of the external computer system having a second, different resolution at the second display generation component provides additional control options for automatically adjusting the displayed resolution of content without cluttering the user interface with additional displayed controls. In some embodiments, the content displayed at the first display is displayed at a different resolution than the content displayed at the second display because the display settings of the first and second displays are different. In some embodiments, the content is displayed at different resolutions at the first/second displays if a feature (e.g., a dynamic resolution feature) is enabled to allow the display of content at different resolutions at different display devices.

In some embodiments, the shared-content user interface (e.g., 615) includes a set of one or more system function options (e.g., 616, 622, 624, and/or 626) (e.g., user interface elements) that are selectable to cause a system function (e.g., displaying a predefined arrangement (e.g., a grid) of application icons, displaying a predefined arrangement of application windows, and/or displaying a desktop) to be performed by an operating system of the external computer system (e.g., 600). Displaying the shared-content user interface including a set of one or more system function options that are selectable to cause a system function to be performed by an operating system of the external computer system provides additional controls for performing a system function at the external computer system without cluttering the user interface with additional displayed controls (e.g., controls that would otherwise be displayed in the shared content from the first/second desktops).

In some embodiments, the set of one or more system function options includes a first system function option (e.g., 622) (e.g., a “show application icons” option). In response to detecting selection of the first system function option, the computer system (e.g., 610 and/or 650) causes the operating system of the external computer system (e.g., 600) to display, at the first desktop (e.g., 601) (e.g., 600a) of the external computer system (and/or the second desktop of the external computer system), a predefined arrangement (e.g., a grid arrangement and/or a non-overlapping arrangement) of application icons (e.g., 644) corresponding to applications available at the external computer system. The computer system displays the representation (e.g., 601a) of first content shared from the first desktop of the external computer system including a representation (e.g., 644a) of the predefined arrangement of application icons corresponding to applications available at the external computer system. Causing the operating system of the external computer system to display, at the first desktop of the external computer system, a predefined arrangement of application icons corresponding to applications available at the external computer system, and displaying the representation of first content shared from the first desktop of the external computer system including a representation of the predefined arrangement of application icons corresponding to applications available at the external computer system provides additional controls for causing the external computer system to display a predefined arrangement of the application icons without cluttering the user interface with additional displayed controls (e.g., controls that would otherwise be displayed in the shared content from the first/second desktops).

In some embodiments, the set of one or more system options includes a second system function option (e.g., 624) (e.g., a “show open applications” option). In response to detecting selection of the second system function option, the computer system (e.g., 610 and/or 650) causes the operating system of the external computer system (e.g., 600) to display, at the first desktop (e.g., 601) (e.g., 600a) of the external computer system (and/or the second desktop of the external computer system), a predefined arrangement (e.g., a grid arrangement and/or a non-overlapping arrangement) of application windows (e.g., 604, 606, 608, and/or 652) corresponding to applications opened at the external computer system. The computer system displays the representation (e.g., 601a) of first content shared from the first desktop of the external computer system including a representation (e.g., 604a, 606a, 608a, and/or 652a) of the predefined arrangement of application windows corresponding to applications opened at the external computer system. Causing the operating system of the external computer system to display, at the first desktop of the external computer system, a predefined arrangement of application windows corresponding to applications opened at the external computer system, and displaying the representation of first content shared from the first desktop of the external computer system including a representation of the predefined arrangement of application windows corresponding to applications opened at the external computer system provides additional controls for causing the external computer system to display a predefined arrangement of the opened application windows without cluttering the user interface with additional displayed controls (e.g., controls that would otherwise be displayed in the shared content from the first/second desktops).

In some embodiments, the set of one or more system options includes a third system function option (e.g., 626) (e.g., a “show desktop” option). In response to detecting selection of the third system function option, the computer system (e.g., 610 and/or 650) causes the operating system of the external computer system (e.g., 600) to display, at the first desktop (e.g., 601) (e.g., 600a) of the external computer system (and/or the second desktop of the external computer system), a desktop view of the first desktop (and/or the second desktop) of the external computer system (e.g., as shown in FIG. 6L) (e.g., a view of the computer desktop (e.g., a home screen, an area of the computer screen in which application icons are optionally displayed, and/or an area of the computer screen that does not include any open application windows)). The computer system displays the representation of first content shared from the first desktop of the external computer system including a representation (e.g., 601a) of the desktop view of the first desktop of the external computer system. Causing the operating system of the external computer system to display, at the first desktop of the external computer system, a desktop view of the first desktop of the external computer system, and displaying the representation of first content shared from the first desktop of the external computer system including a representation of the desktop view of the first desktop of the external computer system provides additional controls for causing the external computer system to display the desktop view of the first desktop without cluttering the user interface with additional displayed controls (e.g., controls that would otherwise be displayed in the shared content from the first/second desktops).

In some embodiments, the shared-content user interface (e.g., 615) includes a control access option (e.g., 618) (e.g., user interface element). In response to detecting selection of the control access option, the computer system (e.g., 610 and/or 650) initiates a process for requesting access (e.g., from the external computer system (e.g., 600)) to control operation of the first desktop (e.g., 600a) (e.g., 601) and/or the second desktop (e.g., 600b) (e.g., 602) of the external computer system (e.g., using the one or more input devices of the computer system). Initiating a process for requesting access to control operation of the first desktop and/or the second desktop of the external computer system in response to detecting selection of the control access option provides additional control options for requesting access to control the external computer system without cluttering the user interface with additional displayed controls. In some embodiments, the external computer system is prompted to grant or deny the request for the computer system to control operation of the first and/or second desktop of the external computer system. If the external computer system grants the request, the computer system is given permission to control operation of the first and/or second desktop, including controlling the first content shared from the first desktop of the external computer system and/or the second content shared from the second desktop of the external computer system.

In some embodiments, the shared-content user interface (e.g., 615) includes a display lock option (e.g., 616) (e.g., user interface element). While the first content shared from the first desktop (e.g., 601) of the external computer system (e.g., 600) is displayed (e.g., at a first display device (e.g., 600a)) at the external computer system and the second content shared from the second desktop (e.g., 602) of the external computer system is displayed (e.g., at a second display device (e.g., 600b)) at the external computer system, the computer system (e.g., 610 and/or 650) detects, via the one or more input devices (e.g., 650c and/or 650b), a selection of the display lock option. In response to detecting selection of the display lock option, the computer system initiates a process for disabling the display of the first content at the external computer system (e.g., locking, disabling, and/or visually obscuring the first content, the first desktop, and/or the first display device) and disabling the display of the second content at the external computer system (e.g., locking, disabling, and/or visually obscuring the second content, the second desktop, and/or the second display device). While the display of the first content and the second content are disabled at the external computer system (e.g., as shown in FIG. 6O), the computer system continues to display, via the set of one or more display generation components (e.g., 610a and/or 650a), the shared-content user interface including the representation (e.g., 601a) of first content shared from the first desktop (e.g., 601) (e.g., 600a) of the external computer system and the representation (e.g., 602a) of second content shared from the second desktop (e.g., 602) (e.g., 600b) of the external computer system. Continuing to display the shared-content user interface including the representation of first content shared from the first desktop of the external computer system and the representation of second content shared from the second desktop of the external computer system while the display of the first content and the second content are disabled at the external computer system provides an enhanced control scheme for accessing content at the external computer system while maintaining privacy for the user of the computer system accessing the external computer system.

In some embodiments, displaying the representation (e.g., 601a) of the first content shared from the first desktop (e.g., 601) of the external computer system (e.g., 600) at the first display generation component (e.g., 610a) includes adjusting (e.g., automatically, without further user input) a displayed size (e.g., increasing or decreasing the displayed dimensions) of the representation of the first content based on a set of one or more size characteristics (e.g., display screen size, resolution, and/or display dimensions) of the first display generation component (e.g., to fit within the dimensions of the first display generation component). In some embodiments, displaying the representation (e.g., 602a) of the second content shared from the second desktop (e.g., 602) of the external computer system at the second display generation component (e.g., 650a) includes adjusting (e.g., automatically, without further user input) a displayed size (e.g., increasing or decreasing the displayed dimensions) of the representation of the second content based on a set of one or more size characteristics (e.g., display screen size, resolution, and/or display dimensions) of the second display generation component (e.g., to fit within the dimensions of the second display generation component). Adjusting a displayed size of the representation of the first content based on a set of one or more size characteristics of the first display generation component and adjusting a displayed size of the representation of the second content based on a set of one or more size characteristics of the second display generation component reduces the number of inputs needed to adjust the displayed sizes of the representations of first and second content for the respective first and second display generation components.

Note that details of the processes described above with respect to method 700 (e.g., FIG. 7) are also applicable in an analogous manner to the methods described below. For example, methods 900 and 1100 optionally include one or more of the characteristics of the various methods described above with reference to method 700. For example, the virtual user interfaces generated using the techniques in method 900 and/or the user interfaces for displaying shared content as described with respect to method 1100 can be manipulated using any of the techniques described with respect to method 700. For brevity, these details are not repeated below.

FIGS. 8A-8P illustrate exemplary user interfaces for generating virtual displays for displaying remote content, in accordance with some embodiments. The user interfaces in these figures are used to illustrate the processes described below, including the processes in FIG. 9.

FIG. 8A illustrates John's computer 610 displaying connections interface 802, which is a user interface for establishing a connection with a remote device or computer system in order to share content. For example, a connection can be established with the remote device or computer system to share screen content as described with respect to FIGS. 6A-6O and FIGS. 10A-10K. Connections interface 802 includes a listing of recently connected computer systems. In some embodiments, a connection can be reestablished with a recently connected computer system. For example, John's system was previously connected to Jane's computer and the connection can be established (or reestablished) by selecting connect option 806. In some embodiments, a new connection can be established by selecting new connection option 804. FIGS. 8A-8C depict an example embodiment in which new connection option 804 is used to establish a connection with Jane's computer. However, it should be appreciated that the connection can instead be established by selecting connect option 806. In some embodiments, selecting connect option 806 identifies Jane's computer for establishing a connection without displaying the user interface in FIG. 8B, and the user interface in FIG. 8C is displayed in response to selecting connect option 806. In some embodiments, selecting connect option 806 establishes a connection with Jane's computer without displaying the user interfaces depicted in FIGS. 8B and 8C, and the user interface depicted in FIG. 8D is displayed in response to selecting connect option 806.

In FIG. 8A, John's computer 610 detects input 808 selecting new connection option 804 and, in response, displays interface 810, which prompts the user to enter the name or identification of a computer system with which to connect. For example, the identification can be a user ID, email address, or other means for identifying a computer for establishing the connection. As shown in FIG. 8B, Jane's computer is identified in interface 810 and connect option 812 is selected via input 814.

In response to selection of connect option 812, John's computer 610 displays login interface 816, as shown in FIG. 8C. Login interface 816 is an interface used to provide credentials for accessing or logging into Jane's computer. After entering the login credentials such as a username and password, John's computer 610 detects input 818 selecting continue option 820. In response, the login credentials are authorized and John's computer 610 establishes a connection with Jane's computer 600.

After selecting continue option 820, John's computer 610 displays display type interface 822, as shown in FIG. 8D. Display type interface 822 provides options for selecting different display types that can be generated at John's computer 610 for viewing content from Jane's computer 600. Virtual display option 824 can be selected (e.g., via one or more inputs) to generate a single virtual display window for viewing content that is accessed from, but not displayed at, Jane's computer 600. Virtual displays option 826 can be selected (e.g., via one or more inputs) to generate two virtual display windows for viewing content accessed from, but not displayed at, Jane's computer. Remote computer display option 828 can be selected (e.g., via one or more inputs) to generate a window for viewing content that is currently displayed at a physical display device (e.g., display screen 600a) of Jane's computer 600.

FIG. 8D also depicts Jane's computer 600, which is displaying desktop 832 on display screen 600a. Desktop 832 includes system window 834, application window 836, and menu bar 838 including application icons that can be selected to launch an application available at Jane's computer 600. In the embodiment depicted in FIG. 8D, Jane's computer 600 includes display screen 600a and hardware 600c.

FIGS. 8D-8F depict example interfaces for an embodiment in which remote computer display option 828 is selected in display type interface 822. In FIG. 8D, John's computer 610 detects input 830 selecting remote computer display option 828. In response, John's computer 610 shows option 828 in a selected state (as indicated by a checkmark next to the option), as shown in FIG. 8E. John's computer 610 then detects input 840 selecting continue option 842 and, in response, displays window 845 as shown in FIG. 8F. Window 845 is a user interface for viewing content that is currently displayed at display screen 600a of Jane's computer 600. Specifically, window 845 includes representation 832a of desktop 832, which includes representation 834a of system window 834, representation 836a of application window 836, and representation 838a of menu bar 838. Accordingly, John's computer 610 is displaying the content from Jane's display screen 600a, as shown in FIG. 8F. In some embodiments, window 845 is similar to sharing application window 615. Accordingly, John's computer 610 can view and interact with the content on Jane's display screen 600a in a manner similar to that discussed above with respect to FIGS. 6A-6O. For the sake of brevity, details are not repeated.

In some embodiments, John's computer 610 can generate one or more virtual displays for viewing content from Jane's computer 600. In such embodiments, the content from Jane's computer 600 may not be displayed at a display screen (e.g., display screen 600a) of Jane's computer, but can still be accessed via the connection between John's computer 610 and Jane's computer 600. In this way, John's computer 610 establishes a virtual desktop for accessing (including displaying) content from a remote computer system, even when the content is not displayed at the remote computer system. FIGS. 8G-8N depict example interfaces for embodiments in which one or more virtual displays are generated for displaying content that is not displayed at the remote computer system. Specifically, FIGS. 8G-8I depict example embodiments in which John's computer 610 generates a single virtual display window for displaying content from Jane's computer 600, and FIGS. 8J-8N depict example embodiments in which John's computer 610 generates multiple virtual display windows for displaying content from Jane's computer 600.

In FIG. 8G, John's computer 610 has selected virtual display option 824 (as indicated by the checkmark), and selects continue option 842 via input 844. Jane's computer 600 is shown with display screen 600a inactive or turned off. Accordingly, Jane's computer 600 is not displaying any content in the embodiment depicted in FIG. 8G.

In response to detecting input 844, John's computer 610 generates virtual display window 847, as shown in FIG. 8H. Virtual display window 847 is a virtual display for showing content that is accessed from Jane's computer 600, even though display screen 600a is inactive and, therefore, is not displaying any content. John's computer 610a generates virtual display window 847 in order to provide a user interface for remotely accessing Jane's computer 600. Thus, John's computer 610 can be used to control Jane's computer 600 using virtual display window 847. The resulting operations at Jane's computer 600 are then displayed at John's computer 610 using virtual display window 847. In some embodiments, virtual display window 847 is similar to sharing application window 615, except that the content displayed in virtual display window 847 is not displayed at Jane's computer 600.

Virtual display window 847 includes virtual desktop 846, including virtual menu bar 848. Virtual desktop 846 is similar to desktop 832 at Jane's computer. For example, virtual desktop 846 includes a balloons-themed wallpaper and includes menu bar 848 (similar to menu bar 838) with application icons for launching applications available at Jane's computer 600. John's computer 610 can interact with (e.g., control) Jane's computer 600 using virtual desktop 846. For example, John's computer 610 selects music icon 850 via input 852 at John's computer 610. In response, John's computer 610 causes the music application to be launched from Jane's computer 600, which is displayed in music interface 854 at John's computer 610, as shown in FIG. 8I. Accordingly, John's computer 610 is controlling the launching of the music application at Jane's computer 600 and is viewing the resulting music interface 854 displayed in virtual display window 847. In some embodiments, John's computer 610 can select music from music interface 854 and the music is output at John's computer 610, using speakers connected to John's computer.

In FIG. 8J, John's computer 610 has selected virtual displays option 826 (as indicated by the checkmark) and selects continue option 842 via input 856. Jane's computer 600 is shown without display screen 600a. Accordingly, Jane's computer 600 includes only hardware 600c without any display components.

In response to detecting input 856, John's computer 610 generates virtual display window 849, as shown in FIG. 8K. Virtual display window 849 is a virtual display for showing content that is accessed from Jane's computer 600, specifically hardware 600c. John's computer 610a generates virtual display window 849 in order to provide a user interface for remotely accessing hardware 600c of Jane's computer 600. Virtual display window 849 is similar to virtual display window 847 except that virtual display window 849 is generated with two virtual desktops, instead of one. Thus, John's computer 610 can be used to control Jane's computer 600 using any of the virtual desktops provided in virtual display window 849 and the resulting operations at Jane's computer 600 are then displayed at John's computer 610 using virtual display window 849. In some embodiments, virtual display window 849 is similar to sharing application window 615, except that the content displayed in virtual display window 849 is not displayed at Jane's computer 600.

Virtual display window 849 includes virtual desktop 846 and second virtual desktop 858. Second virtual desktop 858 is a second instance of a virtual desktop for Jane's computer 600 that is similar to virtual desktop 846. For example, second virtual desktop 858 includes a balloons-themed wallpaper and includes menu bar 860 (similar to menu bar 848) with application icons for launching applications available at Jane's computer 600. John's computer 610 can interact with (e.g., control) Jane's computer 600 using virtual desktop 846 and/or second virtual desktop 858. For example, in FIG. 8K, John's computer 610 selects music icon 850 via input 862 at virtual desktop 846. In response, John's computer 610 causes the music application to launch at Jane's computer 600, and John's computer 610 displays music interface 854 in virtual desktop 846, as shown in FIG. 8I. Similarly, John's computer 610 can control Jane's computer 600 using second virtual desktop 858. For example, in FIG. 8L, John's computer 610 detects input 866 selecting photos icon 864. In response, John's computer 610a causes Jane's computer 600 to launch the photos application, and photos interface 868 is displayed in second virtual desktop 858, as shown in FIG. 8M. Accordingly, John's computer 610 is controlling the launching of the music and photos applications at Jane's computer 600 and is displaying the resulting interfaces in the respective virtual desktops in virtual display window 849.

In some embodiments, the two virtual desktops in virtual display window 849 can be split across two display devices in a manner similar to that described above with respect to FIGS. 6F and 6G. For example, in FIG. 8M John's system includes John's computer 610 and John's laptop 650. In response to detecting input 872 selecting enlarge option 870, virtual desktop window 849 is expanded (e.g., to a full-screen display mode), and virtual desktop 846 and second virtual desktop 858 are displayed in an expanded (e.g., full-screen) mode at the respective devices in John's system. Specifically, virtual desktop 846 is displayed in an enlarged state at John's computer 610, and second virtual desktop 858 is displayed in an enlarged state at John's laptop 650, as shown in FIG. 8N. It should be appreciated that John's system can be used to control operations at Jane's computer 600 while the virtual desktops are split across John's computer 610 and John's laptop 650. For example, inputs at John's computer 610 or at John's laptop 650 can be used to control Jane's computer via the corresponding virtual desktops displayed at the respective devices (e.g., John's computer 610 and John's laptop 650). In some embodiments, a single device can be used to provide input at both of the virtual desktops. For example, a mouse and/or keyboard that is connected to John's computer 610 can be used to provide input at virtual desktop 846 and/or at second virtual desktop 858. Similarly, trackpad 650c and/or keyboard 650b can be used to provide input at virtual desktop 846 and/or at second virtual desktop 858.

In the embodiments depicted in FIGS. 8M and 8N, the dynamic resolution feature is enabled when virtual display window 849 is expanded. Accordingly, the resolutions and sizes of the virtual desktop 846 and second virtual desktop 858 are automatically adjusted to fit the display capabilities of John's computer 610 and John's laptop 650, respectively.

In some embodiments, the dynamic resolution feature can be enabled or disabled by accessing the display settings of the host computer (e.g., Jane's computer 600). For example, FIGS. 8O and 8P depict user interfaces for an example embodiment where display settings interface 874 of Jane's computer 600 is accessed by John's computer 610 using virtual desktop window 875 (similar to virtual desktop window 847). In FIG. 8O, the dynamic resolution feature is enabled. In response to detecting input 878 selecting toggle 876, John's computer 610 disables the dynamic resolution feature at Jane's computer 600, as shown in FIG. 8P. When the dynamic resolution feature is disabled, display settings interface 874 includes various preset resolution options 880 that can be selected to set a resolution for the content displayed from Jane's computer 600 in the virtual desktop in FIGS. 8O and 8P. In FIG. 8P, resolution option 880c is shown as the selected preset resolution option.

FIG. 9 is a flow diagram illustrating a method for generating virtual displays for displaying remote content using a computer system in accordance with some embodiments. Method 900 is performed at a computer system (e.g., 100, 300, 500, 600, 610, and/or 650) (e.g., a smartphone, a tablet computer, a desktop computer, a laptop computer, and/or a head-mounted device (e.g., a head-mounted augmented reality and/or extended reality device)) that is in communication with (e.g., includes and/or is connected to) a set of one or more display generation components (600a, 600b, 610a, and/or 650a) (e.g., a display controller, a monitor, a touch-sensitive display system, a display screen, a projector, a holographic display, and/or a head-mounted display system) and one or more input devices (e.g., 650b and/or 650c) (e.g., a touch-sensitive surface, a keyboard, mouse, trackpad, one or more optical sensors for detecting gestures, one or more capacitive sensors for detecting hover inputs, and/or accelerometer/gyroscope/inertial measurement units). Some operations in method 900 are, optionally, combined, the orders of some operations are, optionally, changed, and some operations are, optionally, omitted.

As described below, method 900 provides an intuitive way for generating virtual displays for displaying remote content. The method reduces the cognitive burden on a user for generating virtual displays for displaying remote content, thereby creating a more efficient human-machine interface. For battery-operated computing devices, enabling a user to generate virtual displays for displaying remote content faster and more efficiently conserves power and increases the time between battery charges.

In method 900, the computer system (e.g., 610 and/or 650) displays (902), via the set of one or more display generation components (e.g., 610a and/or 650a), a setup user interface (e.g., 822) for enabling display (e.g., via the set of one or more display generation components) of content shared from an external computer system (e.g., 600) (e.g., a remote computer system), including displaying, in the setup user interface, a plurality of display type options (e.g., 824, 826, and/or 828) (e.g., user interface elements) for selecting a display type for displaying the content shared from the external computer system. In some embodiments, the content is shared (e.g., transmitted) from the external computer system (directly, or indirectly such as, for example, through a server) to the computer system for display at the computer system. In some embodiments, the content is concurrently displayed at both the computer system and the external computer system. In some embodiments, the content is not displayed at the external computer system (e.g., the external computer system does not have a display and/or is not associated with a display).

The computer system (e.g., 610 and/or 650) detects (904), via the one or more input devices (e.g., 650b and/or 650c), a first set of one or more inputs (e.g., 830, 840, 844, and/or 856) (e.g., directed to the setup user interface) corresponding to a request to enable display of content shared from the external computer system (e.g., 600).

In response to detecting the first set of one or more inputs (e.g., 830, 840, 844, and/or 856) corresponding to a request to enable display of content shared from the external computer system (e.g., 600), the computer system (e.g., 610 and/or 650) displays (906), via the one or more display generation components (e.g., 610a and/or 650a), content shared from the external computer system, including the following. In accordance with a determination that a first display type option (e.g., 828) (e.g., an option (e.g., user interface element) corresponding to a respective physical display) is selected (e.g., the first set of one or more inputs includes a selection of the first display type option and/or the first display type option is selected when the display of the shared content is enabled), the computer system displays (908), via the set of one or more display generation components, a representation (e.g., 832a, 834a, 836a, and/or 838a) of first content that is shared from the external computer system (e.g., 600) and is displayed (e.g., concurrently) at a display device (e.g., 600a) (e.g., a display screen, a monitor) of the external computer system (e.g., the computer system displays content that is shared from the external computer system while the shared content is also displayed at a physical display device of the external computer system). In accordance with a determination that a second display type option (e.g., 824) (e.g., a user interface element, a virtual display option, a “1 Virtual Display” option) is selected (e.g., the first set of one or more inputs includes a selection of the second display type option and/or the second display type option is selected when the display of the shared content is enabled), the computer system generates (910) (and, in some embodiments, displaying via the set of one or more display generation components) a virtual display interface (e.g., 847, 849, or 875) that includes a representation (e.g., 846, 848, and/or 850) of second content that is shared from the external computer system and is not displayed at a display device of the external computer system (e.g., the virtual display interface displays content that is shared from the external computer system (e.g., a first remote desktop) while the shared content is not displayed (e.g., at the time the display of the shared content is enabled) at a display device of the external computer system). Generating the virtual display interface that includes a representation of second content that is shared from the external computer system and is not displayed at a display device of the computer system when the second display type option is selected provides an improved control scheme for accessing content at a remote computer system that does not have a display component.

In some embodiments, as a part of displaying content shared from the external computer system (e.g., 600), the computer system (e.g., 610 and/or 650) performs the following. In accordance with a determination that a third display type option (e.g., 826) (e.g., a user interface element, a virtual display option, a “2 Virtual Displays” option) is selected (e.g., the first set of one or more inputs includes a selection of the third display type option and/or the third display type option is selected when the display of the shared content is enabled), the computer system generates (and, in some embodiments, displays via the set of one or more display generation components) a second virtual display interface (e.g., 849) (e.g., the virtual display interface) that includes: the representation of second content (e.g., 846, 848, and/or 850) (e.g., a first remote desktop) that is shared from the external computer system and is not displayed at a display device of the external computer system; and a representation of third content (e.g., 858, 860, and/or 864) (e.g., a second remote desktop) that is shared from the external computer system and is not displayed at a display device of the external computer system (e.g., the second virtual display interface displays content that is shared from the external computer system (e.g., a first remote desktop and a second remote desktop) while the shared content is not displayed (e.g., at the time the display of the shared content is enabled) at a display device of the external computer system). Generating a second virtual display interface that includes the representation of second content that is shared from the external computer system and is not displayed at a display device of the computer system and a representation of third content that is shared from the external computer system and is not displayed at a display device of the external computer system provides an improved control scheme for accessing content at a remote computer system that does not have a display component. In some embodiments, the representation of second content is concurrently displayed with the representation of third content in the second virtual display interface.

In some embodiments, the set of one or more display generation components includes a first display generation component (e.g., 610a) and a second display generation component (e.g., 650a) (e.g., the computer system is in communication with, or includes, two or more display screens that are available for use at the computer system). In some embodiments, while displaying the second virtual display interface (e.g., 849) having a first displayed state (e.g., as shown in FIG. 8M) (e.g., a state in which the virtual display interface is not displayed in a full-screen mode and/or is displayed at a smaller size than the second displayed state), the computer system (e.g., 610 and/or 650) receives a request (e.g., 872) to modify (e.g., expand and/or enlarge) the second virtual display interface from the first displayed state to a second displayed state (e.g., a state in which the virtual display interface is displayed in a full-screen mode and/or is displayed at a larger size than the first displayed state). In response to receiving the request to modify the second virtual display interface from the first displayed state to the second displayed state, the computer system displays the second virtual display interface having the second displayed state, including: displaying (or causing display of) the representation of second content (e.g., 846, 848, 850, and/or 854) at the first display generation component (e.g., 610a) (e.g., without displaying the representation of the third content at the first display generation component); and displaying the representation of third content (e.g., 858, 860, 864, and/or 868) at the second display generation component (e.g., 650a) (e.g., without displaying the representation of the second content at the second display generation component). Displaying the representation of second content at the first display generation component and displaying the representation of third content at the second display generation component provides an improved control scheme for accessing and viewing two different representations of content from a remote computer system that does not have a display component.

In some embodiments, while displaying the virtual display interface (e.g., 847, 849, and/or 875) that includes the representation of second content that is shared from the external computer system (e.g., 600) and is not displayed at a display device of the external computer system, the computer system (e.g., 610 and/or 650) detects, via the one or more input devices (e.g., 850b and/or 850c), a request (e.g., 852, 862, and/or 866) to perform an operation (e.g., access content (e.g., for display via the virtual display interface at the computer system), perform a system function, and/or modify content) at the external computer system. In response to detecting the request to perform the operation at the external computer system, the computer system causes the external computer system to perform the operation (e.g., sending instructions to the external computer system for executing the operation). Causing the external computer system to perform the operation in response to detecting the request to perform the operation at the external computer system provides an improved control scheme for remotely accessing and controlling content at a remote computer system that does not have a display component. In some embodiments, the virtual display is used to control the external computer system. In some embodiments, the virtual display interface enables operations performed at the external computer system (or the results of such operations) to displayed at the set of one or more display generation components of the computer system, even when the operations (or results of the operations) are not viewable at the external computer system (e.g., because the external computer system does not include a display device).

In some embodiments, the computer system (e.g., 610 and/or 650) displays a resolution option (e.g., 876) (e.g., user interface element) that is selectable to enable (or disable) a dynamic resolution mode in which a displayed resolution of the representation of first content (e.g., 846, 848, 850, 854, 858, 860, 864, and/or 868) is automatically adjusted (e.g., changed, updated, and/or modified) in the virtual display interface (e.g., 847, 849, and/or 875) based on one or more display characteristics (e.g., display settings and/or display capabilities) of the set of one or more display generation components (e.g., 610a and/or 650a). Displaying the setup user interface including a resolution option that is selectable to enable a dynamic resolution mode in which a displayed resolution of the representation of first content is automatically adjusted in the virtual display interface based on one or more display characteristics of the set of one or more display generation components provides additional control options for automatically adjusting the displayed resolution of content, which reduces the number of inputs at the computer system by eliminating the need to adjust the displayed resolution of the content to fit the display generation components. In some embodiments, when the dynamic resolution mode is disabled, the representation of first content is displayed having a predetermined resolution in the virtual display interface.

In some embodiments, displaying the resolution option (e.g., 876) includes: in accordance with a determination that the dynamic resolution mode is disabled, displaying a set (e.g., 880) of predetermined resolution options (e.g., 880a-880d) that are selectable to provide a predetermined resolution for displaying the representation of first content (e.g., 846, 848, 850, 854, 858, 860, 864, and/or 868) in the virtual display interface (e.g., 847, 849, and/or 875) (e.g., as shown in FIG. 8P); and in accordance with a determination that the dynamic resolution mode is enabled, forgoing displaying the set of predetermined resolution options that are selectable to provide a predetermined resolution for displaying the representation of first content in the virtual display interface (e.g., as shown in FIG. 8O). Displaying the set of predetermined resolution options that are selectable to provide a predetermined resolution for displaying the representation of first content in the virtual display interface when the dynamic resolution mode is disabled provide additional control options for setting a resolution setting without cluttering the user interface with additional displayed controls. In some embodiments, when the dynamic resolution mode is disabled, the computer system displays options for manually selecting a resolution for the content displayed in the virtual display interface.

Note that details of the processes described above with respect to method 900 (e.g., FIG. 9) are also applicable in an analogous manner to the methods described above and/or below. For example, methods 700 and 1100 optionally include one or more of the characteristics of the various methods described above with reference to method 900. For example, the user interfaces described with respect to the techniques in method 700 and/or method 1100 can be generated using any of the techniques described with respect to method 900. For brevity, these details are not repeated.

FIGS. 10A-10K illustrate exemplary user interfaces for displaying shared content, in accordance with some embodiments. The user interfaces in these figures are used to illustrate the processes described below, including the processes in FIG. 11.

FIGS. 10A-10K depict example user interfaces for various embodiments in which John's laptop 650 is sharing content with Jane's computer 600 while participating in a real-time communication session (e.g., a video chat). In some embodiments, the user interfaces depict a changing appearance of a displayed cursor when an input is made using the cursor or when an input is made that may be relevant to the cursor position. This provides improved feedback to the participants of the shared-content session by providing context for inputs made by the other participant in the shared-content session. This is particularly advantageous for situations in which it may not otherwise be apparent to a participant of a shared-content session when an input is made by the other participant. The sharing of content, including the updates to the appearance of the cursors, avatars, and other visual features, is facilitated using the sharing application operating at Jane's computer 600 and John's laptop 650.

In FIG. 10A, John's laptop displays desktop 1002 which includes browser window 1004. John's cursor 1006 is positioned on browser window 1004. John's laptop 650 is sharing its screen content with Jane's computer 600, as shown on Jane's computer in sharing application window 1005 (similar to sharing application window 615). Accordingly, Jane's computer 600 displays, in sharing application window 1005, representation 1002a of John's desktop 1002, including representation 1004a of browser window 1004, and representation 1006a of John's cursor 1006. In some embodiments, the displayed video feeds for the real-time communication session are not displayed in the shared content. Jane's computer also displays system window 1010 and Jane's cursor 1008, which is positioned over system window 1010. System window 1010 is positioned in front of a portion of sharing application window 1005, however, system window 1010 is not part of the screen content shared from John's laptop 650.

In some embodiments, a position of Jane's cursor 1008 can be shown at John's laptop 650 during the shared-content session when Jane's cursor is positioned over the shared content. For example, in FIG. 10B, Jane has moved cursor 1008 off of system window 1010 and onto sharing application window 1005. In response to detecting the position of Jane's cursor on sharing application window 1005, Jane's computer displays Jane's avatar 1012 next to cursor 1008 to indicate to Jane that cursor 1008 is Jane's cursor and to provide feedback to Jane that her cursor (and avatar) is being displayed at John's laptop 650. Similarly, John's laptop 650 displays representation 1008a of Jane's cursor 1008 and representation 1012a of Jane's avatar to indicate to John that Jane's cursor is displayed at John's laptop 650 over the shared content. As Jane moves cursor 1008 over the shared content in sharing application window 1005, the positions of representation 1008a of Jane's cursor and representation 1012a of Jane's avatar are updated in real time on John's laptop 650. In some embodiments, Jane's avatar 1012 is an avatar that is associated with a user account (e.g., Jane's user account) that is logged into Jane's computer 600. In some embodiments, Jane's avatar is a user-created avatar or customized avatar that represents Jane.

In some embodiments, a visual indication of a cursor input is provided to indicate to a participant when the other participant provides an input using their respective cursor. For example, in FIG. 10B John clicks trackpad 650c in order to provide a click or selection input with John's cursor 1006. Accordingly, Jane's computer 600 displays ripple effect 1014, which is a visual animation associated with representation 1006a of John's cursor 1006, indicating to Jane that John provided a click input for cursor 1006. In the embodiment depicted in FIG. 10B, the ripple effect is not displayed at John's laptop 650 because it is unnecessary to indicate the click input to John since he is likely aware that he provided a click input. However, in some embodiments, the ripple effect can be displayed at John's laptop 650. It should be appreciated that a ripple effect is one example of an animated effect that can be used to indicate a click input. Other animated effects can be used to indicate the click input such as, for example, a pulsing ring or other visual effect. In some embodiments, the ripple effect is shown one time for a single-click input. In some embodiments, the ripple effect is modified for a double-click input, for example, to display the ripple effect twice in succession or to display a ripple effect with additional ripples.

In some embodiments, a visual indication of a cursor input is not provided for some cursor inputs. For example, in FIG. 10C, John right-clicks trackpad 650c. In response to detecting the right-click input, John's laptop 650 displays right-click menu 1016 and Jane's computer 600 displays representation 1016a of right-click menu 1016, but neither device displays a ripple effect to indicate the detection of the right-click input. In some embodiments, Jane's computer does not display representation 1016a of right-click menu 1016 in response to the right-click input at John's laptop 650.

In some embodiments, a visual indication of a keyboard input is provided in response to a detected keyboard input. For example, in FIG. 10D, John selects the “control” and “shift” keys from keyboard 650b. In response to detecting the keyboard input, John's laptop 650 displays indicator 1018, which provides feedback to John of the keyboard keys being pressed at John's laptop 650 (in some embodiments, indicator 1018 is not displayed at John's laptop 650 because the input is provided at John's laptop 650). Similarly, Jane's computer 600 displays indicator 1019, which provides feedback to Jane of the keyboard keys being pressed at John's laptop 650. In some embodiments, visual indications can be combined for multiple types of inputs. For example, if John also clicks trackpad 650c while pressing the “control” and “shift” keys, Jane's computer 600 (and optionally John's laptop 650) displays a ripple effect in addition to indicator 1018.

In FIG. 10D, Jane has moved cursor 1010 off of the shared content (specifically, representation 1002a of John's desktop 1002) in sharing application window 1005 and is selecting control access option 1020 (similar to control access option 618). Because Jane's cursor is no longer positioned over the shared content in sharing application window 1005, Jane's computer 600 ceases to display avatar 1012 and John's laptop 650 ceases to display the representation 1008a of Jane's cursor and representation 1012a of Jane's avatar.

In response to detecting selection of control access option 1020, Jane's computer 600 initiates a request for John's laptop 650 to permit Jane's computer 600 to control operation of John's laptop 650. As shown in FIG. 10E, Jane's computer 600 displays notification 1022 indicating that Jane's computer is waiting for John's laptop 650 to grant control rights to Jane's computer 600. John's laptop 650 displays notification 1023 prompting John's laptop 650 to grant or deny Jane's computer's request for control of John's laptop. In FIG. 10E, John's laptop 650 selects allow option 1024 to grant control rights to Jane's computer 600.

In FIG. 10F, Jane's computer 600 has permission to control operation of John's laptop 650 through the sharing application, including permission to control John's cursor 1006 (using hardware at Jane's computer 600). Accordingly, control of John's cursor 1006 is shared between John's laptop 650 and Jane's computer 600. Because control of John's cursor 1006 is shared, Jane's computer 600 displays text 1026 indicating to Jane that she is sharing control of cursor 1006 with John, and John's laptop 650 displays text 1028 indicating to John that he is sharing control of cursor 1006 with Jane—that is, both Jane's computer 600 and John's laptop 650 are capable of moving cursor 1006 and providing input using cursor 1006.

In FIG. 10G, while Jane's computer 600 and John's laptop 650 both have permission to control the cursor, Jane's computer 600 moves cursor 1006 thereby taking current control of the cursor. Accordingly, Jane's computer 600 modifies the appearance of representation 1006a of John's cursor to include avatar 1012, and John's laptop 650 modifies the appearance of cursor 1006 to include representation 1012a of Jane's avatar. The display of Jane's avatar indicates to John and Jane that Jane's computer 600 currently has control of John's cursor 1006.

In FIG. 10H, Jane moves cursor 1006 and clicks on order icon 1032 in browser window 1004. Because Jane's computer 600 is controlling cursor 1006, John's laptop 650 displays representation 1012a of Jane's avatar 1012 with cursor 1006 and displays ripple effect 1030 to indicate to John that Jane's computer 600 is providing a click input for cursor 1006. Similarly, Jane's computer 600 displays Jane's avatar 1012 with representation 1006a of John's cursor 1006 to indicate to Jane that she currently has control of John's cursor 1006.

In FIG. 10I, John's laptop 650 moves cursor 1006, thereby taking control of the cursor. In response to John's laptop 650 taking control of cursor 1006, John's laptop 650 replaces the representation of Jane's avatar with John's avatar 1034 to indicate to John that he is controlling cursor 1006. When John's laptop 650 takes control of cursor 1006, Jane's computer 600 ceases to display Jane's avatar 1012 and instead displays representation 1034a of John's avatar 1034 to indicate to Jane that John currently has control of cursor 1006. In some embodiments, John's avatar 1034 is an avatar that is associated with a user account (e.g., John's user account) that is logged into John's laptop 650. In some embodiments, John's avatar is a user-created avatar or customized avatar that represents John.

In FIG. 10J, John's laptop 650 moves cursor 1006 (including avatar 1034) and selects menu option 1038. Jane's computer 600 displays representation 1006a of John's cursor 1006 and representation 1034a of John's avatar 1034 moving to representation 1038a of menu option 1038. Jane's computer 600 also displays ripple effect 1036 to indicate to Jane that John is providing a click input for cursor 1006 to select menu option 1038.

In response to selecting menu option 1038, John's laptop 650 displays menu 1040, as shown in FIG. 10K. Menu 1040 provides information and controls for the shared-content session, including control option 1042, which is selectable to terminate the permission for Jane's computer 600 to control John's laptop 650. John's laptop moves cursor 1006 (including avatar 1034) to control option 1042 and clicks on control option 1042, thereby terminating Jane's computer's permission to control John's laptop 650. Jane's computer 600 displays the representation of John's cursor and avatar moving to representation 1042a of control option 1042 and displays ripple effect 1044 indicating to Jane that John is clicking on control option 1042. Jane's computer 600 is now capable of viewing the content shared from John's laptop 650 (similar to the embodiment in FIG. 10A), but it is no longer capable of controlling John's computer 650.

FIG. 11 is a flow diagram illustrating a method for displaying shared content using a computer system in accordance with some embodiments. Method 1100 is performed at a computer system (e.g., 100, 300, 500, 600, 610, and/or 650) (e.g., a smartphone, a tablet computer, a desktop computer, a laptop computer, and/or a head-mounted device (e.g., a head-mounted augmented reality and/or extended reality device)) that is in communication with (e.g., includes and/or is connected to) a display generation component (600a, 600b, 610a, and/or 650a) (e.g., a display controller, a monitor, a touch-sensitive display system, a display screen, a projector, a holographic display, and/or a head-mounted display system) and one or more input devices (e.g., 650b and/or 650c) (e.g., a touch-sensitive surface, a keyboard, mouse, trackpad, one or more optical sensors for detecting gestures, one or more capacitive sensors for detecting hover inputs, and/or accelerometer/gyroscope/inertial measurement units). Some operations in method 1100 are, optionally, combined, the orders of some operations are, optionally, changed, and some operations are, optionally, omitted.

As described below, method 1100 provides an intuitive way for displaying shared content. The method reduces the cognitive burden on a user for displaying shared content, thereby creating a more efficient human-machine interface. For battery-operated computing devices, enabling a user to display shared content faster and more efficiently conserves power and increases the time between battery charges.

In method 1100, while displaying (1102), via the display generation component (e.g., 600a and/or 650a), a first user interface (e.g., 1005 and/or any location on display screen 600a or display 650a) that includes a representation (e.g., 1004a) of respective content shared between the computer system (e.g., 600) and an external computer system (e.g., 650) (e.g., a remote computer system) (and, in some embodiments, a representation of content that is not shared between the computer system and the external computer system), the computer system performs the following.

In response to detection (1104) of (e.g., at the computer system or at the external computer system) an input (e.g., cursor movement, mouse click, touch input, and/or keyboard input) while a cursor (e.g., 1006, 1006a, 1008, and/or 1008a) (e.g., a graphical element that indicates a position associated with an input device such as a mouse or trackpad) is displayed at the first user interface (e.g., 1005 and/or any location on display screen 600a or display 650a), and in accordance with a determination that the cursor is displayed at a location in the first user interface that overlaps at least a portion of the representation (e.g., 1002a and/or 1004a) of respective content shared between the computer system and the external computer system when the input is detected (e.g., the cursor is positioned over the shared content), the computer system performs (1106) a first action associated with the detected input (e.g., executing one or more commands associated with the input such as performing a selection, a cursor movement, a cursor click, and/or a keyboard input) and displays a visual effect (e.g., 1012, 1012a, 1014, 1018, 1019, 1030, 1034, 1034a, 1036, and/or 1044) (e.g., an avatar, a visual indication of keyboard input, a visual indication that control of the cursor is being shared, and/or an animation such as a ripple effect) that is visually associated with the cursor (e.g., 1006, 1006a, 1008, and/or 1008a) (e.g., displayed at a location that is determined based on a location of the cursor, displayed at the same location as the cursor, displayed adjacent to the cursor, and/or displayed moving with the cursor) when a set of criteria is met (e.g., the computer system is controlling the cursor (e.g., while control of the cursor is shared by the computer system and the external computer system), the cursor is the cursor of the external computer system, the external computer system is sharing the respective content with the computer system, the external computer system is controlling the cursor, or a combination thereof). In some embodiments, the input is performed and/or detected at the external computer system. In some embodiments, the input is performed and/or detected at the computer system. In some embodiments, the cursor represents a position of an input device associated with the external computer system (e.g., the cursor is the external computer system's cursor). In some embodiments, the cursor represents a position of an input device associated with the computer system (e.g., the cursor is the computer system's cursor). In some embodiments, when the set of criteria is not met, the first action is performed without displaying the visual effect associated with the cursor. In some embodiments, the visual effect that is visually associated with the cursor does not include a pointer trail of the cursor or a menu that is displayed in response to the mouse click. In some embodiments, an input performed and/or detected at the computer system can cause an action to be performed at the external computer system (e.g., a user of the computer system can remotely operate or control the external computer system), and an input performed and/or detected at the external computer system can cause an action to be performed at the external computer system (e.g., the external computer system can be controlled by the external computer system and can be remotely controlled by the computer system).

In response to detection (1104) of (e.g., at the computer system or at the external computer system) an input (e.g., cursor movement, mouse click, touch input, and/or keyboard input) while a cursor (e.g., 1006, 1006a, 1008, and/or 1008a) (e.g., a graphical element that indicates a position associated with an input device such as a mouse or trackpad) is displayed at the first user interface (e.g., 1005 and/or any location on display screen 600a or display 650a), and in accordance with a determination that the cursor is displayed at a location (e.g., 1010) in the first user interface that does not overlap at least a portion of the representation of respective content shared between the computer system and the external computer system when the input is detected (e.g., the cursor is not positioned over the shared content), the computer system (e.g., 600) performs (1108) a second action (e.g., the first action or an action different from the first action) associated with the detected input without displaying the visual effect that is visually associated with the cursor regardless of whether the set of criteria is met. Performing a first action associated with the detected input and displaying a visual effect that is visually associated with the cursor when a set of criteria is met, in accordance with a determination that the cursor is displayed at a location in the first user interface that overlaps at least a portion of the representation of respective content shared between the computer system and the external computer system when the input is detected, provides improved feedback about input occurring at a device that is sharing the respective content. In some embodiments, even if the set of criteria is met, the visual effect is not displayed if the cursor does not overlap at least a portion of the representation of respective content shared between the computer system and the external computer system (in some embodiments, however, the second action is still performed even when the visual effect is not displayed).

In some embodiments, the content is shared (e.g., transmitted) from the external computer system (directly, or indirectly such as, for example, through a server) to the computer system for display at the computer system. In some embodiments, the content is shared (e.g., transmitted) from the computer system (directly, or indirectly such as, for example, through a server) to the external computer system for display at the external computer system. In some embodiments, the content is concurrently displayed at both the computer system and the external computer system. In some embodiments, the respective content shared between the computer system and the external computer system includes (or, in some embodiments, is) a desktop of the external computer system, a screen of the external computer system, an application executing on the external computer system, a window of an application executing on the external computer system, and/or a user interface of an application executing on the external computer system.

In some embodiments, the visual effect (e.g., 1012, 1012a, 1014, 1018, 1019, 1030, 1034, 1034a, 1036, and/or 1044) is associated with the cursor (e.g., 1006) of a respective computer system (e.g., the computer system (e.g., 600) or external computer system (e.g., 650)) that is sharing the respective content (e.g., the visual effect is visually associated with the cursor of the device that is sharing the content). Displaying the visual effect associated with the cursor of the respective computer system that is sharing the respective content provides improved feedback about input occurring at a device that is sharing the respective content. In some embodiments, the set of criteria is met when the external computer system is sharing the respective content (e.g., the external computer system is the sharing device), the cursor is associated with the external computer system (e.g., the cursor is the sharing device's cursor), and the input is received at the external computer system.

In some embodiments, the visual effect (e.g., 1012, 1014, 1019, 1026, 1036, and/or 1044) is displayed at a display generation component (e.g., 600a) of a respective computer system (e.g., 600) (e.g., the computer system or the external computer system) that is receiving the respective content (e.g., 1002 and/or 1004). In some embodiments, the set of criteria is met when the external computer system is sharing the respective content. In some embodiments, the visual effect is not displayed at a display generation component (e.g., 650a) of the respective computer system that is sharing the respective content (e.g., 650). In some embodiments, the set of criteria is not met when the computer system is sharing the respective content (e.g., the visual effect of the sharing device's cursor is shown on the receiving device, but not the sharing device).

In some embodiments, displaying the visual effect that is visually associated with the cursor (e.g., 1006 and/or 1008) includes displaying a representation of a virtual avatar (e.g., 1012, 1012a, 1034, and/or 1034a) (or other visual indicator identifying or representing the user account such as initials, a name, photo, etc.) associated with a user account that is assigned control of the cursor (e.g., the user account is enabled to control the cursor, granted permission to control the cursor, providing input to control the cursor, and/or is the user account that most recently controlled the cursor). Displaying a representation of a virtual avatar associated with a user account that is assigned control of the cursor provides improved feedback indicating which user is controlling the cursor. In some embodiments, the user account is logged into the computer system or the external computer system.

In some embodiments, while the user account is assigned control of the cursor (e.g., 1006 and/or 1008), the computer system (e.g., 600 and/or 650) detects an input corresponding to a request to move the cursor (e.g., from a current location to a different location). In response to detecting the input corresponding to a request to move the cursor, the computer system displays the cursor moving from a current location to a different location, including: in accordance with a determination that the representation of the virtual avatar is not displayed (e.g., as shown in FIG. 10A) and the cursor moves to a location in the first user interface (e.g., 1005) that overlaps at least a portion of the representation (e.g., 1002a) of respective content shared between the computer system (e.g., 600) and the external computer system (e.g., 650), the computer system displays (e.g., introduces display of) the representation of the virtual avatar (e.g., 1012) that is visually associated with the cursor (e.g., 1008) when the cursor moves to the location that overlaps at least a portion of the representation of respective content (e.g., as shown in FIG. 10B) (e.g., as the cursor moves onto the representation of the shared content, the computer system displays the visual effect that includes the virtual avatar). In accordance with a determination that the representation of the virtual avatar is displayed visually associated with the cursor (e.g., as shown in FIG. 10C) and the cursor moves to a location in the first user interface that does not overlap at least a portion of the representation of respective content shared between the computer system and the external computer system (e.g., as shown in FIG. 10D), ceasing display of the representation of the virtual avatar when the cursor moves to the location that does not overlap at least a portion of the representation of respective content (e.g., as the cursor moves off of the representation of the shared content, the computer system ceases to display the visual effect that includes the virtual avatar). Displaying the representation of the virtual avatar that is visually associated with the cursor when the cursor moves to the location that overlaps at least a portion of the representation of respective content, and ceasing display of the representation of the virtual avatar when the cursor moves to the location that does not overlap at least a portion of the representation of respective content, provides improved feedback about whether content is being shared and which device is controlling the cursor when it is positioned on the shared content.

In some embodiments, displaying the representation of the virtual avatar associated with the user account that is assigned control of the cursor includes: in accordance with a determination that a user account of the external computer system (e.g., 650) is assigned control of the cursor (e.g., 1006) (e.g., the external computer system has control of the cursor), displaying a representation of a virtual avatar (e.g., 1034) associated with the user account of the external computer system (e.g., when the external computer system is controlling the cursor, the visual effect includes an avatar associated with the user account logged into the external computer system). In accordance with a determination that a user account of the computer system (e.g., 600) is assigned control of the cursor (e.g., 1006) (e.g., the computer system has control of the cursor), displaying a representation of a virtual avatar (e.g., 1012) associated with the user account of the computer system (e.g., when the computer system is controlling the cursor, the visual effect includes an avatar associated with the user account logged into the computer system). Displaying the representation of the virtual avatar associated with the user account of the external computer system when the user account of the external computer system is assigned control of the cursor, and displaying the representation of the virtual avatar associated with the user account of the computer system when the user account of the computer system is assigned control of the cursor, provides improved feedback about which user account is controlling the cursor.

In some embodiments, while displaying the representation of the virtual avatar (e.g., 1034) associated with the user account of the external computer system (e.g., 650) (e.g., and while the external computer system has control of the cursor), the computer system (e.g., 600) determines that control of the cursor (e.g., 1006) has changed from the external computer system to the computer system. In response to determining that control of the cursor has changed from the external computer system to the computer system, the computer system displays the representation of the virtual avatar (e.g., 1012) associated with the user account of the computer system (e.g., replacing the avatar of the external computer system with the avatar of the computer system). Displaying the representation of the virtual avatar associated with the user account of the computer system in response to determining that control of the cursor has changed from the external computer system to the computer system, provides improved feedback about when control of the cursor has changed to the user account of the computer system. In some embodiments, when cursor control changes from the recipient device to the sharing device, the computer system changes the avatar from the avatar of the recipient device to the avatar of the sharing device. In some embodiments, when cursor control changes from the sharing device to the recipient device, the computer system changes the avatar from the avatar of the sharing device to the avatar of the recipient device. In some embodiments, the external computer system is the sharing device, and the computer system is the recipient device. In some embodiments, the external computer system is the recipient device, and the computer system is the sharing device.

In some embodiments, input includes a keyboard input (e.g., selecting one or more keyboard keys at the computer system that is controlling the cursor), and the computer system (e.g., 600) displays the visual effect that is visually associated with the cursor (e.g., 1006 or 1008), including displaying a visual representation (e.g., 1018 and/or 1019) of the keyboard input (e.g., a visual indication of the one or more keyboard keys that are selected via the keyboard input). Displaying the visual representation of the keyboard input provides improved feedback about the input that is being provided by a remote device while content is being shared. In some embodiments, the visual representation of the keyboard input includes text indicating specific keys being activated at the device controlling the cursor.

In some embodiments, while a first control mode is enabled for the cursor (e.g., 1006) (e.g., a mode in which the cursor is capable of being controlled by only the computer system or the external computer system) while the cursor is displayed at the first user interface (e.g., 1002 and/or 1005), the computer system (e.g., 600 and/or 650) detects that a second control mode is enabled for the cursor (e.g., a mode in which control of the cursor is shared between the computer system and the external computer system) (e.g., the first control mode is disabled). In response to detecting that the second control mode is enabled for the cursor, the computer system displays an indication (e.g., 1026 and/or 1028) of the second control mode that is visually associated with the cursor (e.g., displaying text indicating that control of the cursor is shared). Displaying an indication of the second control mode that is visually associated with the cursor in response to detecting that the second control mode is enabled for the cursor provides improved feedback about a control state of the cursor.

In some embodiments, the input includes a cursor selection input (e.g., an input using a mouse, trackpad, or other input device that controls placement of the cursor and provides a selection input using the cursor). In some embodiments, displaying the visual effect that is visually associated with the cursor includes displaying an animation (e.g., 1014, 1030, 1036, and/or 1044) (e.g., a ripple effect) representing the cursor selection input. Displaying the animation representing the cursor selection input provides improved feedback about input provided by a remote device while content is being shared.

In some embodiments, the set of criteria is met when the cursor selection input is a first type of cursor selection input (e.g., a left-click input). In some embodiments, the set of criteria is not met when the cursor selection input is a second type of cursor selection input that is different from the first type of cursor selection input (e.g., a right-click input) (e.g., as shown in FIG. 10C). Displaying the animation representing the cursor selection input when the cursor selection input is the first type of cursor selection, and forgoing displaying the animation when the cursor selection input is the second type of cursor selection reduces the computational workload of the computer system by avoiding the display of irrelevant animation when the cursor selection input is not relevant to the viewer.

Note that details of the processes described above with respect to method 1100 (e.g., FIG. 11) are also applicable in an analogous manner to the methods described above. For example, methods 700 and 900 optionally include one or more of the characteristics of the various methods described above with reference to method 1100. For example, the user interfaces described with respect to the techniques in method 700 and/or method 1100 can include any of the techniques for displaying shared content described with respect to method 1100. For brevity, these details are not repeated.

The various embodiments provided herein are generally described using devices 600, 610, and 650. However, it should be appreciated that other computer systems or devices can be used (in addition to, or in lieu of, devices 600/610/650) to participate in a shared-content session, and that various aspects of a shared-content session can be implemented in different manners across the various devices participating in the shared-content session. For example, a smart speaker, optionally including a display component, can be used to participate in a shared-content session. In some embodiments, inputs at the smart speaker can be provided verbally and, optionally, via a touch input, and outputs can be audio outputs and, optionally, visual outputs provided at a connected display component. As another example, a display component of a head-mounted device (HMD) can be used to display visual aspects of the shared-content session (and a speaker used to produce audio), and inputs can be received by detecting gestures, eye gaze, hand movements, audio inputs, touch inputs, or the like. In some embodiments, the user interfaces depicted in the figures can be displayed in an extended reality environment such as augmented reality or virtual reality. For example, video tiles, windows, and/or other display regions shown in the figures can be displayed suspended in a three-dimensional environment. As another example, the representations of users or participants can be displayed as simulated three-dimensional avatars or two-dimensional avatars positioned around a three-dimensional environment rather than video tiles or windows in a video call or video conference application. Additionally, embodiments are described herein using various types of inputs such as taps, drags, clicks, and hover gestures, however, it should be appreciated that the described embodiments can be modified to respond to other forms of input including gestures, eye gaze, hand movements, audio inputs, and the like. Additionally, different devices with different capabilities can be combined in a single shared-content session, for example a smartphone, tablet, laptop computer, desktop computer, smart speaker, smart TV, headphones or earbuds, HMD, and/or smart watch (or a subset thereof) could participate in the same shared-content session with the different devices participating in different manners according to the capabilities of the device (e.g., the HMD presenting content in a simulated three-dimensional environment or an augmented reality environment, the smart speaker providing audio outputs and inputs, the headphones providing spatial audio outputs and audio inputs, the laptop and desktop computers, smartphone and tablet providing audio and visual inputs and outputs, the smart TV providing audio and visual outputs and audio inputs (or audio and visual inputs)).

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the techniques and their practical applications. Others skilled in the art are thereby enabled to best utilize the techniques and various embodiments with various modifications as are suited to the particular use contemplated.

Although the disclosure and examples have been fully described with reference to the accompanying drawings, it is to be noted that various changes and modifications will become apparent to those skilled in the art. Such changes and modifications are to be understood as being included within the scope of the disclosure and examples as defined by the claims.

As described above, one aspect of the present technology is the gathering and use of data available from various sources to display remote content. The present disclosure contemplates that in some instances, this gathered data may include personal information data that uniquely identifies or can be used to contact or locate a specific person. Such personal information data can include demographic data, location-based data, telephone numbers, email addresses, social network IDs, home addresses, data or records relating to a user's health or level of fitness (e.g., vital signs measurements, medication information, exercise information), date of birth, or any other identifying or personal information.

The present disclosure recognizes that the use of such personal information data, in the present technology, can be used to the benefit of users. For example, the personal information data can be used to customize a user's content that is shared with another user in a remote viewing session. Further, other uses for personal information data that benefit the user are also contemplated by the present disclosure. For instance, health and fitness data may be used to provide insights into a user's general wellness, or may be used as positive feedback to individuals using technology to pursue wellness goals.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of or access to certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of customized content that is shared with other users, the present technology can be configured to allow users to “opt in” or “opt out” of the display of the customized content when shared in a remote viewing session. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers (e.g., date of birth, etc.), controlling the amount or specificity of data stored (e.g., collecting location data a city level rather than at an address level), controlling how data is stored (e.g., aggregating data across users), and/or other methods.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, content can be selected and delivered to users by inferring preferences based on non-personal information data or a bare minimum amount of personal information, such as the content being requested by the device associated with a user, other non-personal information available to the content delivery services, or publicly available information.

1.-51. (canceled)

52. A computer system configured to communicate with a display generation component and one or more input devices, comprising:
one or more processors; and
memory storing one or more programs configured to be executed by the one or more processors, the one or more programs including instructions for:
while displaying, via the display generation component, a first user interface that includes a representation of respective content shared between the computer system and an external computer system:
in response to detection of an input while a cursor is displayed at the first user interface:
in accordance with a determination that the cursor is displayed at a location in the first user interface that overlaps at least a portion of the representation of respective content shared between the computer system and the external computer system when the input is detected, performing a first action associated with the detected input and displaying a visual effect that is visually associated with the cursor when a set of criteria is met; and
in accordance with a determination that the cursor is displayed at a location in the first user interface that does not overlap at least a portion of the representation of respective content shared between the computer system and the external computer system when the input is detected, performing a second action associated with the detected input without displaying the visual effect that is visually associated with the cursor regardless of whether the set of criteria is met.

53. The computer system of claim 52, wherein the visual effect is associated with the cursor of a respective computer system that is sharing the respective content.

54. The computer system of claim 53, wherein:
the visual effect is displayed at a display generation component of a respective computer system that is receiving the respective content; and
the visual effect is not displayed at a display generation component of the respective computer system that is sharing the respective content.

55. The computer system of claim 52, wherein displaying the visual effect that is visually associated with the cursor includes displaying a representation of a virtual avatar associated with a user account that is assigned control of the cursor.

56. The computer system of claim 55, the one or more programs further including instructions for:
while the user account is assigned control of the cursor, detecting an input corresponding to a request to move the cursor; and
in response to detecting the input corresponding to a request to move the cursor, displaying the cursor moving from a current location to a different location, including:
in accordance with a determination that the representation of the virtual avatar is not displayed and the cursor moves to a location in the first user interface that overlaps at least a portion of the representation of respective content shared between the computer system and the external computer system, displaying the representation of the virtual avatar that is visually associated with the cursor when the cursor moves to the location that overlaps at least a portion of the representation of respective content; and
in accordance with a determination that the representation of the virtual avatar is displayed visually associated with the cursor and the cursor moves to a location in the first user interface that does not overlap at least a portion of the representation of respective content shared between the computer system and the external computer system, ceasing display of the representation of the virtual avatar when the cursor moves to the location that does not overlap at least a portion of the representation of respective content.

57. The computer system of claim 55, wherein displaying the representation of the virtual avatar associated with the user account that is assigned control of the cursor includes:
in accordance with a determination that a user account of the external computer system is assigned control of the cursor, displaying a representation of a virtual avatar associated with the user account of the external computer system; and
in accordance with a determination that a user account of the computer system is assigned control of the cursor, displaying a representation of a virtual avatar associated with the user account of the computer system.

58. The computer system of claim 57, the one or more programs further including instructions for:
while displaying the representation of the virtual avatar associated with the user account of the external computer system, determining that control of the cursor has changed from the external computer system to the computer system; and
in response to determining that control of the cursor has changed from the external computer system to the computer system, displaying the representation of the virtual avatar associated with the user account of the computer system.

59. The computer system of claim 52, wherein the input includes a keyboard input, and displaying the visual effect that is visually associated with the cursor includes displaying a visual representation of the keyboard input.

60. The computer system of claim 52, the one or more programs further including instructions for:
while a first control mode is enabled for the cursor while the cursor is displayed at the first user interface, detecting that a second control mode is enabled for the cursor; and
in response to detecting that the second control mode is enabled for the cursor, displaying an indication of the second control mode that is visually associated with the cursor.

61. The computer system of claim 52, wherein:
the input includes a cursor selection input; and
displaying the visual effect that is visually associated with the cursor includes displaying an animation representing the cursor selection input.

62. The computer system of claim 61, wherein:
the set of criteria is met when the cursor selection input is a first type of cursor selection input; and
the set of criteria is not met when the cursor selection input is a second type of cursor selection input that is different from the first type of cursor selection input.

63. A non-transitory computer-readable storage medium storing one or more programs configured to be executed by one or more processors of a computer system that is in communication with a display generation component and one or more input devices, the one or more programs including instructions for:
while displaying, via the display generation component, a first user interface that includes a representation of respective content shared between the computer system and an external computer system:
in response to detection of an input while a cursor is displayed at the first user interface:
in accordance with a determination that the cursor is displayed at a location in the first user interface that overlaps at least a portion of the representation of respective content shared between the computer system and the external computer system when the input is detected, performing a first action associated with the detected input and displaying a visual effect that is visually associated with the cursor when a set of criteria is met; and
in accordance with a determination that the cursor is displayed at a location in the first user interface that does not overlap at least a portion of the representation of respective content shared between the computer system and the external computer system when the input is detected, performing a second action associated with the detected input without displaying the visual effect that is visually associated with the cursor regardless of whether the set of criteria is met.

64. A method, comprising:
at a computer system that is in communication with a display generation component and one or more input devices:
while displaying, via the display generation component, a first user interface that includes a representation of respective content shared between the computer system and an external computer system:
in response to detection of an input while a cursor is displayed at the first user interface:
in accordance with a determination that the cursor is displayed at a location in the first user interface that overlaps at least a portion of the representation of respective content shared between the computer system and the external computer system when the input is detected, performing a first action associated with the detected input and displaying a visual effect that is visually associated with the cursor when a set of criteria is met; and
in accordance with a determination that the cursor is displayed at a location in the first user interface that does not overlap at least a portion of the representation of respective content shared between the computer system and the external computer system when the input is detected, performing a second action associated with the detected input without displaying the visual effect that is visually associated with the cursor regardless of whether the set of criteria is met.
